(19) United States
(12) Patent Application Publication
(10) Pub. No.: US 2021/0061654 A1
(43) Pub. Date: Mar. 4, 2021

(54) NATURAL GAS CONVERSION TO CHEMICALS AND POWER WITH MOLTEN SALTS

(71) Applicant: The Regents of the University of California, Oakland, CA (US)

(72) Inventors: Eric W. McFarland, Santa Barbara, CA (US); Ches Upham, Menlo Park, CA (US); Clarke Palmer, Goleta, CA (US); Shizhao Su, Santa Barbara, CA (US); Davide Mannini, Santa Barbara, CA (US); Nazanin Rahimi, Goleta, CA (US); Dohyung Kang, Goleta, CA (US); Horia Metiu, Santa Barbara, CA (US); Michael Gordon, Goleta, CA (US)

(73) Assignee: The Regents of the University of California, Oakland, CA (US)

(21) Appl. No.: 17/054,714

(22) PCT Filed: May 14, 2019
(86) PCT No.: PCT/US19/32205

§ 371 Date: Nov. 11, 2020

Related U.S. Application Data
(60) Provisional application No. 62/674,268, filed on May 21, 2018.

(51) Int. Cl. C01B 3/26; B01J 27/10; B01J 35/12; B01J 6/00

(52) U.S. Cl. CPC C01B 3/26; B01J 27/10; B01J 35/12; C01B 2203/1041; C01B 2203/0277; C01B 2203/1241; C01B 2203/0833; B01J 6/008

(57) ABSTRACT

A reaction process comprises feeding a feed stream comprising a hydrocarbon into a vessel, reacting the feed stream in the vessel, producing solid carbon and a gas phase product based on the contacting of the feed stream with the molten salt mixture, separating the gas phase product from the molten salt mixture, and separating the solid carbon from the molten salt mixture to produce a solid carbon product. The vessel comprises a molten salt mixture, and the molten salt mixture comprises a reactive component.

### CROSS-REFERENCE TO RELATED APPLICATIONS

This application claims priority to U.S. Provisional Application No. 62/674,268, filed on May 2018, and entitled “Natural Gas Conversion to Chemicals and Power with Molten Salts”, which is incorporated herein by reference in its entirely.

### STATEMENT REGARDING FEDERALLY SPONSORED RESEARCH OR DEVELOPMENT

This invention was made with Government support under Grant #DE-FG02-89ER14048 awarded by the US DOE BES. The Government has certain rights in this invention.

### FIELD

The invention relates to the manufacture of chemicals and solid carbon from natural gas making use of a molten salt to remove the carbon from the reactor. The invention also relates to the manufacture of hydrogen and solid carbon from other hydrocarbon feedstocks including natural gas, petroleum, and their components. The invention also relates broadly to reactive separation of reactants from products in molten salt environments with a catalyst. The invention also relates to producing heat and steam from natural gas without producing carbon dioxide in a molten salt environment that allows removal of solid carbon. More particularly, the disclosure relates to an improved process for conversion of hydrogen and carbon containing molecules into gaseous hydrogen and solid carbon in reactors Whereby the removal of the solid carbon is facilitated by the presence of a molten salt.

### BACKGROUND

At present, industrial hydrogen is produced primarily using the steam methane reforming (SMR) process, and the product effluent from the reactors contains not only the desired hydrogen product but also other gaseous species including gaseous carbon oxides (CO/CO₂) and unconverted methane. Separation of the hydrogen for shipment or storage and separation of the methane for recirculation back to the reformer is carried out in a pressure swing adsorption (PSA) unit, a costly and energy-intensive separation. Generally the carbon oxides are released to the environment. This separation process exists as an independent unit after reaction. Overall the process produces significant carbon dioxide. Natural gas is also widely used to produce power by combustion with oxygen, again producing significant amounts of carbon dioxide.

Methane pyrolysis can be used as a means of producing hydrogen and solid carbon. The reaction, CH₄←→2H₂+C is limited by equilibrium such that at pressures of approximately 5-40 bar which are need for industrial production and temperatures below 1100° C. the methane conversion is relatively low. The many strategies investigated to date have been recently reviewed in Renewable and Sustainable Energy Reviews 44 (2015) 221-256 which highlighted solid catalysts including metals, metal enhanced carbons, and activated carbons Applied Catalysis A General 359(1-2):1-24 May 2009, Energy & Fuels 1998. 12. pp. 41-48 and Topics in Catalysis vol. 37, Nos. 2-4, Apr. 2006, pp. 137-145 which assessed technologies pertaining to the catalytic decomposition of hydrocarbons for hydrogen production in general, the conclusions point to the rapid deactivation of solid catalysts (requiring reactivation steps) and the high power requirements and low pressures of hydrogen produced in plasma type systems. Other reviews of these same technologies include International Journal of Hydrogen Energy 24 (1999), pp. 613-624, and International Journal of Hydrogen Energy 35 (2010), pp. 1160-1190.

U.S. Pat. No. 9,061,909 discloses the production of carbon nanotubes and hydrogen from a hydrocarbon source. The carbon is produced on solid catalysts and the carbon is reportedly removed by use of “a separation gas”.

In the 1920's the thermal decomposition of methane to produce carbon at very high temperatures was described, J. Phys. Chem., 1924, 28 (10), pp 1036-1048. Following on this approach, U.S. Pat. No. 6,936,234 discloses a process for converting methane to solid graphitic carbon without a catalyst in a high temperature process at 2100-2400° C. The methods of heating or for removing the carbon are not disclosed.

U.S. Pat. No. 6,936,234 discloses a process for converting methane to solid graphitic carbon without a catalyst in a high temperature process at 2100-2400° C. The methods of heating or for removing the carbon are not disclosed.

U.S. Pat. No. 9,776,860 discloses a process for converting hydrocarbons to solid graphitic carbon in a chemical looping cycle whereby the hydrocarbon is dehydrogenated over a molten metal salt (e.g. metal chloride) to produce a reduced metal (e.g. Ni), solid carbon, and a hydrogen containing intermediate (e.g. HCl). The reaction conditions are then changed to allow the intermediate to react with the metal to recreate the metal salt and molecular hydrogen.

Molten iron is employed in U.S. Pat. Nos. 4,187,672 and 4,244,180 as a solvent, for carbon generated from coal; the carbon is then partially oxidized by iron oxide and partially through the introduction of oxygen. Coal can be gasified in a molten metal bath such as molten iron at temperatures of 1200-1700° C. Steam is injected to react with the carbon endothermically and moderate the reaction which otherwise heats up. The disclosure maintains distinct carbonization and oxidation reaction chambers. In U.S. Pat. Nos. 4,574,714 and 4,602,574 describe a process for the destruction of organic wastes by injecting them, together with oxygen, into a metal or slag bath such as is utilized in a steelmaking facility. Nagel, et. al. in U.S. Pat. Nos. 5,322,547 and 5,358,549 describe directing an organic waste into a molten metal bath, including. an agent which chemically reduces a metal of the metal-containing component to form a dissolved intermediate. A second reducing agent is added to reduce the metal of the dissolved intermediate, thereby, indirectly chemically reducing the metal component. Hydrogen gas can be produced from hydrocarbon feedstocks such as natural gas, biomass and steam using a number of different techniques.

U.S. Pat. No. 4,388,084 by Okane, et al. discloses a process for the gasification of coal by injecting coal, oxygen and steam onto molten iron at a temperature of about 1500° C. The manufacture of hydrogen by the reduction of steam using an oxidizable metal species is also known. For example, U.S. Pat. No. 4,343,624 discloses a three-stage hydrogen production method and apparatus utilizing a steam oxidation process. U.S. Pat. No. 5,645,615 discloses a method for decomposing carbon and hydrogen containing feeds, such as coal, by injecting the feed into a molten metal using a submerged lance. U.S. Pat. No. 6,110,239 describes a hydrocarbon gasification process producing hydrogen and carbon oxides where the molten metal is transferred to different zones within the same reactor.

Contacting methane with molten metals to produce solid carbon and hydrogen was described previously in Energy & Fuels 2003, 17, pgs. 705-713. In this prior work, molten tin and molten tin with suspended silicon carbide particles were used as the reaction environment. The authors report that the thermochemical process has increased methane conversion due to increased residence time when the particles are added to the tin melt in a non-catalytic heat transfer medium. More recently, molten tin was again utilized as a reaction medium for methane pyrolysis, Int. J. Hydrogen Energy 40, 14134-11146 (2015), with the metal serving as a non-catalytic heat transfer medium which allowed separation of the solid carbon product from the gas phase hydrogen.

### Chemical Looping Combustion for Power Production

The use of halide salts as catalysts for the selective partial oxidation of hydrocarbons has been demonstrated in the presence of oxygen. For example, iodide salts have been used to dehydrogenate a wide range of hydrocarbons as described in U.S. Pat. No. 3,080,435. In the referenced patent, oxygen reacts with an iodide salt to produce elemental iodine, which in turn reacts with a saturated hydrocarbon in the gas phase, producing an unsaturated compound and hydrogen iodide. The hydrogen iodide reacts with the salt to produce the iodide again, completing a catalytic chemical looping cycle. The dehydrogenated products remain in the gas-phase and the process operates continuously.

The use of molten salts as high temperature heat transfer fluids is described in the field and heat extraction has been demonstrated from molten salt nuclear reactors, concentrated solar heated salts, and other exothermic reactions. For example, U.S. Pat. No. 2,692,234 describes molten media for heat transfer at high temperature, WO2012093012A1 describes molten salts for solar thermal applications, and U.S. Pat. No. 3,848,416 describes the use of molten salts for the transfer and storage of heat in nuclear reactors. In the referenced patents, the liquid media act as heat transfer agents which can be moved easily from one vessel to another.

The continuous removal of carbon from hydrocarbon decomposition reactions in molten media have been reported by Steinburg in U.S. Pat. No. 5,767,165 where methane is fed to a bubble column of liquid tin. Methane decomposes to carbon and hydrogen and the carbon floats to the surface where it can be removed. Carbon produced from the thermal decomposition of hydrocarbons has also been shown to dissolve in the molten media in which the decomposition occurs. For example, U.S. Pat. No. 4,574,714 discloses the decomposition of organic waste into a molten metal bath. Oxygen is also added, and the produced carbon is partially dissolved in the melt.

A multistep process for the conversion of methane to separate streams of carbon and hydrogen using a salt is referenced in U.S. Pat. No. 9,776,860. In the referenced process, methane is contacted with nickel chloride, and nickel metal, carbon and hydrogen chloride are produced. At a lower temperature in a separate step, the hydrogen chloride and nickel metal react to form nickel chloride and hydrogen. The carbon and nickel chloride are separated in another higher temperature reactor in which nickel chloride sublimes.

The gas-phase conversion of methane and oxygen to carbon and steam has been reported by Rehordinos (International Journal of Hydrogen Energy 42, 4710-4720). In the referenced work, methane and bromine react to form carbon and hydrogen bromide, which flow to another reactor in which the carbon is separated. The hydrogen bromide is then reacted with oxygen in another reactor to generate steam and to re-generate bromine. The process requires multiple reactors and energy intensive separations between reactors.

### SUMMARY

In some embodiments, a reaction process comprises feeding a feed stream comprising a hydrocarbon into a vessel, reacting the feed stream in the vessel, producing solid carbon and a gas phase product based on the contacting of the feed stream with the molten salt mixture, separating the gas phase product from the molten salt mixture, and separating the solid carbon from the molten salt mixture to produce a solid carbon product. The vessel comprises a molten salt mixture, and the molten salt mixture comprises a reactive component.

In some embodiments, a reaction process comprises contacting a feed stream comprising a hydrocarbon with an active metal component within a vessel, reacting the feed stream with the active metal component in the vessel, producing carbon based on the reacting of the feed stream with the active metal component in the vessel, contacting the reactive metal component with a molten salt mixture, solvating at least a portion of the carbon using the molten salt mixture, and separating the carbon from the molten salt mixture to produce a carbon product.

In some embodiments, a system for the production of carbon from a hydrocarbon gas comprises a reactor vessel comprising a molten salt mixture, a feed stream inlet to the reactor vessel, a feed stream comprising a hydrocarbon, solid carbon disposed within the reactor vessel, and a product outlet configured to remove the carbon from the reactor vessel. The molten salt mixture comprises an active metal component, and a molten salt mixture. The feed stream inlet is configured to introduce the feed stream into the reactor vessel, and the solid carbon is a reaction product of the hydrocarbon within the reactor vessel.

These and other features will be more clearly understood from the following detailed description taken in conjunction with the accompanying drawings and claims.

### BRIEF DESCRIPTION OF TI-IE DRAWINGS

For a more complete understanding of the present disclosure, reference is now made to the following brief description, taken in connection with the accompanying drawings and detailed description:

FIG. 1 is a schematic illustration of an embodiment of the overall process for conversion of gases containing molecules with primarily hydrogen and carbon into a solid carbon product and gas phase chemicals.

FIG. 2 is a schematic illustration of an embodiment of a natural gas stream being bubbled into a molten salt filled vessel containing catalytic activity producing solid carbon and hydrogen gas.

FIGS. 3A-3C are schematic illustrations and photographs of embodiments showing a bubble lift pump carrying molten salt containing carbon out of the main reactor and over a separation system.

FIG. 4 is a schematic illustration of an embodiment of a molten salt pyrolysis reactor with a separate section where solid carbon is caused to move to a screw auger for removal from the reactor.

FIG. 5 is a schematic illustration of an embodiment of a molten salt pyrolysis reactor with a separate section where solid carbon is filtered and a high velocity gas stream used to entrain the carbon and move it to a solid-gas separation system.

FIG. 6 is a schematic illustration of methane pyrolysis in a supported catalyst reactor. The supported catalyst can be different and immiscible with the molten salt used as the surrounding environment. The surrounding molten salt can wet and remove any carbon species deposited, allowing them to move to the surface for facile removal.

FIG. 7 is a schematic illustration of a bubble lift reactor configuration for the circulation of a molten salt on top of a molten reactive metal. The carbon formed by contacting methane with the reactive metal can be separated in the salt loop.

FIG. 8 is a schematic illustration of two molten salt bubble columns in series allowing co-current circulation of the molten salt with two different gases. One gas may be reactive and another used to exchange heat by direct contact.

FIG. 9 is a schematic illustration; molten metals and molten salts can form an emulsion whereby one phase is a reactive material.

FIG. 10 illustrates schematically a continuous process for electrical power generation in a combination of a natural gas pyrolysis unit with a gas turbine and electricity generator.

FIG. 11 is a schematic illustration of an embodiment in which methane and oxygen are fed into a molten salt bubble column and produce carbon, steam, and electricity from the heat.

FIG. 12 shows the proposed reaction pathway for one salt pair and one halogen where LiI—LiOH is used to generate iodine gas, which reacts with methane to form carbon and hydrogen iodide.

FIG. 13 illustrates how the general reaction scheme can he split into three reactors in which different gases are fed.

FIG. 14. Two-stage generation of hydrogen and power with a separate stream of CO₂ from natural gas in molten salt reactors. Natural gas can be bubbled through one molten salt vessel and pyrolyzed at 1000° C. to hydrogen gas and solid carbon. The solid carbon intercalates with the molten salt creating a slurry, which is then fed into a separate vessel for combustion in oxygen. Fresh salt is then recycled to the first reaction vessel.

FIG. 15 is a schematic illustration of an exemplary process whereby a hydrocarbon containing gas is introduced into a reactor with a molten salt to produce low density solid carbon and hydrogen gas.

FIG. 16. Data described further in Example 2 showing the fractional methane conversions versus temperature [°C] for methane pyrolysis in molten alkali-halide binary salts: (A) KCl (B) KBr (C) NaCl (D) NaBr.

FIG. 17 illustrates data showing the fractional methane conversions in molten (A) KCl, (B) KBr, (C) NaCl, and (D) NaBr at 1000° C., versus time used for Example 3.

FIG. 18 illustrates fractional methane conversions versus temperature [°C] with different hydrocarbon additives in a KCl bubble column reactor of a pure methane feed (A) and methane with 2% volume hydrocarbon additives: (B) ethane, (C) propane, (D) acetylene, and (E) benzene.

FIG. 19 illustrates fractional methane conversions versus temperature [°C] with ethane added in a KCl bubble column reactor of a pure methane feed (A) and methane with 1% (B), 2% (C), and 5% (D) volume ethane added.

FIG. 20 illustrates fractional methane conversions versus temperature [°C] with propane added in a KCl bubble column reactor of a pure methane feed (A) and methane with 1% (B), 2% (C), and 5% (D) volume propane added as described in Example 4.

FIG. 21 is a diagrammatic illustration of an exemplary process whereby a hydrocarbon containing gas is introduced into a reactor with a catalytic molten salt to produce solid carbon and hydrogen gas.

FIG. 22 is data described in Example 5 showing the fractional conversion of methane with different compositions of potassium chloride and manganese chloride mixtures in a molten salt reactor versus temperature.

FIG. 23 is data described in Example 5 showing the crystallinity of carbon from pure molten potassium chloride and molten salt mixture of potassium-manganese chloride.

FIG. 24 is a diagrammatic illustration of an exemplary process whereby a hydrocarbon containing gas is introduced into a reactor with molten salt-particle slurry comprised of potassium or magnesium chloride and magnesium oxide particle to produce solid carbon and hydrogen gas.

FIG. 25 is data described in Example 6 showing the fractional conversion of methane in a molten salt-magnesium oxide slurry reactor versus temperature.

FIG. 26 is a diagrammatic illustration of an exemplary process whereby a hydrogen containing gas is introduced into a reactor with salt mixture comprised of iron chloride and potassium chloride to reduce iron chloride and produce iron nano/micron particles-embedded molten potassium chloride.

FIG. 27 is a diagrammatic illustration of an exemplary process whereby a hydrocarbon containing gas is introduced into a reactor with iron nano/micron particles-embedded molten potassium chloride to produce solid carbon and hydrogen gas.

FIG. 28 is data described in Example 7 showing the fractional conversion of methane with different weight fraction of iron nano/micron particles in a molten salt reactor versus temperature.

FIG. 29 is a diagrammatic illustration of an exemplary process whereby a hydrocarbon containing gas is introduced into a three-phase molten salt packed-bed reactor.

FIG. 30 is data described in Example 8 showing the fractional conversion of methane in a three-phase molten salt packed-bed reactor versus temperature.

FIGS. 31A and 31B show schematic representations of molten salt reactors with a less dense salt on the left, FIG. 31A, and a more dense salt on the right. FIG. 31B.

FIGS. 32A-32C are schematic representations of a molten salt filled reactor for methane pyrolysis with spherical solid catalysts immersed in the salt is shown on left. In the middle a photograph of molten bromide salt with solid Ni spheres immersed in the salt at 1000° C. and on the left after running for several hours showing carbon accumulation at top of reactor as described in Example 10.

FIGS. 33A and 33B are photographs on the left shows a coked Ni foil and on the right after washing off the carbon with molten salt as described in Example 11.

FIGS. 34A and 34B are a diagrammatic illustration of an exemplary process whereby a reducing gas is introduced into a reactor with a molten salt containing transition metal halide to produce solid transition metal dispersed in the molten salt. FIG. 32B is a diagrammatic illustration of an exemplary process whereby a hydrocarbon containing gas is introduced into a reactor with solid catalysts dispersed in molten salt to produce low density solid carbon and hydrogen gas.

FIG. 35 is a scanning electron microscopy image of carbon collected from the surface of the molten salt after the reactor consist of molten salt and solid cobalt particles are cooled to room temperature.

FIGS. 36A is a a scanning electron microscopy image of the cobalt particles and cooled salt and FIG. 36B is a high resolution transmission electron microscopy image of a cobalt particle extracted from the cooled salt.

FIGS. 37A and 37B are illustrations of (A) how the lifting action by the bubbles can accumulate carbon at the top of the reactor.

FIGS. 38A and 38B are photographs described in Example 13 of a quartz bubble column reactor after cooling and breaking open to show carbon accumulation.

FIG. 39 is data collected and described in Example 14 showing methane conversion in a molten salt mixture with addition of (A) TiO₂ (10 wt %), (B) CeO₂ (10 wt %), (C) no metal oxides.

FIG. 40 shows data described in Example 15 of methane conversion as a function of time during the 99 hours methane decomposition reaction at 1050° C. 1.25 g of Ni supported catalyst (65 wt % Ni loading on Al₂O₃/SiO₂) is dispersed in 25 g of NaBr (49 mol %)-KBr (51 mol %) molten salt. Methane flow rate is 14 SCCM.

FIG. 41 shows scanning electron microscope image of the carbon product from the methane decomposition on solid catalysts suspended in molten salt described in Example 15.

FIG. 42 shows Raman spectroscopy data from the carbon product from the methane decomposition on solid catalysts suspended in molten salt described in Example 15.

FIG. 43 is data of methane conversion as a function of temperature in a bubble column reactor with an active molten salt described in Example 16.

FIG. 44 is a photograph of the inside of a bubble column reactor after cooling described in Example 16.

FIG. 45 is the measured tum over frequency of methane on solid MgF₂ surface as a function of decomposition reaction temperature as described in Example 16.

FIG. 46 is a schematic illustration of use of the molten salt vapor as a catalyst for methane conversion as described in Example 17.

FIG. 47 is the data for methane fractional conversion by the vapor of a specific molten salt as described in Example 17.

FIG. 48 is schematic showing how gas phase catalysis occurs from the catalytic vapor of the molten salt as described in Example 18.

FIG. 49 is the data for methane fractional conversion by the vapor of a specific molten salt as described in Example 18.

FIG. 50 illustrates how an emulsion of a molten salt and molten metal mixture can be used as a catalytic environment as described in Example 20.

FIG. 51 shows the experimental setup for examples 23 and 24 with a flow reactor system.

FIG. 52 shows experimental results from a mass spectrometer used in Example 23 showing oxygen conversion.

FIG. 53 shows results from an experiment in which methane and oxygen are fed into a 1:1 LiI—LiOH bubble column with methane conversion, oxygen conversion, and selectivity to carbon area plotted as described in Example 23.

FIG. 54 shows experimental results from kinetic measurements described in Example 23.

FIGS. 55A and 55B shows experimental results of conversion described in Example 24.

FIG. 56 shows experimental conversion and selectivity data for experiments in which methyl iodide was sent to a bubble column of iodide salt described in Example 24.

FIG. 57 shows kinetic modeling results described in Example 24.

FIG. 58 shows experimental data from methane reacting with oxygen and iodine in the gas phase described in Example 24.

FIG. 59 shows experimental results from the reaction of methane and bromine with 2:1 Br₂:CH₄ bubbled through NiBr₂—KBr described in Example 25.

FIG. 60 is a set of scanning electron microscopy images of the carbon at the surface of a LiI—LiOH bubble column described in Example 26.

FIG. 61 shows Raman spectroscopy results from the experiments of Example 26.

FIGS. 62A and 62B contain experimental results from sending methyl bromide to a bubble column of NiBr₂—KBr—LiBr described in Example 25.

### DETAILED DESCRIPTION

The conversion of natural gas into hydrogen or power today is practiced commercially using processes that produce significant quantities of carbon dioxide. As the global community seeks to reduce carbon dioxide emissions it is desired to find cost effective processes to make use of natural gas to produce hydrogen or power without generating carbon dioxide. The present systems and methods make conversion of natural gas or other fossil hydrocarbons into hydrogen and/or heat and steam for power possible without producing carbon dioxide while producing instead solid carbon.

The systems and methods described herein are based on transformation of natural gas or other molecules or mixtures of molecules containing predominately hydrogen and carbon atoms into a solid carbon product that can be readily handled and prevented from forming carbon dioxide in the atmosphere, as well as a gas phase co-product. In some embodiments, the co-product is hydrogen which can be used as a fuel or chemical. The overall process in this case can be referred to as pyrolysis, CₙH₂ₘ→mH₂nC. In some embodiments, the co-product is steam which can be used in power generation. The overall reaction in this second case is carried out as: CₙH₂ₘ+m/2O₂→mH₂O+nC.

The present systems and methods according to many embodiments shows how to significantly improve on previous attempts to transform gases containing carbon and hydrogen into chemicals including hydrogen and solid carbon through the use of a catalytic environment containing a molten salt, whereby the solid carbon can be removed from the reactor carried by the molten salt in a much lower cost and practically easier way than known before.

The systems and methods disclosed herein teach the preparation and use of novel high-temperature catalytic environments in reactors containing molten salt for the transformation of natural gas to solid carbon with the co-production of hydrogen or other chemicals and/or power without producing stoichiometric carbon oxides. The various embodiments include continuous processes whereby carbon can be produced from natural gas and separated from the molten media together with gas phase chemical co-products and reactors and methods for removal of the carbon. In some embodiments, methane or other light hydrocarbon gases are fed into a reactor system containing a molten salt with a catalyst and react to produce carbon and molecular hydrogen as a chemical product. The reaction is endothermic and heat is provided to the reactor. The salt is an excellent heat transfer medium and can be used to facilitate heat transfer into the reactor. In sonic embodiments, methane or other light hydrocarbon gases and oxygen are ted into a reactor system whereby oxygen reacts in the presence of a halide salt to produce carbon and water. In this embodiment, the reaction is exothermic and the heat (and steam) can be removed and used to produce power. The specific use of molten salts facilitates the removal of the produced heat. In each process, the carbon can be separated and removed as a solid in the process.

The processes disclosed herein can overcome most or all major barriers hindering prior approaches to transforming molecules containing carbon and hydrogen into solid carbon and chemical products and/or heat energy without the production of any carbon dioxide. Namely, by the use of specific molten salts, solid carbon can be created and accumulated and removed with the molten salt. The produced carbon can be easily cleaned and made free of significant amounts of residual salt, and by the use of catalytic salts or catalysts within the salt, the reaction rate is high allowing commercially acceptable reactor sizes. Further, by deploying the novel reactor configurations described herein, the carbon, moving within the salt, can be removed. The present systems and methods take advantage of the high-temperature reaction and solid separation environment made possible by unique combinations molten salts to produce solid carbon, chemicals) products, and/or power from natural gas in novel embodiments.

As demonstrated herein, pure or substantially pure (e.g., accounting for minor amounts of impurities that do not affect the reaction) natural gas can be bubbled through specific compositions of high-temperature molten salts to thermally decompose the molecules containing carbon and hydrogen into solid carbon and molecular hydrogen. The solid carbon product can be suspended in the salt where it can be readily removed during a continuous process (e.g., without pausing operations). Salt separations from solid carbon are facile, allowing for clean carbon production and an overall loss of salt that is acceptable economically.

In other embodiments, natural gas can be co-fed with oxygen through a halide salt environments which participate in the reaction network. Rapid reaction of oxygen with halide suppresses carbon oxide formation and allows for facilitated natural gas conversion to solid carbon and steam through an alkyl-halide intermediate.

In some embodiments, the various systems and methods described herein relate to novel, high temperature, complex liquid systems and processes comprised primarily of molten salts with unique catalytic properties that allow for the controlled reaction of hydrocarbon molecules (including alkanes contained in natural gas) to be dehydrogenated in an environment where the dehydrogenation reaction is promoted by the catalytic activity of the melt system and reactive separation occurs such that the solid carbon produced can be separated from gas phase chemical products. The reaction environments are engineered to prevent entirely, or limit, in some embodiments, any carbon oxides (CO₂ and CO from being produced.

The feed to the reaction can comprise natural gas. As used herein, the natural gas can generally include and/or consist primarily of light alkanes including methane, ethane, propane, and butane, which are molecules containing only carbon and hydrogen. In some embodiments, the feed can comprise hydrocarbons (e.g., minor amounts of hydrocarbons) containing elements other than hydrogen and carbon as are sometimes present in natural gas or other hydrocarbon feedstocks (e.g., minor amounts of oxygen, nitrogen, sulfur, etc.). Non-oxidative dehydrogenation (pyrolysis) of natural gas-like molecules has been practiced on solid catalysts. Unfortunately, the solid catalysts are rapidly deactivated (coked) and removal of the carbon is difficult and costly. Some embodiments demonstrate that contacting these alkanes with catalytic species within a specific molten salt environment at an appropriate reaction temperature, such as between about 900° C. and about 1,200° C. or approximately 1000° C., allows for dehydrogenation of the alkanes to form solid carbon and molecular hydrogen without coking or otherwise deactivating the catalyst.

The selection of the specific salts is also a component of the invention. Many salts are not suitable for high temperature reaction environments with hydrocarbons, for example most nitrate or carbonate salts are not suitable. A preferred class of salts are halides (chlorides, bromides, etc). In most simple salts (e.g., NaCl, KCl, etc.), this reaction process is relatively slow and may not allow for high conversion, thereby resulting in byproduct polycyclic aromatics and unstructured carbon. By control of the salt type, properties, and/or the addition of specific catalysts the reaction, when performed in unique molten salt environments, deactivation of the catalytic function can be prevented by carrying away carbon produced in the salt, thereby allowing for continuous operation without deactivation. In a simple but relevant example, solid activated alumina is a reasonably active catalyst for methane pyrolysis, however, when it is used as a solid catalyst it rapidly is covered in solid carbon (cokes) and is deactivated. However, with specific molten salts used as solvents and/or scrubbing agents (e.g., to carry, entrain, or remove the carbon from the catalyst), the gas can contact the solid catalyst within the melt, activating the alkane and dehydrogenating it. Within the salt, carbon can be removed from the solid catalyst surface as it is formed removing it from the catalyst active sites allowing the catalytic activity to continue and carrying the carbon out of the reactor with the liquid salt to Where it can be separated and processed. In this environment, the salt acts as a powerful solvent for the carbon and/or as a scrubbing agent to remove the carbon from the catalyst by carrying/entraining the carbon within the molten salt flow. In some embodiments, the catalyst is in the form of fixed solids, solid particles, dispersions, or liquid metal emulsions. In other embodiments, the catalyst is a component of the salt itself.

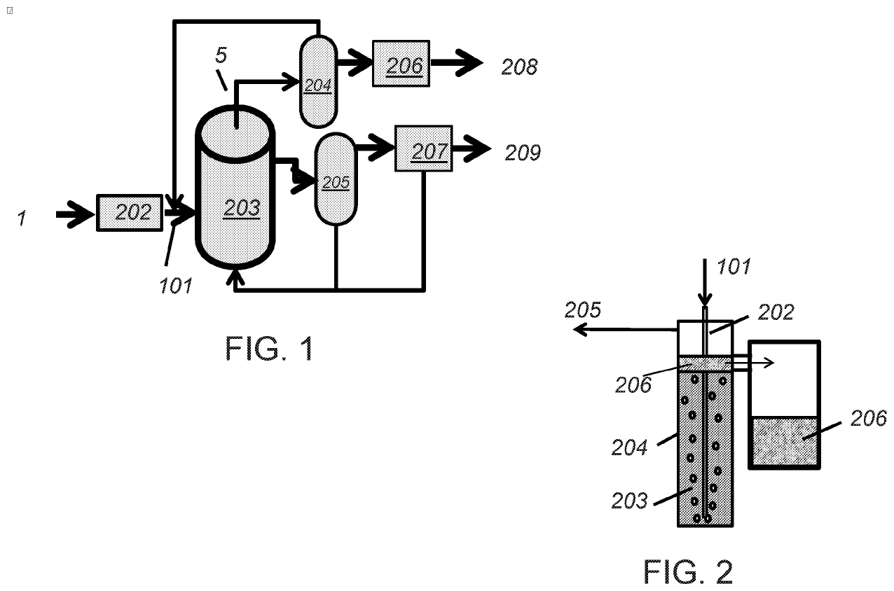

The overall process for conversion of fossil hydrocarbon gases into hydrogen and solid carbon can be understood by reference to FIG. 1. Raw material reactant gases 1 such as natural gas or other hydrocarbon containing primarily hydrogen and carbon can be fed into the process and optionally pretreated to remove any impurities 202. The primary feed 101 can be fed into the reactor system 203 where the catalytic process, within an environment containing a molten salt, converts the reactants to solid carbon and a gas phase product within the reactor. The gas can be disengaged and separated from the liquid and solid either within the main reactor or in a separate unit 204. The gases leave the primary reactor system 5 and the solid carbon is removed. Facilities for separation of the solid carbon from any retained molten medium are provided either within the main reactor or in a separate unit 205. The solid carbon can he physically separated using filters or other physical means due to the sizes of the carbon particles and/or its density difference with the salts. The gas may require additional purification 206 before leaving the process 208. Similarly, the solid may also require additional purification 207 before leaving the process for sale or disposal 209.

The chemical reactant stream or streams 101 can comprise a hydrocarbon such as methane, ethane, propane, etc. and/or mixture such as natural gas. In some embodiments, a common source for methane is natural gas which may also contain associated hydrocarbons ethane and other alkanes and impurity gases which may be supplied into the inventive reactor system. The natural gas also may be sweetened and/or dehydrated prior to being used in the system. The methods and apparatus disclosed herein can convert the methane to carbon and hydrogen, and may also serve to simultaneously convert some fraction of the associated higher hydrocarbons to carbon and hydrogen.

As described herein, the addition of other hydrocarbon gases to methane can improve the overall conversion of the methane to reactant products including solid carbon and hydrogen. The additives can include higher molecular weight hydrocarbons including and aromatic and/or aliphatic compounds, including alkenes and alkynes. Exemplary additives can include, but are not limited to, ethane, ethylene, acetylene, propane, butane, butadiene, benzene, etc. When additives are used with methane, the additives can be present in a volume percentage ranging from 0.1 vol. % to about 20 vol. %, or from about 0.5 vol. % to about 5 vol. %. The addition of the additives can improve the conversion of methane to carbon and hydrogen by a factor of at least 1.1, at least 1.2, at least 1.3, at least 1.4, at least 1.5, at least 1.7, at least 2.0, or at least 2.5.

In some embodiments, the molten salt(s) can comprise any salts that have high solubilities for carbon and/or solid carbon particles, or have properties that facilitate solid carbon suspension making them suitable media for the reactive-separation of hydrocarbon dehydrogenation processes, such as methane pyrolysis. The transport of solid carbon or carbon atoms in molten salts away from the gas phase reactions within bubbles would be effective in increasing the reactant conversion, as most thermal hydrocarbon processes have solid carbon formation. The affinity of solid carbon in molten salts is specific to the salt and can vary greatly.

The selection of the salt can also vary depending on the salt density. The selection of the molten salt(s) can affect the density of the resulting molten salt mixture. The density can be selected to allow solid carbon to be separated by either being less dense or denser than the solid carbon, thereby allowing the solid carbon to be separated at the bottom or top of the reactor, respectively. In some embodiments as described herein, the carbon formed in the reactor can be used to form a slurry with the molten salt. In these embodiments, the salt(s) can be selected to allow the solid carbon to be neutrally buoyant or nearly neutrally buoyant in the molten salt(s).

The salts can be any salt having a suitable melting point to allow the molten salt or molten salt mixture to be formed within the reactor. In sonic embodiments, the salt mixture comprises one or more oxidized atoms (M)^{+m} and corresponding reduced atoms (X)⁻¹, wherein M is at least one of K, Na, Mg, Ca, Mn, Zn, La, or Li, and wherein X is at least one of F, Cl, Br, I, OH, SO₃, or NO₃. Exemplary salts can include, but are not limited to, The molten salts can include, but not limited to, NaCl, NaBr, KCl, KBr, LiCl, LiBr, CaCl₂, MgCl₂, CaBr₂, MgBr₂ and combinations thereof.

When combinations of two or more salts are used, the individual compositions can be selected based on the density, interaction with other components, solubility of carbon, ability to remove or carry carbon, and the like. in some embodiments, a eutectic mixture can be used in the molten salt mixture. For example, a eutectic mixture of KCl (44 wt. %) and MgCl₂ (56 wt %)) can be used as the salt mixture in the molten salt. Other eutectic mixtures of other salts are also suitable for use with the systems and methods disclosed herein.

The selection of the salt in the molten salt mixture can affect the resulting structure of the carbon. For example, the carbon morphology can be controlled through the selection of the reaction conditions and molten salt composition. The produced carbon can comprise carbon black, graphene, graphite, carbon nanotubes, carbon fibers, or the like. For example, the use of some mixtures of salts (e.g., MnCl₂/KCl) can produce a highly crystalline carbon, whereas the use of a single salt may produce carbon having a lower crystallinity.

The reactor can operate at suitable conditions for pyrolysis to occur. In sonic embodiments, the temperature can be selected to maintain the salt in the molten state such that the salt or salt mixture is above the melting point of the mixture while being below the boiling point. In some embodiments, the reactor can be operated at a temperature above about 400° C., above about 500° C., above about 600° C., or above about 700° C. In some embodiments, the reactor can be operated at a temperature below about 1,500° C., below about 1,400° C., below about 1,300° C., below about 1,200° C., below about 1,100° C., or below about 1,000° C.

The reactor can operate at any suitable pressure. When bubbles are desired, the reactor may operate at or near atmospheric pressure such as between about 0.5 atm and about 3 atm, or between about 1 atm and 2.5 atm. Higher pressures are possible with an appropriate selection of the reactor configuration, operating conditions, and flow schemes, where the pressure can be selected to maintain a gas phase within the reactor.

The chemical processes within the reactor itself can be important and are illustrated schematically in an experimental set-up as shown in FIG. 2. The feed 101 can be introduced into the reactor 204 containing the molten salt 203 and components which are active catalysts through a feed tube 202. The feed 101 can include any of the feed components, including the optional additives, as described herein. Similarly, the molten salt 203 can comprise any salt or combinations of salts as described herein. It is the specific composition of the catalyst/melt system that forms part of the novelty of the present systems and methods. The feed 101 passing through the feed tube 202 forms bubbles which react in the catalytic environment to form gas phase products and solid carbon 206, which accumulates within the molten salt 203 as a separate phase and can be removed from the reactor 204. The gas phase products exit the reactor as a gas stream 205. Specific examples below show how this is applied in various reactor configurations and processes.

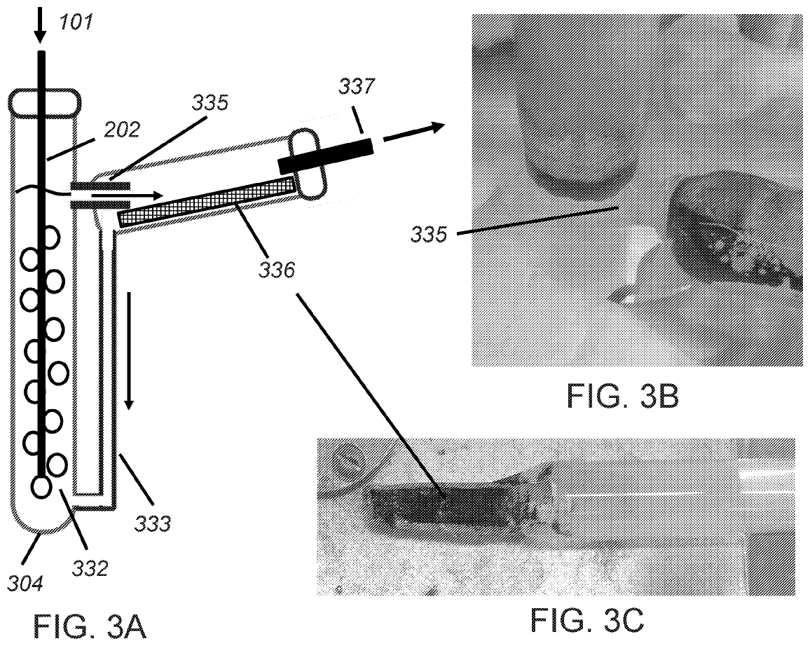

Removal of the solid carbon from the reactor 204 is also a part of the systems and methods disclosed herein. Another embodiment of a reactor configuration is illustrated in FIG. 3A, which makes use of a bubble lift pumping arrangement whereby gas phase reactants 101, including any of the feed components as described herein including natural gas and/or methane, can be introduced into the reactor 304 through an inlet tube 202, and the rising bubbles can lift the molten salt 332 and solid carbon products upwards and out of the main reactor 304 through a connection 335. The mixture can flow and pass over a filter 336 that retains the solid carbon and passes the molten salt 332 back to the reactor 304 through a pipe system 333. The gas phase hydrogen product can leave the reactor as a product stream 337. The photographs in FIGS. 3B and 3C show how the solid carbon can be produced and captured in filter(s) 336, which is further described in Example 1 below

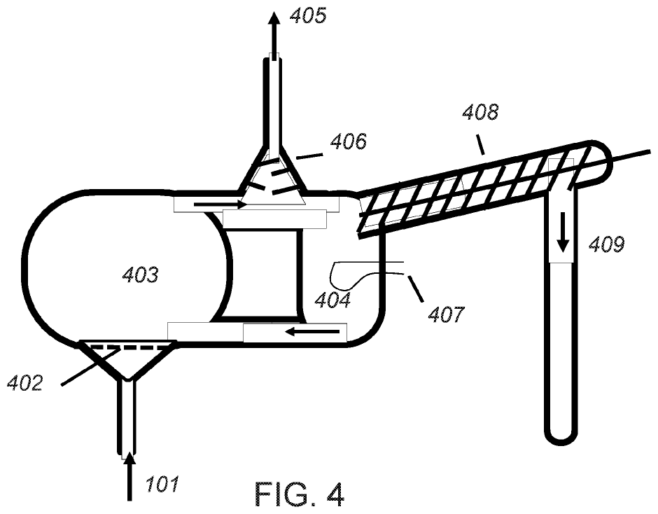

Another embodiment of a reactor system implementation is schematically illustrated in FIG. 4. The feed 101 can be fed into the reactor 403 through a gas distributor 402, which provides for the feed 101 to be bubbled into the molten salt contained within the reactor 403. The feed 101 can have any of the components as described herein. In some embodiments, the feed can comprise primarily methane. The molten salt in the reactor 403 can comprise any molten salt or molten salt mixtures as described herein. The gas bubbles can rise within the reactor 403, carrying both the gas and the liquid upwards while the reaction occurs to produce solid carbon and gaseous hydrogen. At the top of the reactor 403, a liquid stream pushed by the bubble lift action of the gas can pass into a second vessel 404. Between the reactor 403 and the second vessel 404, the hydrogen gas products can be disengaged from the liquid and solid products in a demister 405 before the hydrogen gas leaves the reactor as a hydrogen product stream 405. In the second vessel 404, the solid carbon can be separated by filtration and/or differences in its density (e.g., as compared to the density of the molten salt(s)) and removed from the vessel mechanically using a solid transfer device 408 such as an screw auger. The solid can be transferred to a vessel through a transfer conduit 409 where further processing can be performed if needed. The liquid molten salt stream can return to the main vessel 403 under the influence of the bubble lift pumping with heat added to the melt through heat exchangers elements 407 (e.g., a heat exchanger, steam tube, resistive heater, etc.) to maintain the temperature of the molten salt(s)within the second vessel 404 and/or within the main reactor 403.

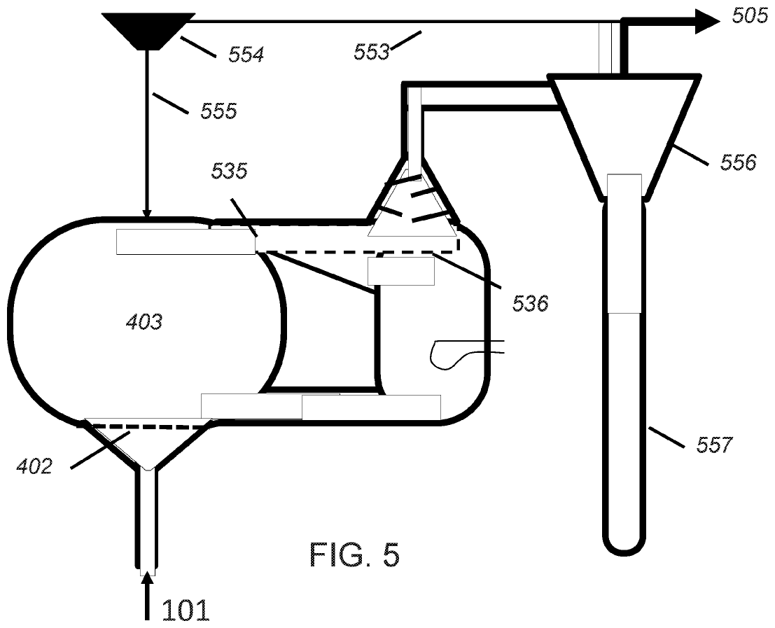

Another embodiment of a reactor system configuration is schematically illustrated in FIG. 5. The reactor system and its operation can be the same or similar to those as described with respect to for the embodiment illustrated in FIG. 4, and similar elements can be the same or similar to those described above. In this embodiment, the mixture of molten salt and solid carbon leave the main reactor 403 through a connecting element 535 and can pass over a filter 536. A high velocity gas stream 555 can be introduced into the gas filled top of the reactor or over the filter 536 and can be used to entrain the solid carbon collected on top of the filter 536 into the gas stream. The gas stream 555 can have a velocity sufficiently high to entrain the carbon from the filter 536. The gas stream with the entrained carbon exits the reactor and is separated in a gas-solid separation system such as a cyclone 556. The gas stream 555 can have a velocity sufficient to entrain the solid carbon, which in some embodiments, can be referred to as a high velocity gas stream. The solid can be collected separately in a collection vessel 557 from the gas, which exits the system as gas stream 505. In some embodiments, a slip stream 553 of the hydrogen product can be used with a blower (e.g., a blower, compressor, turbine, etc.) 554 employed to increase the gas velocity as the entrainment gas stream 555.

In some embodiments, the salt itself can be designed to have catalytic activity without added metal catalysts. In other embodiments, salts without alkali metals such as, but not limited, to MnCl₂, ZnCl₂, AlCl_{3,} when used with host salts including mixtures of KCl, NaCl, KBr, NaBr, CaCl₂, MgCl₂ can provide a reactive environment that dehydrogenates the alkane producing carbon within the melt. In some embodiments, fluorine based salts (e.g., flourides) can be used in the pyrolysis of any of the feed gas components described herein, such as natural gas. In some embodiments, magnesium based salts such as MgCl₂, MgBr₂, and/or MgF₂ can be used for hydrocarbon pyrolysis including methane pyrolysis. Magnesium based salts may allow for high conversion with relatively simple separation of the salt and carbon.

Within any of the molten salt compositions described herein, a portion of the salt melt may be molten, and one or more additional components or elements may be present as solids to produce a multiphase composition. For example, one component may be the liquid phase salt and a second component may be in the solid phase, with the two components forming a slurry or the solid may be fixed around which the salt flows. The solid may be itself a salt, a metal, a non-metal, or a combination of multiple solid components that include a salt, a metal, or a non-metal. In some embodiments, the salt can be entirely in the solid phase. For example, salt particles can be used in the reactors with the feed gas passed over the solid salt particles.

In some embodiments, a multiphase composition within a molten salt can comprise molten metals, metal alloys, and molten metal mixtures that have high solubilities for hydrogen and low solubilities for alkanes, making them suitable media for the reactive-separation of hydrocarbon dehydrogenation processes, such as methane pyrolysis. The molten metal would form an emulsion or dispersion within the molten salt or the molten metal may be on a solid support (e.g. Al₂O₃). The transport of solid carbon or carbon atoms in molten metals could play a similar role as hydrogen in the effective increase in reactant conversion, as most thermal hydrocarbon processes have solid carbon formation. The solubility of solid carbon in molten metals is specific to the metal and can vary greatly.

In some embodiments, a multiphase composition within a molten salt can comprise a catalytic liquid. A catalytic liquid can comprise of a low-melting point metal with relatively low activity for the desired reaction combined with a metal with higher intrinsic activity for the desired reaction, but with a melting point above the desired operating temperature of reaction. The alloy may also consist of an additional metal or metals which further improve the activity, lower the melting point, or otherwise improve the performance of the catalytic alloy or catalytic process. It is understood and within the scope of the present disclosure that the melting point of a catalytic alloy may be above the reaction temperature, and the liquid operates as a supersaturated melt or with one or more components precipitating. It is also understood and within the scope of the present disclosure that one or more reactants, products, or intermediates dissolves or is otherwise incorporated into the melt and therefore generates a catalytic alloy which is not purely metallic. Such an alloy is still referred to as a molten metal or liquid phase metal herein.

The selection of the metal or metals can be based on the catalytic activity of the selected metal. The reactivity of molten metals for catalytic purposes is not well documented or understood. Current preliminary results suggest that metals in the liquid phase have far less activity for alkane activation processes than in their solid phases. Additionally, the differences in activity across different molten metals is far less when compared to the differences in solid metals for catalysis, which differ by orders of magnitudes in terms of turnover frequencies of reactant molecules.

In some embodiments, the liquid comprising a molten metal can comprise nickel, bismuth, copper, platinum, indium, lead, gallium, iron, palladium, tin, cobalt, tellurium, ruthenium, antimony, gallium, oxides thereof, or any combination thereof. For example, combinations of metals having catalytic activity for hydrocarbon pyrolysis can include, but are not limited to: nickel-bismuth, copper-bismuth, platinum-bismuth, nickel-indium, copper-indium, copper-lead, nickel-gallium, copper-gallium, iron-gallium, palladium-gallium, platinum-tin, cobalt-tin, nickel-tellurium, and/or copper-tellurium.

The specific composition of the alloys also influenced the catalytic activity. in some embodiments, the components of the molten metal can comprise between 5 mol. % and 95 mol. %, or between 10 mol. % and 90 mol. %, or between 15 mol. % and 85 mol. % of a first component, with the balance being at least one additional metal. In some embodiments, at least one metal may be selected to provide a desired phase characteristic within the selected temperature range. For example, at least one component can be selected with a suitable percentage to ensure the mixture is in a liquid state at the reaction temperature. Further, the amount of each metal can be configured to provide the phase characteristics as desired such as homogeneous molten metal mixture, an emulsion, or the like.

In some embodiments, solid components such as solid metals, metal oxides, metal carbides, and in some embodiments, solid carbon, can also be present within a molten salt as catalytic components, For example, solid components can be present within the molten solution and can include, but are not limited to a solid comprising a metal (e.g. Ni, Fe, Co, Cu, Pt, Ru, etc.), a metal carbide (e.g. MoC, WC, SiC, etc.), a metal oxide (e.g. MgO, CaO, Al₂O₃, CeO₂, etc.), a metal halide (e.g., MgF₂, CaF₂, etc), solid carbon, and any combination thereof. The solid component can be present as particles present as a slurry or as a fixed component within the reactor. The particles can have a range of sizes, and in some embodiments, the particles can be present as nano and/or micro scale particles. Suitable particles can include elements of magnesium, iron, aluminum, nickel, cobalt, copper, platinum, ruthenium, cerium, combinations thereof, and/or oxides thereof.

In sonic embodiments, the solid component can be generated in-situ. In some embodiments, a transition metal solid can be generated in situ within the molten salt(s). in this process, transition metal precursors can be dispersed within the molten salt either homogeneously such as transition metal halide (e.g. CoCl₂, FeCl₁₂, FeCl₃, NiCl₂, CoBr₂, FeBr₂, FeBr₃, or NiBr₂) dissolved in molten salt, or heterogeneously such as transition metal oxide solid particles (e.g. CoO, Co₃O₄, FeO, Fe₂O₃, Fe₃O₄, NiO) suspended in the molten salt. Hydrogen can then be passed through the mixture and the catalyst precursors can be reduced by the hydrogen. Transition metal solids can be produced and dispersed in the molten salt(s) to form the reaction media for the methane decomposition reactions.

In some embodiments, a multiphase composition can comprise a solid catalytic component. The catalytic solid metal can comprise nickel, iron, cobalt, copper, platinum, ruthenium, or any combination thereof. The solid metals may be on supports such as alumina, zirconia, silica, or any combination thereof. The solids catalytic for hydrocarbon pyrolysis would convert hydrocarbons to carbon and hydrogen and subsequently be contacted with a liquid molten metal and/or molten salt to remove the carbon from the catalyst surface and regenerate catalytic activity, Preferred embodiments of the liquids include but are not limited to molten metals of: nickel-bismuth, copper-bismuth, platinum-bismuth, nickel-indium, copper-indium, copper-lead, nickel-gallium, copper-gallium, iron-gallium, palladium-gallium, platinum-tin, cobalt-tin, nickel-tellurium, and/or copper-tellurium. The molten salts can include, but not limited to, NaCl, NaBr, KCl, KBr, LiCl, LiBr, CaCl₂, MgCl₂, CaBr₂, MgBr₂ and combinations thereof.

In some embodiments, specific compositions of molten metal(s) or solid(s) used in the systems and processes described herein can provide for different types of carbon products. A composition of molten materials for performing alkane pyrolysis can include a metal having a high soluble for carbon including but not limited to alloys of Ni, Fe, Mn, which produce a carbon product which is mostly graphitic type carbon. A composition of molten materials for performing alkane pyrolysis can include a metal which has limited solubility to carbon including but not limited to alloys of Cu, Sn, Ag, which produce a carbon product which is mostly disordered type carbon.

in some embodiments, a multiphase composition can comprise a solid salt component. The salt can comprise a salt component below its melting point within the reactor, or a salt above its saturation composition within the salt mixture; for example, solid CaF₂ in molten NaCl.

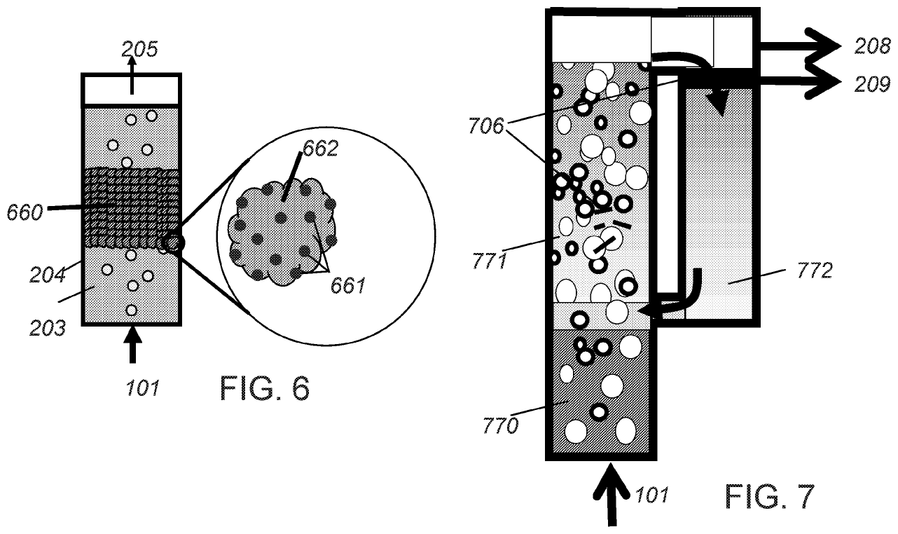

Another implementation of a reactor system is sthematically illustrated in FIG. 6. The feed 101 comprising a hydrocarbon, which in some embodiments can primarily be methane, can be fed into the reactor 204 and the gas bubbles can pass over a packed bed of fixed solids 660. The solids 660 can have catalytic activity for the feed including hydrocarbon and/or methane pyrolysis. The solids 660 can comprise any of those solids described above with respect to the solid catalytic components (e.g., metals, metal oxides, solid salts, etc.). In some embodiments, the fixed solids can comprise a catalyst support material 662 and an active catalyst 661, including any of the catalytic components described above. In some embodiments, the catalyst support material 662 can have catalytic activity for pyrolysis and can be present alone (e.g., as having both functionalities) or in combination with another catalytic component. The feed 101 can react within the molten salt(s) and/or based on contact with the solids 660 to produce carbon and hydrogen. The hydrogen can be removed from the top of the bed as a gas stream 205, and the solid carbon can be removed in one of the many ways described herein.

In some embodiments, a multiphase composition can comprise a molten salt or molten metal component confined to a solid support. The molten component can comprise a molten salt or metal above its melting point that is immiscible with the main molten salt(s) in the reactor. The molten component can be present on a surface such as a support formed from alumina, zirconia, and/or silica such that the molten component remains coupled to the surface based on surface tension. This allows the molten component to act as a reaction site while not being free to move within the reactor.

In some embodiments, the molten salt(s) can comprise a molten salt containing solid catalysts including metals (e.g. Fe) and/or non-metals including oxides (e.g. CaO, MgO) and/or solid salts (e.g. MgF₂) and/or supported molten catalysts (metals or salts immiscible in the main salt). A hydrocarbon gas can be bubbled through a high-temperature molten salt with a bed of supported molten salt particles, where the molten salt particles adhere or are retained on the support based on surface tension. The supported molten salt sites on the solid catalyst support greatly increase the surface area for reactions to occur. The supported molten salt species should be chosen to be immiscible within the molten salt used for the surrounding environment to ensure the supported sites stay anchored due to surface tension. The dynamic liquid surfaces can prevent C—C bond coordination. Furthermore, the surrounding molten salt environment can be chosen to have a higher carbon wettability to uptake any C atoms deposited on the supported molten salt sites; this can help to reduce or prevent coking and plugging of the packed bed reactor.

In some embodiments, the molten salt flows around a fixed solid that has catalytic activity and removes, solvates, and/or washes off the solid carbon formed at the catalytic surface carrying the carbon out of the reactor. This use of a molten salt as a liquid decoking agent is a unique aspect of the systems and methods described herein.

Another embodiment of a reactor configuration is schematically illustrated in FIG. 7, whereby a catalytic molten metal 770 exists in a separate phase due to its density difference from a molten salt phase 771, which floats or resides on top of the molten metal 770. The reactor system can comprise two vessels. The two vessels can be configured in such a way that the feed 101 comprising the hydrocarbon reactant (e,g., methane or other reactant gas, including any optional additives) entering at the bottom of the reactor reacts in the catalytic molten metal 770 to produced solid carbon 706 and hydrogen gas. The bubbles comprising the hydrogen gas and potentially some unreacted hydrocarbon reactant can rise and act as a bubble lift pump to move the molten salt 771 containing the carbon 706 from the first vessel into the second vessel where it is separated and removed as a carbon product 209. At the top of the reactor the gas and liquid disengage from the gaseous phase, and the gas exits the system as a gas stream 208 while the liquid molten salt 772 circulates under the bubble lift pumping action back to the first vessel. The presence of the salt column with the molten salt 771 on top of the reactive metal 770 allows the condensation and partial removal of non-salt vapors from the gas phase, thereby providing for a clean carbon product.

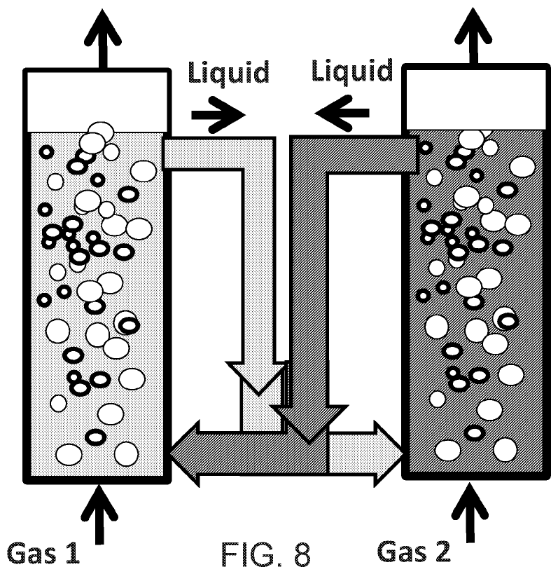

FIG. 8 illustrates how two reactors can be connected in series to allow two separate gas/liquid phase reactions. As shown, two molten salt bubble columns can be connected in series allowing co-current circulation of the molten salt with two different gases. One gas may be reactive and another used to exchange heat by direct contact. At the top of the reactor the gas and liquid disengage and the gas exits the reactor while the liquid that had been in contact with the gas flows from the top of first reactor to the second reactor.

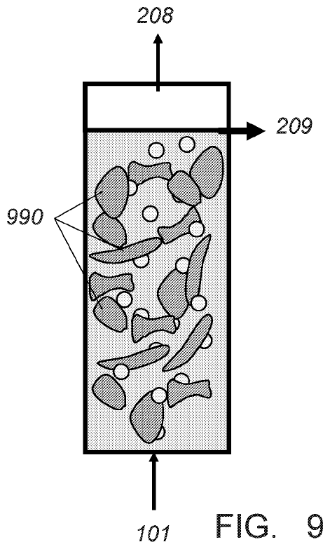

In some embodiments, the molten salt mixture can comprise a catalytic molten metal emulsified within a molten salt, or a molten salt emulsified within a molten metal. Referring to FIG. 9, a feed 101 can be bubbled through a high-temperature emulsification 990 of molten metal in molten salt or vice versa. The feed 101 can comprise any of the components as described herein, and the molten salt(s) can comprise any of the components as described herein. The molten metals can include any metal, metals, alloys, etc. as described above. The emulsification 990 has a much higher surface area to volume ratio than pure molten salts or molten metals would have on their own. In turn, the reactive surface area available for the hydrocarbon gas bubbles is larger, resulting in larger rates of hydrogen production. The emulsification 990 also provides the opportunity to have processes and reactions that are normally selective to salt or metal interfaces carried out in concert. Emulsification can be achieved by either adding an emulsifying agent to salt-metal mixture or high gas velocities disrupting a normally layered molten metal-molten salt column.

In some embodiments, the emulsion as discussed with respect to FIG. 9 can be formed as a nano or micro-scale emulsion using a high rate of mixing or shear, for example, using a high velocity gas stream. Referring to FIG. 7 and FIG. 50, a reactor configuration with both molten metals and molten salts can be used to produce kinetically stable nanoemulsions of catalytically active molten metals in the molten salts as a solvent, by introducing high velocity gas to generate an emulsion. The immiscible metal and metal salts are melted under mechanical stirring and gas flow to produce a homogeneous mixture of the reagents. This leads to the production of micron to nanosized droplets of molten metal dispersed in the molten salt.

An important aspect of the process is the control of the type of carbon produced and its separation for use as a valuable commercial product. As will be shown in the examples, use of specific salt combinations and specific conditions allows the generation of specific forms of carbon ranging from carbon black type carbon to crystalline graphitic carbon.

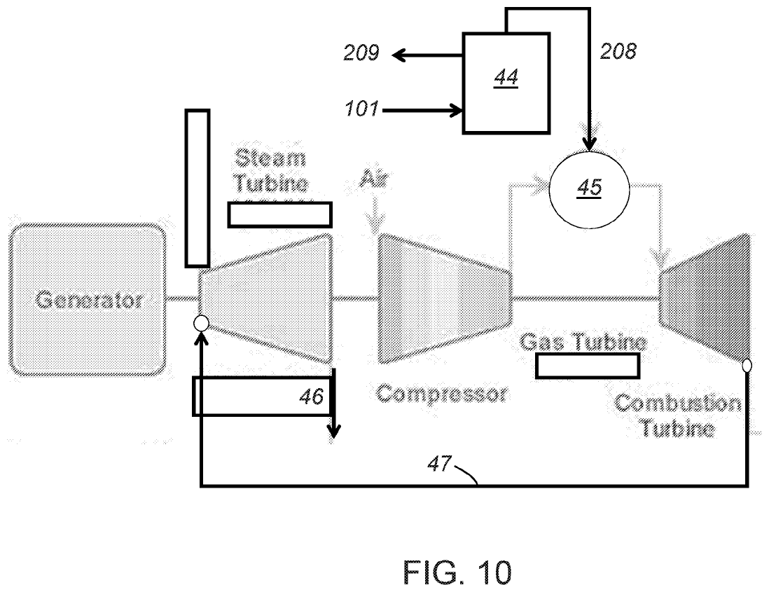

The reaction systems and processes described herein can be used in electrical power production processes. FIG. 10 illustrates schematically the continuous process for electrical power generation using the hydrogen 208 produced in a pyrolysis unit 44 in a combined cycle gas turbine by reacting the hydrogen with oxygen in a combustion chamber 45 according to the reaction: H₂+½O₂→H₂O, which drives a combustion turbine. The high pressure high temperature steam 47 is then passed to steam turbine producing additional power and lower pressure and temperature steam 46. The overall efficiency of the cycle can exceed all modern single stage turbine power cycles.

In some embodiments, the process uses a chemical looping salt. In one step, a hydrogen halide is converted to a halide salt by reaction with an oxide or hydroxide. In a second step, oxygen reacts with a halide salt to produce a halogen and an oxide or hydroxide, completing the salt chemical looping cycle. In the process, the alkane reacts with a halogen and forms a hydrogen halide. The hydrogen halide is converted back to a halogen in the salt chemical looping cycle, which completes a halogen looping cycle so that neither halogens nor salts are stoichiometrically used they are neither used nor produced in the overall process as represented by (in this example methane represents any hydrocarbon):

CH₄+2X₂→C+4HX

4HX9+2MO→2MX₂+2H₂O

2MX₂+O₂→2X₂+2MO

The process can use natural gas and produce carbon from methane or natural gas hydrocarbons, as well as power from the exothermic reaction. A steam cycle may be used to convert the exothermic heat generated in the process to electrical power. The carbon produced may be used or stored as needed (e.g., as a stable product it can be stored indefinitely). The net effect is the selective, partial oxidation of the carbon in the natural gas feed to zero oxidation state. Also as demonstrated and explained in the Examples, the carbon can be removed without fouling of the catalytic surface by using a liquid (molten salt) catalyst in which carbon can be phase-separated. In another embodiment, oxygen and methane can be co-fed or fed into separate locations in a reactor or in separate reactors. The oxygen reacts with a halide salt to form a halogen containing intermediate. This intermediate is reacted with methane in another region of the reactor or in a separate reactor. The reaction results in the production of carbon which is separated and removed. When two reactors are used, the salt or salt slurry can flow between the reactors. The gaseous products from one reactor may also be combined with the feed to the other. For example, iodine can be produced from the reaction between lithium iodide and oxygen and combined with methane in another portion of the reactor or in another reactor. Iodine may also be dissolved in the salt and transported in the liquid phase with the salt to contact methane.

Whereas in the above application the metal halide salt and its oxide are used in a looping configuration to recycle molecular halogen, X₂, which serves as the active alkane activation agent. In another embodiment, the salt itself is the catalyst used for activation and conversion of alkanes to carbon and hydrogen. The reactor system and process is based on a general molten salt mixture whereby the salt mixture has one or more active metal components comprised of oxidized atoms (M_{A})⁺ⁿ and reduced atoms (X)⁻¹. Examples of such active metal components can include, but are not limited to, M_{A}=Zn, La, Mn, Co, Ni, Cu, Mg, Ca, and X═F, Cl, Br, I, OH, SO₀₃, NO₃, that can be mixed with a second solvent salt mixture that has one or more oxidized atoms (M)^{+m} and reduced atoms (X)⁻¹. Example of one or more oxidized atoms (M)^{+m} and reduced atoms (X)⁻¹ can include, but are not limited to, M=K, Na, Li and X═F, Cl, Br, I, OH, SO₃, NO₃. As disclosed herein, specific combinations of salts have been identified having high activity for conversion of alkanes R-H to carbon and hydrogen. In particular, specific active salts facilitate reactions including pyrolysis of alkanes, R—H (where R═CH₃, C₂H₅, etc) through formation of specific active metals M_{A} coordinated with reduced atoms Xₙ that make the metals electrophilic facilitating the reaction:

CH₄+(M_{A}Xₙ)→(H₃CHM_{A}Xₙ)→C+2H₂+(M_{A}Xₙ)

It is the identification of specific metals MA made particularly active in combinations with specific solvent salts for use in complete dehydrogenation of hydrocarbons that is an important part of the reactions within the systems and methods described herein. When directly coupled to a hydrogen combustion process, the molten salt-based dehydrogenation above can be used to produce steam that may be used to produce power. In some embodiments as depicted in FIG. 10, a continuous process consisting of a pyrolysis unit produces hydrogen which is contacted with oxygen (or air) in a combustion chamber and the resulting high temperature steam produced by the reaction introduced into a high temperature, high pressure gas turbine. The exhaust steam still contains sufficient potential energy to be introduced into a conventional steam turbine as a second stage.

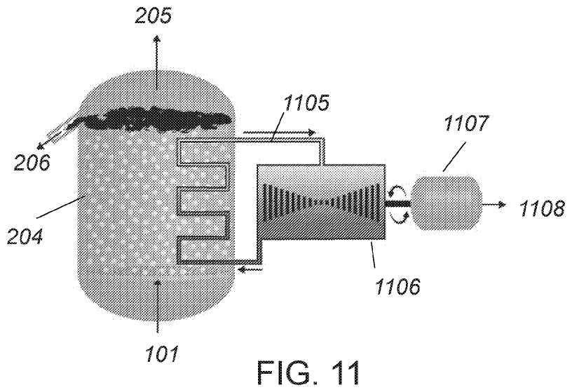

Referring to FIG. 11, a system for the production of carbon and power is schematically illustrated. As shown, a hydrocarbon gas (e.g., methane, natural gas, etc.) and oxygen can be sent as a feed stream 101 or two independent gas streams to a reactor containing a reactive molten halide salt 204. The feed 101 can comprise any of the components as described herein, and the molten halide salt 204 can comprise any of the salt(s) as described herein wherein the molten salt(s) have a halide salt. In the reactor, the hydrocarbon gas can be converted to form solid carbon, which floats to the surface and can be removed as a solid carbon product 206. The hydrogen in the hydrocarbon gas can be reacted to produce steam 1105 and leave the reactor. The reaction is exothermic and a steam cycle is used to generate electrical power 1108 from the heat of reaction using a steam turbine 1106 and electricity generator 1107.

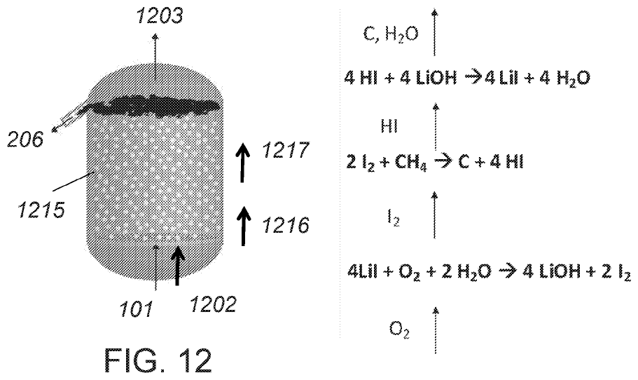

Referring to FIG. 12, the reaction pathway and intermediates in the reduction of a hydrocarbon gas to carbon are schematically illustrated. As shown, the various intermediates can be explained in the figure using iodine, lithium iodide, and lithium hydroxide as exemplary intermediates. A feed 101 comprising a hydrocarbon such as methane and oxygen 1202 may be fed together or, as indicated in the figure, separately relying on the solubility of the halogen in the salt to provide a source of halogen vapor within the methane containing bubble. When oxygen gas 1202 reacts with a halide salt (e.g., LiI), a halogen (e.g., I₂) can be produced. The halogen can stay in a gas bubble, dissolve in the melt 1215, or be combined with another gas stream of methane. The halogen can react with the hydrocarbon such as methane to form hydrogen halide (HI) and carbon via radical gas-phase reactions. This step may also occur from a surface or melt-stabilize halogen, such as I₄⁻².The produced carbon 206 floats to the melt surface and can be removed. The hydrogen halide reacts with an oxide, oxyhalide, or hydroxide (LiOH) to form the original halide and water 1203.

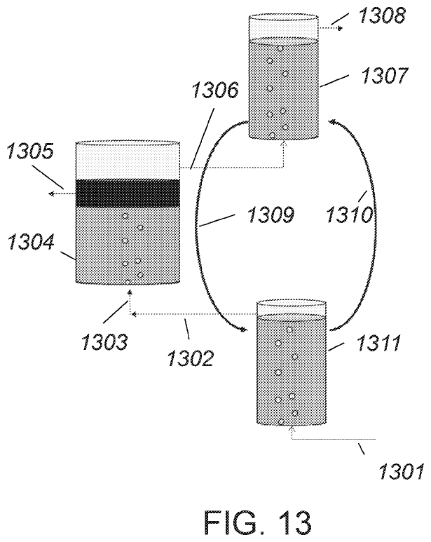

Referring to FIG. 13, the various reaction steps described with respect to FIG. 12 can be split into separate reactors with mixing between reactors. The salt chemical looping steps can be split into a reactor with oxygen addition and hydrogen halide addition. These two reactors could also be combined into a single reactor with both steps occurring simultaneously. The reactor with methane addition may consist of the same chemical looping halide salt, or another catalytically active melt, for example a molten metal, molten salt, or other liquid catalytic media may be used. A bromide salt used in this example of a bromine and bromide chemical looping cycle. Oxygen 1301 is contacted with a reactive bromide salt 1309 in a slurry 1311 that may be dissolved in other salts: bromine 1302 and oxide or oxy-halides 1310 are produced. The bromine 1302 is then contacted with methane 1303 in a separate vessel to produce separable carbon 1305 and hydrogen bromide 1306. Hydrogen bromide 1306 is then sent to another reaction vessel and contacted with an oxide or oxyhalide 1307 to produce steam 1308 and a bromide or oxybromide 1309. The bromide or oxybromide 1309 is then re-cycled to the first reactor, completing a chemical looping cycle for both the salt and halogen. Heat transfer may occur in one or more vessels, depending on the choice of salt.

In some embodiments, the oxygen present in the reactor may be provided by an oxide or hydroxide, thereby providing an oxygen carrier. A multi-reactor system can be used to separately react the hydrocarbons with the oxide or hydroxide followed by a separate reaction between the resulting product and molecular oxygen. This may help to prevent direct reaction between molecular oxygen and the hydrocarbon.

In some embodiments, the carbon morphology can be controlled through the selection of the reaction conditions and molten salt composition. The produced carbon can comprise carbon black, graphene, graphite, carbon nanotubes, or the like. In order to facilitate the collection and separation of the carbon, the density of the molten salt at the reaction conditions can be selected to have a density comparable or greater than the density of the solid carbon.

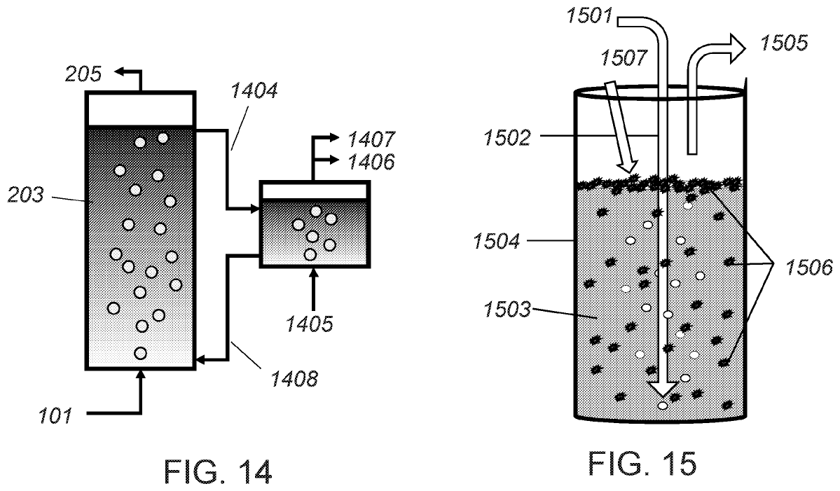

Referring to FIG. 14, a system is schematically illustrates that allows for the formation of a salt slurry that can be separately processed. As illustrated, a feed 101 comprising a hydrocarbon gas can be bubbled through a high-temperature, molten salt 203 to thermochemically decompose it into molecular hydrogen 205 and solid carbon. The gaseous hydrogen 205 can be collected at the top of the reactor and solid carbon can float to the molten salt 203 surface. A molten salt is chosen to have a density comparable to solid carbon at reaction temperature, so a molten salt-carbon slurry 1404 forms. This slurry is diverted into a separate vessel via gravitational forces, a molten salt pump, and/or and auxiliary gas flow. A separate stream of oxygen 1405 can be bubbled through the slurry to combust all of the solid carbon, producing a pure stream of CO₂ 1407 and heat 1406. The hot CO₂ stream can be passed through a turbine to generate power and cool it for compression and sequestration or utilization. The power generated from this combustion can be fed back into the first vessel to drive the endothermic decomposition. Regenerated salt 1408 (e.g., a substantially carbon-free or pristine salt) can then be recycled back to the base of the molten salt reactor.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims in any manner.

### Example 1

Referring to FIG. 3, the pyrolysis of methane was performed to form hydrogen and solid carbon, which was separated through filtration in a bubble lift pump. 100% methane was used as the feed 101 at a rate of 30 sccm into a reactor at 1000° C. containing a molten mixture of 50% KCl and 50% NaCl salt through a concentric inlet tube 202 made of quartz. The feed gas was caused to bubble upwards in the liquid filled reactor 332. The methane reacted within the bubble, and the products, carbon and hydrogen, together with the liquid were lifted upwards in the reactor by virtue of their density differences. At the top of the liquid, a passage allows the liquid containing the carbon and gas to move out of the main reactor section 335 and be passed over a filter 336, where the solid carbon was retained and the molten salt passed. The filter was removable and the photograph shows the solid carbon retained on the filter. The gas phase product was primarily hydrogen which exited the reactor 337. The molten salt returned to the bottom of the reactor under the influence of the bubble lift pumping 333.

### Example 2

### Methane Pyrolysis in Binary Molten Salts

In a second example, methane is thermally decomposed in a reactor configuration according to simplified illustration FIG. 15. Some embodiments may also include more reaction zones, post-reaction separation units, or gas preheating units.

In this specific example, a feed stream 1501 of methane having a flow rate of 15 sccm at 1 bar of pressure was bubbled through a quartz inlet tube 1502 (having a 3 mm outer diameter (OD) and a 2 mm inner diameter (ID)) into an alkali-halide molten salt 1503 housed in a quartz reactor 1504 (having a 25 mm OD, 22 mm ID). 77 cm³ of molten salt in total were loaded in the reactor. Bubble rise velocities were estimated to be 24 cm/s, resulting in a gas residence time of about 0.75 seconds. Gaseous products such as hydrogen, C₂ hydrocarbons (e.g. ethane, ethene, and acetylene), aromatics (e.g. benzene), and unreacted methane were collected from the top of the column 1505 and analyzed using a mass spectrometer. Solid carbon formed from thermal decomposition of methane accumulated throughout the column and at the melt surface 1506. In different embodiments, the propensity for carbon to float or sink could be controlled by altering the density of the molten salt media. Argon as an inert gas (30 sccm) was delivered to the surface of the melt in order to suppress reactions in the headspace 1507.

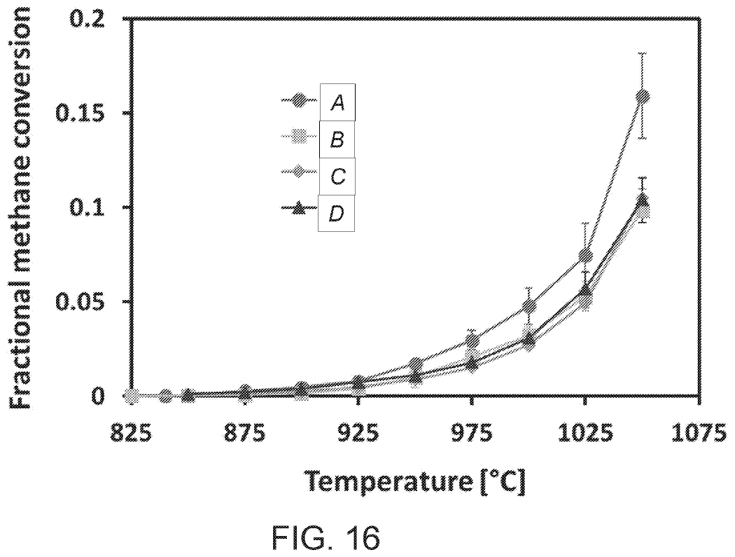

The fractional conversion of methane versus temperature in KCl (A), KBr (B), NaCl (C), and NaBr (D) is shown in FIG. 16. 15 sccm of methane was bubbled into the molten salt bubble column and solid carbon formed accumulated throughout the column. Gas residence times were estimated to be 0.75 seconds. Methane conversion lit off around 900° C. and increased exponentially with temperature, with a 3-5% conversion at 1000° C. and a 10-16% conversion at 1050° C. At longer gas residence times (e.g., taller bubble columns), the methane conversions would improve further. Solid carbon was made at steady-state and collected from the melt after cooling down.

From the differential methane conversion measurements presented in FIG. 16, apparent kinetic parameters (e.g., activation energies and pre-exponential factors) can be estimated using the following simple kinetic model for methane consumption:

$$\frac{d [ {CH}_{4} ]}{dt} = - {k}_{f} [ {CH}_{4} ]$$

and assuming k_{f} can be described using the Arrhenius equation. The apparent kinetic parameters for the different alkali-halide salts (KCl, KBr, NaCl, NaBr) are shown in TABLE 1. The measured apparent activation energies of ˜300 kJ/mole are markedly lower than reported values for non-catalytic, gas-phase methane pyrolysis which range from 350-450 kJ/mole.

TABLE 1
Apparent kinetic parameters measured for methane pyrolysis in molten
alkali-halide bubble column reactors. Pre-exponential factors and
activation energies reported have errors of ±50% and ±10%,
respectively.

| Molten alkali- | Pre-exponential | Activation energy |
|---|---|---|
| halide salt | factor [1/s] | [kJ/mole] |
| KCl | 4.5 × 10¹⁰ | 290 |
| KBr | 1.8 × 10¹¹ | 309 |
| NaCl | 1.7 × 10¹¹ | 308 |
| NaBr | 1.3 × 10¹¹ | 304 |

This Example demonstrates the successful conversion of methane in a molten salt bubble column reactor with effective rates faster than non-catalytic gas-phase chemistry. The solid carbon formed from the decomposition of methane at high temperatures accumulates in the melt, whereby it can be separated from the top or bottom of the reactor, Current heterogenous catalytic reactor designs are unable to avoid deactivation and reactor plugging from the solid carbon formed during methane pyrolysis without burning it.

### Example 3

### MP in Carbon-Salt Slurries

In this example, methane was thermally decomposed in a reactor configuration according to simplified illustration FIG. 15. Some embodiments may also include more reaction zones, post-reaction separation units, or gas preheating units. Other embodiments may introduce solids suspended in the molten salt media to enhance reaction rates and increase reactive surface areas. For example, both metal and carbon-based materials have been explored thoroughly as heterogenous methane conversion catalysts.

In this specific example, a feed stream 1501 of methane (15 sccm) at 1 bar of pressure was bubbled through a quartz inlet tube 1502 (having a 3 mm OD and a 2 mm ID) into an alkali-halide molten salt 1503 (i.e. NaCl, NaBr, KCl, or KBr) housed in a quartz reactor (having a 25 mm OD, and a 22 mm ID) at 1000° C. 77 cm³ of molten salt in total were loaded in the reactor. Bubble rise velocities were estimated to be 24 cm/s, resulting in a gas residence time of about 0.75 seconds. Gaseous products such as hydrogen, C₂ hydrocarbons (e.g. ethane, ethane, and acetylene), aromatics (e.g. benzene), and unreacted methane were collected from the top of the column 1505 and analyzed using a mass spectrometer. Solid carbon formed from thermal decomposition of methane accumulated throughout the column and at the melt surface 1506. In different embodiments, the propensity for carbon to float or sink can be controlled by altering the density of the molten salt media. Argon as an inert gas (30 sccm) was delivered to the surface of the melt in order to suppress reactions in the headspace 1507.

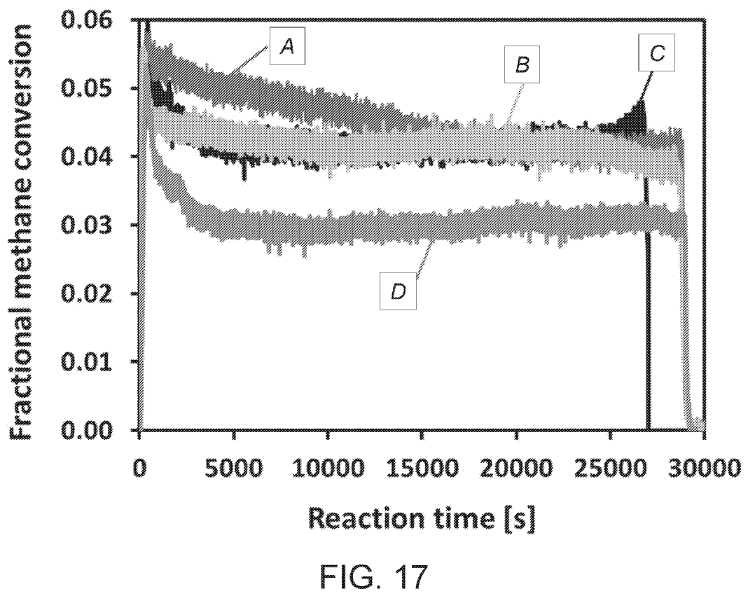

The fractional conversion of methane versus time on stream for an 8-hour reaction period is shown in FIG. 17 for methane pyrolysis at 1000° C. in four binary molten salts: (A) KCl, (B) KBr, (C) NaCl, and (D) NaBr. The products of the feed additive decomposition (e.g. methane and hydrogen) are accounted for in this data. 15 sccm of methane was bubbled into the reactor and solid carbon formed accumulates throughout the column, but did not demonstrate gas-solid interactions. Gas residence times were estimated to be 0.75 seconds. As solid carbon was produced and accumulated in the molten salt bubble columns, more reactive surface area was effectively created, as solid carbon (especially amorphous carbon) is well-known to be catalytic for methane pyrolysis. However, it is clear in FIG. 17 that the conversion of methane does not increase over time despite considerable carbon build-up, suggesting that the salt prevents gas-solid (i.e. methane-carbon) contacting and reaction. This “wetting” of the carbon by the molten salt is also expected to prevent the carbon from catalyzing or participating in back-reactions, potentially shifting equilibrium towards the products (e.g., hydrogen gas).

This Example demonstrates the successful conversion of methane in molten salt bubble column reactors and the wetting of carbon species by the liquid salts. Other embodiments may optimize the gas-solid-liquid interactions to allow for gas-solid contacting and facile solid-liquid separations.

### Example 4

### Pyrolysis with Hydrocarbon Feed Additives

In this example, a feed stream of methane was thermally decomposed in a reactor configuration according to simplified illustration FIG. 15. Some embodiments may also include more reaction zones, post-reaction separation units, or gas preheating units. Other embodiments may introduce mixtures of hydrocarbon gas feeds. For example, it is well-known that hydrocarbon gases can decompose and react via radical pathways. Therefore, hydrocarbons that decompose into radical products with lower energy barriers (e.g., ethane and propane) can be utilized to react with hydrocarbons that decompose with higher energy barriers (e.g., methane).

In this specific example, a feed stream 1501 of methane (15 sccm) with hydrocarbon feed additives (e.g. methane, ethane, ethylene, acetylene, propane, butane, butadiene, benzene, etc.) at 1 bar of pressure was bubbled through a quartz inlet tube 1502 (having a 3 mm OD, and a 2 mm ID) into molten KCl 1503 housed in a quartz reactor 1504 (having a 25 mm OD, and a 22 mm ID) at temperatures between 850-1025° C. 77 cm³ of molten KCl in total was loaded in the reactor. Bubble rise velocities were estimated to be 24 cm/s, resulting in a gas residence time of about 0.75 seconds. Gaseous products such as hydrogen, C₂ hydrocarbons (e.g. ethane, ethene, and acetylene), aromatics (e.g. benzene), and unreacted methane were collected from the top of the column 1505 and analyzed using a mass spectrometer. Solid carbon formed from thermal decomposition of methane (and hydrocarbon additives) accumulated throughout the column and at the melt surface 1506. In different embodiments, the propensity for carbon to float or sink can be controlled by altering the density of the molten salt media. Argon as an inert gas (30 sccm) was delivered to the surface of the melt in order to suppress reactions in the headspace 1507.

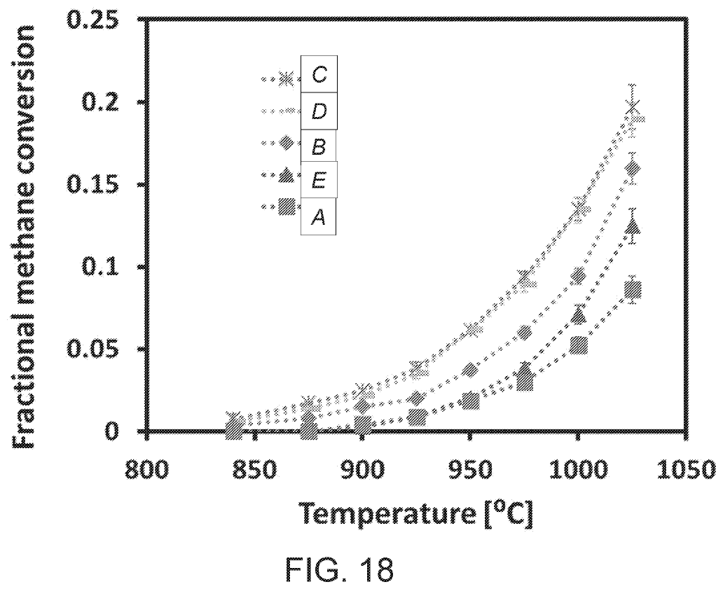

The fractional conversions of pure methane (A) and methane with 2% volume ethane (B), propane (C), acetylene (D), and benzene (E) are shown in FIG. 18. The products of the feed additive decomposition (e.g., methane and hydrogen) are accounted for in this data. 15 sccm of methane (+additive) was bubbled into the KCl bubble column and solid carbon formed accumulated throughout the column. Gas residence times were estimated to be 0.75 seconds. Regardless of hydrocarbon feed additive, the consumption rate of methane was enhanced in the presence of the feed additive (and its decomposition products) when compared to the pure methane feed. Methane conversion markedly improves with feeds of 2% propane (C) and 2% acetylene (D), with an increase from 5% methane conversion with pure methane at 1000° C. to 13% methane conversion with the aforementioned additives.

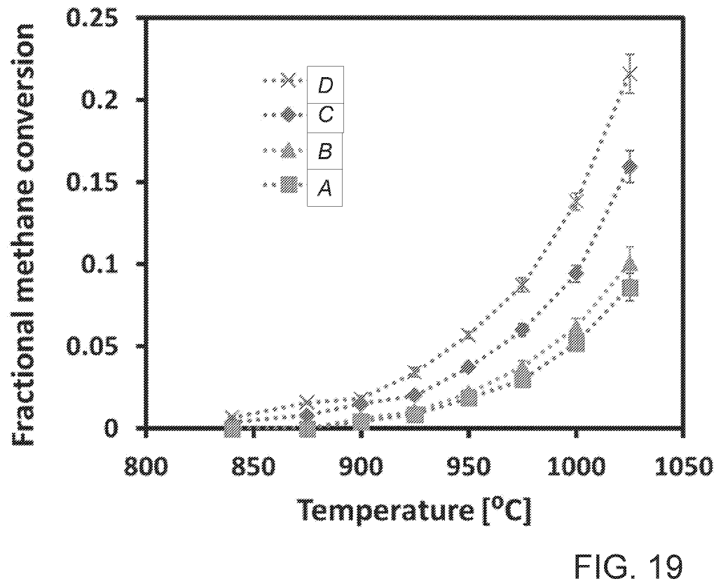

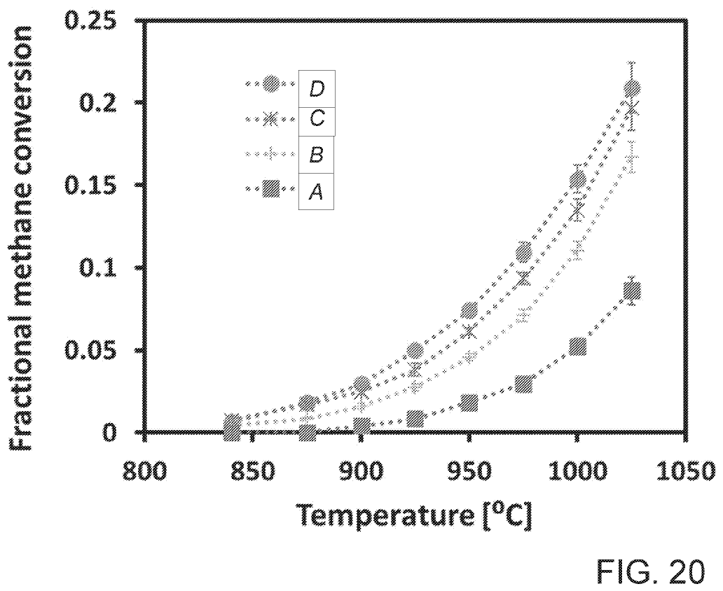

Aside from methane, light alkanes such as ethane, propane, and butane are common components of natural gas and are likely to be abundant for the next several decades. Therefore, it is conceivable these alkane impurities may be readily added or removed from natural gas, allowing for optimization of their volume percentages in terms of their effects on methane decomposition rates. FIG. 19 plots fractional methane conversion versus temperature for 0% (A), 1% (B), 2% (C), and 5% (D) by volume ethane 15 sccm of methane (+additive) was bubbled into the KCl bubble column and solid carbon formed accumulates throughout the column. Gas residence times were estimated to be 0.75 seconds. FIG. 20 plots fractional methane conversion versus temperature for 0% (A), 1% (B), 2% (C), and 5% (D) by volume propane. 15 sccm of methane (+additive) was bubbled into the KCl bubble column and solid carbon formed accumulates throughout the column. Gas residence limes were estimated to be 0.75 seconds. In both sets of data, the methane consumption rate increases as the feed volume percentage of the hydrocarbon additive increases. However, there is likely a threshold in the feed additive percentage where the amount of hydrogen produced from the hydrocarbon additive inhibits methane consumption rates.

This Example demonstrates the successful conversion of methane in a molten KCl bubble column reactor with enhanced reaction rates from hydrocarbon feed additives. The feed compositions of natural hydrocarbon impurities such as ethane and propane can be adjusted to optimize the decomposition rate of methane. No specialized apparatus or additional catalyst is required.

### Example 5

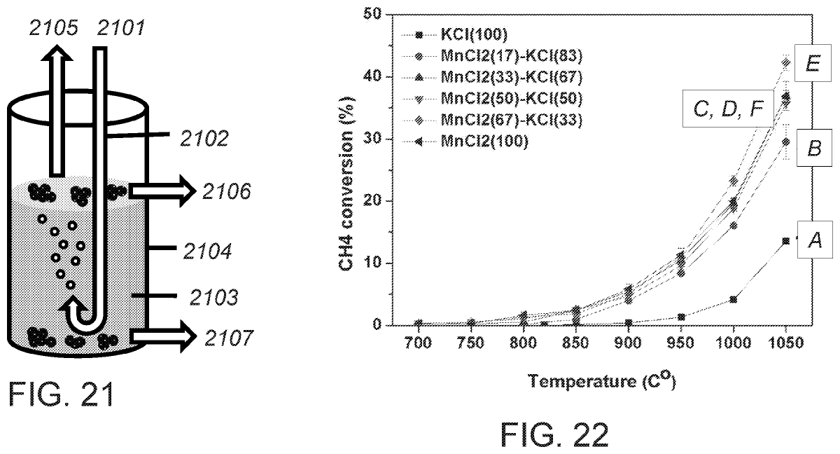

In this example an active molten salt catalyst, was used with the thermal decomposition of methane in a reactor configuration according to simplified illustration shown in FIG. 21. Some embodiments may also include more reaction zones, post-reaction separation units, or gas preheating units.

In this specific example, a feed stream 2101 of a mixture of methane (10 sccm) and argon (10 sccm) at 1 bar of pressure was bubbled through a quartz inlet tube 2102 (3 mm OD, 2 mm ID) into molten salts 2103 including manganese chloride and potassium chloride mixtures housed in a quartz reactor 2104 (having a 25 mm OD, and a 22 mm ID). 50 cm³ of molten salts in total were loaded in the reactor. Bubble rise velocities were estimated to be 20 cm/s, resulting in a gas residence time of about 0.6 seconds. Gaseous products, mostly hydrogen and unreacted methane, were collected from the top of the column 2105. Solid carbon formed from thermal decomposition of methane floated to the surface 2106 or sank to the bottom 2107 of the molten salts based on its relative density, and the carbon was then removed.

The fractional conversion of methane in the reactor effluent (e.g., effluent 2105 as shown in FIG. 21) versus temperature is shown in FIG. 22. Methane conversion of potassium chloride (A) begins around 850° C. and increases exponentially with temperature, with 4% conversion at 1000° C. and 15% conversion at 1050° C. As the amount of manganese chloride in potassium chloride increases, the methane conversion of the mixture salt increases and maximizes at 67 molar percent manganese chloride (E) and decreases at pure manganese chloride (F). At 67 molar percent manganese chloride, methane conversion begins around 750° C. and increases exponentially with temperature, with 23% conversion at 1000° C. and 40% conversion at 1050° C. Solid carbon was made at steady-state and collected from the bottom (0, 17, and 33 molar percent manganese chloride) or the surface (50, 67, and 100 molar percent manganese chloride) of the melt after cooling down.

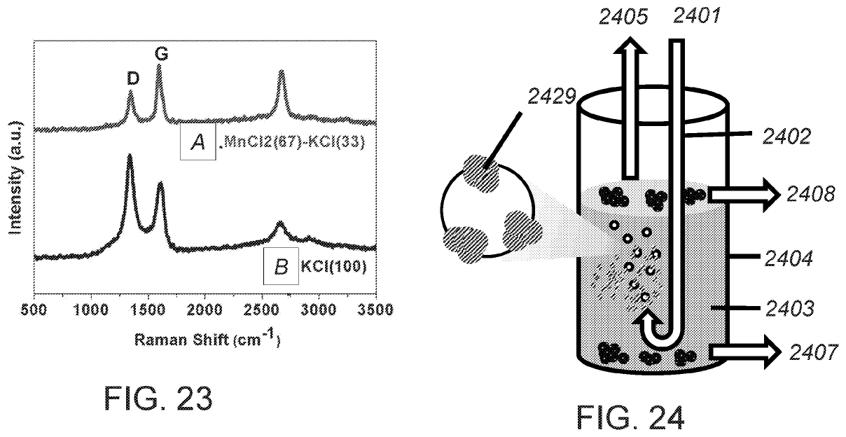

The Raman spectra of water-washed carbon is shown in FIG. 23. As shown in FIG. 23, the carbon collected from 67 molar percent manganese chloride shows the low intensity ratio of D to G band (A), showing the high crystallinity of the carbon. On the other hand, the carbon collected from pure potassium chloride shows the high intensity ratio of D to G band with the low crystallinity of the carbon (B).

This Example demonstrates the successful conversion of methane in a catalytic molten salt bubble column reactor. The addition of manganese chloride into potassium chloride increases the methane conversion, which supports the presence of active species for methane pyrolysis in the salt mixture. The solid formed from the decomposition of methane at high temperatures inherently floats to the surface or sinks to the bottom of the melt, preventing catalytic deactivation or plugging of the reactor. Current heterogenous catalytic reactor designs are unable to avoid deactivation and reactor plugging from the solid carbon formed during methane pyrolysis without burning it.

### Example 6

In another example, methane was thermally decomposed in a reactor configuration according to simplified illustration shown in FIG. 24. Some embodiments may also include more reaction zones, post-reaction separation units, or gas preheating units.

In this specific example, a feed gas mixture 2401 of methane (10 sccm) and argon (10 sccm) at 1 bar of pressure was bubbled through a quartz inlet tube 2402 (having a 3 mm OD, and a 2 mm ID) into a molten salt 2403 of molten potassium chloride or magnesium chloride while fluidizing magnesium oxide particles 2429 inside the molten salt 2403 housed in a quartz reactor 2404 (having a 25 mm OD, and a 22 mm ID). 50 cm³ of molten salts in total were loaded in the reactor. Bubble rise velocities were estimated to be 25 cm/s, resulting in a gas residence time of about 0.5 seconds. The initial weight fraction of magnesium oxide in potassium chloride was about 12.5 percent. The exact weigh fraction of magnesium oxide in magnesium chloride could not be measured, since the magnesium oxide was in-situ generated from magnesium chloride. Gaseous products, mostly hydrogen and unreacted methane, were collected from the top of the column 2405. Solid carbon formed from thermal decomposition of methane sank to the bottom 2407 of the molten potassium chloride or floated to the surface 2408 of the magnesium chloride.

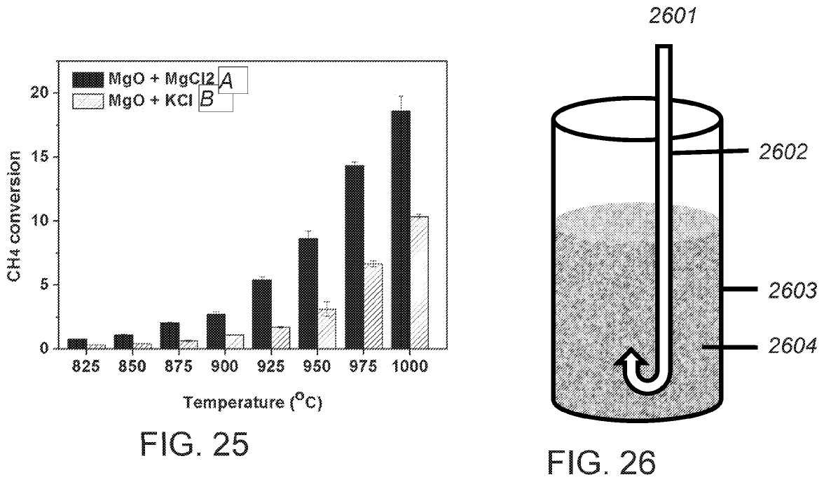

The fractional conversion of methane in the reactor effluent 2405 versus temperature is shown in FIG. 25, As shown in FIG. 25, methane conversion in potassium chloride mixed with magnesium oxide (A) begins around 825° C. and increases exponentially with temperature, with 10% conversion at 1000° C. Compared with the methane conversion of potassium chloride without magnesium oxide, 4% conversion at 1000° C. (see FIG. 22(A)), the addition of magnesium oxide increases the methane conversion, suggesting the catalytic activity of the fluidized magnesium oxide particles inside the melt. Methane conversion of the magnesium chloride-magnesium oxide slurry was 18% at 1000° C. (B) possibly due to the large amount of magnesium oxide particles or their well-fluidization. Solid carbon was made at steady-state and collected from the bottom (potassium chloride) or the surface (magnesium chloride) of the melt after cooling down.

This Example demonstrates the successful conversion of methane in a molten salt-particle slurry reactor. The addition of magnesium oxide particles into a molten salt increases methane conversion, suggesting their catalytic activity for methane pyrolysis in a molten salt bubble column reactor. The solid formed from the decomposition of methane at high temperatures inherently sinks to the bottom of the melt (potassium chloride) or floats to the surface (magnesium chloride), preventing catalytic deactivation or plugging of the reactor. Current heterogenous catalytic reactor designs are unable to avoid deactivation and reactor plugging from the solid carbon formed during methane pyrolysis without burning it.

### Example 7

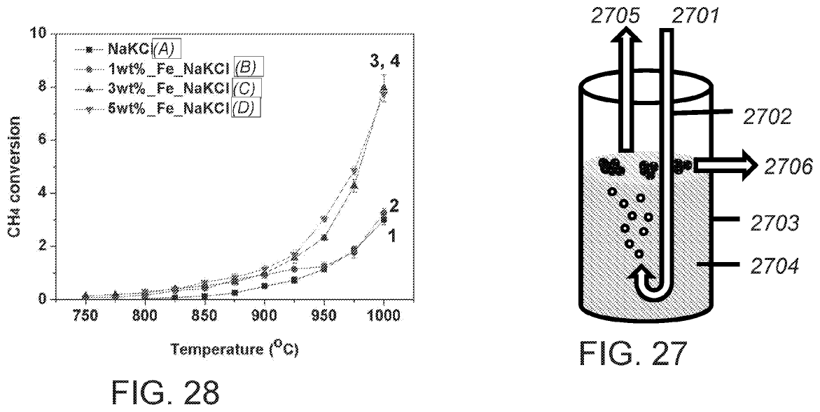

In another example, an iron nano/micron particles-embedded molten potassium-sodium chloride mixture was prepared by reducing iron chloride with very diluted hydrogen, as shown in FIG. 26. Then, methane was thermally decomposed in a reactor configuration according to simplified illustration shown in FIG. 27. Some embodiments may also include more reaction zones, post-reaction separation units, or gas preheating units.

In the specific example of FIG. 26, the solid salt mixture of potassium-sodium chloride and iron chloride was dried under an inlet stream 2601 of very diluted hydrogen (1 sccm) in argon (20 sccm) at 1 bar of pressure from room temperature to the melting point of the salt mixture with a ramping rate of 0.25° C./min. After melting the salt mixture, a mixture of very diluted hydrogen (1 sccm) in argon (20 sccm) was bubbled through a quartz inlet tube 2602 (having a 3 mm OD, and a 2 mm ID) into the molten salt 2603 housed in a quartz reactor (having a 25 mm OD, and a 22 min ID) to reduce the iron chloride and synthesize iron nano/micron particles in the melt 2604. After fully reducing the iron chloride 4, 50 cm³ of iron nano/micron particles-embedded molten salts in total were loaded in the reactor.

As shown in FIG. 27, a feed stream 2701 having a gas mixture of methane (10 sccm) and argon (10 seem) at 1 bar of pressure was bubbled through a quartz inlet tube 2702 (having a 3 mm OD, and a 2 mm ID) into the iron nano/micron particles-embedded molten salts 2704 housed in a quartz reactor 2703 (having a 25 mm OD, and a 22 mm ID) , and 50 cm³ of a slurry mixture in total were loaded in the reactor. Bubble rise velocities were estimated to be 25 cm/s, resulting in a gas residence time of about 0.5 seconds. Gaseous products, mostly hydrogen and unreacted methane, were collected from the top 2705 of the column. Solid carbon formed from thermal decomposition of methane floated to the surface 2706 of the molten salts 2704.

The fractional conversion of methane in the reactor effluent 2705 versus temperature is shown in FIG. 28. As shown in FIG. 28, methane conversion of potassium-sodium chloride (A) begins around 850° C. and increases exponentially with temperature, with 3.5% conversion at 1000° C. As the amount of iron particles increases, the methane conversion of the slurry increases and shows a plateau above 3 wt % (C). At 3 wt % of iron particles, methane conversion begins around 750° C. and increases exponentially with temperature, with 7.5% conversion at 1000° C., Solid carbon was made at steady-state and collected from the surface of the slurry after cooling down.

This Example demonstrates the successful conversion of methane in iron nano/micron particles-embedded molten salt bubble column. The addition of iron particles into a molten salt increases methane conversion, suggesting their catalytic activity for methane pyrolysis in a molten salt bubble column reactor. The solid formed from the decomposition of methane at high temperatures inherently floats to the surface, preventing catalytic deactivation or plugging of the reactor. Current heterogenous catalytic reactor designs are unable to avoid deactivation and reactor plugging from the solid carbon formed during methane pyrolysis without burning it.

### Example 8

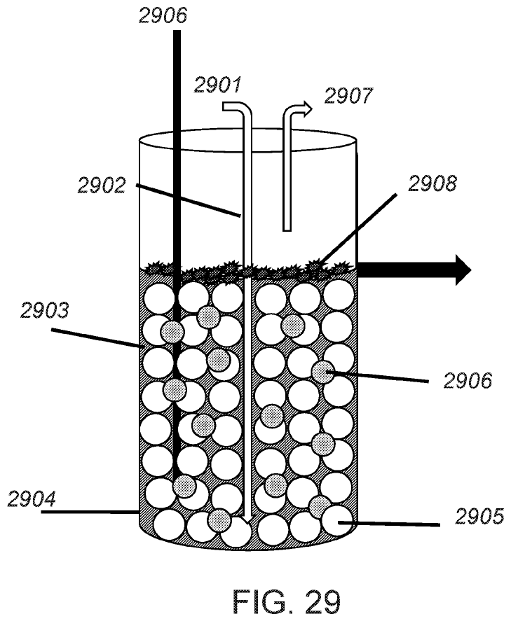

In another example, methane is thermally decomposed in a reactor configuration according to simplified illustration shown in FIG. 29. Some embodiments may also include more reaction zones, post-reaction separation units, or gas preheating units.

In this specific example, a feed stream 2901 of methane (20 sccm) at 1 bar of pressure was bubbled through a quartz inlet tube 2902 (having a 3 mm OD, and a 2 mm ID) into a molten metal alloy 2903 of pure KBr housed in a quartz reactor 2904 (having a 25 mm OD, and a 22 mm ID). 20 g of porous alumina beads 2905 with a surface area of 400 m²g⁻¹ was added to 14 cm³ of molten KBr and the combination was loaded in the reactor 2906. Temperatures were measured in-situ by a type K thermocouple. Bubble rise velocities were estimated to be 20 cm/s, resulting in a gas residence time of about 0.5 seconds. Gaseous products such as hydrogen. C₂ hydrocarbons (e.g. ethane, ethene, and acetylene), aromatics (e.g. benzene), and unreacted methane were collected from the top 2907 of the column. Solid carbon formed from thermal decomposition of methane floated to the surface 2908 of the molten metal by virtue of its lower density where it was removed.

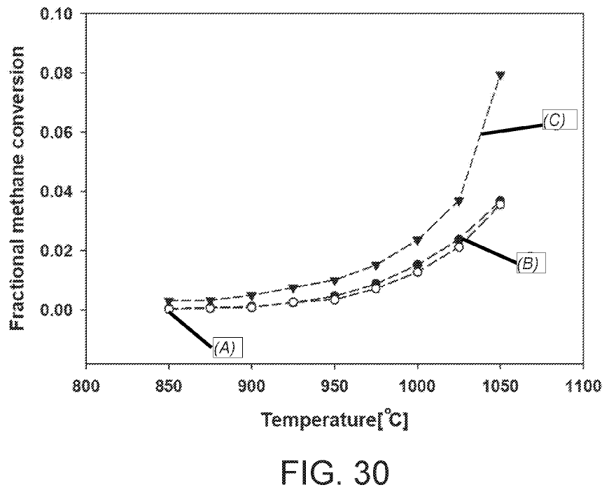

The fractional conversion of methane in the reactor effluent 2907 versus temperature is shown in FIG. 30. As shown, the following legend applies: (A) Methane conversion in pure KBr, (B) Methane conversion in α-alumina KBr three-phase reactor, (3) Methane conversion in γ-alumina KBr three-phase reactor.

As shown in FIG. 30, methane conversion (A) and (B) begins around 850° C. and increases with temperature, with 1.3% conversion at 1000° C. and 3.7% conversion at 1050° C. Methane conversion (C) begins around 850° C. and increases exponentially with temperature, with 2.4% conversion at 1000° C. and 8.0% conversion at 1050° C. The comparison of methane conversion in (A) and (B) with (C) shows γ-alumina beads improves methane conversion by a factor of almost 2 as compared to a pure salt one-phase reactor and α-alumina fixed-bed three-phase reactors.

This Example demonstrates the successful conversion of methane in a catalytic three-phase molten salt packed-bed reactor. The solid carbon formed from the decomposition of methane at high temperatures inherently floats to the surface of the γ-alumina KBr reactor, preventing catalytic deactivation or plugging of the reactor.

### Example 9

### Catalyst Dispersion and Carbon Separation in Molten Salt Reactor for Methane Pyrolysis Using Different Salt Densities

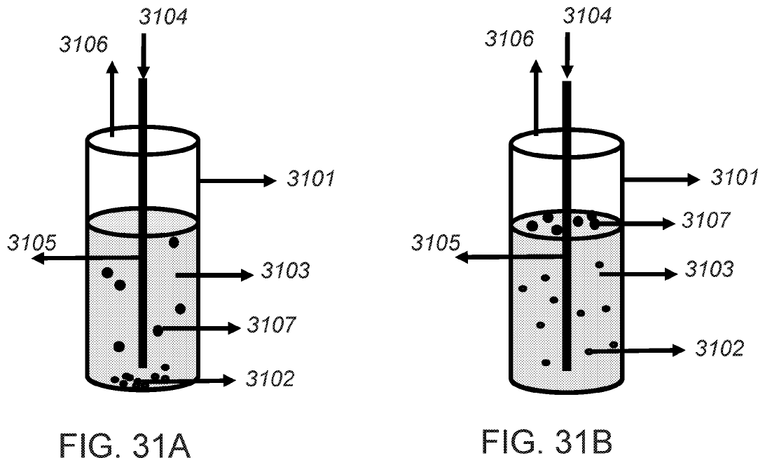

Reference is made to FIG. 31, where two quartz reactors 3101 were prepared that both contain dispersed catalysts 3102 in molten salt 3103. The catalysts were the same in both reactors and have the same size of 10/20 μm. A first reactor, a, was filled with a molten eutectic mixture of NaCl/KCl, while the second reactor in FIG. 31B was filled with a molten eutectic mixture of the more dense, LiBr/KBr. Both reactors were fed with 20 sccm methane 4 from an inlet tube 3105 and were held at a temperature of 1000° C. Gas products exited the rector from the top 3106. As shown in Table 2, these salt mixtures have different densities. The molten chloride salt is less dense than the molten bromide salt, which makes fluidization of the catalysts harder. The higher density of the molten bromide salt aids in the catalyst dispersion, resulting in full fluidization of the active particles. Furthermore, the chloride salt has a density comparable to that of the carbon 3107 formed from methane pyrolysis. When carbon is produced it tends to disperse in the molten salt instead of separating, while in the molten bromide salt, which is considerably denser than the carbon produced, the carbon float at the surface of the melt, aiding in separating the carbon from the reaction system.

TABLE 2

| Density at | | | |
|---|---|---|---|
| melting point | | | |
| (g/cm³) | X = Cl | X = Br | X = I |
| M = Na | 1.556 | 2.342 | 2.742 |
| M = Li | 1.502 | 2.528 | 3.109 |
| M = Ca | 2.085 | 3.111 | 3.443 |
| M = K | 1.527 | 2.127 | 2.448 |

### Example 10

### Decoking of Active Catalysis Using Molten Salt as a Solvent

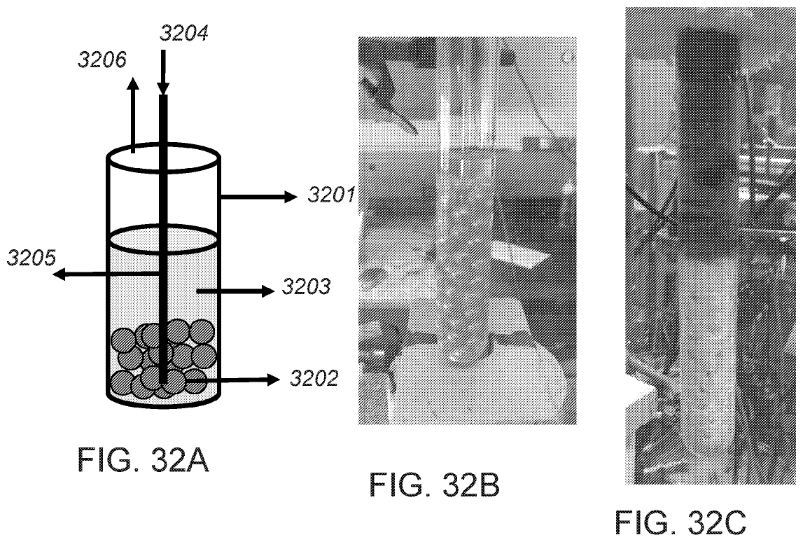

Reference is made to FIG. 32, which shows schematically (FIG. 32A) a quartz reactor 3201 filled with spherical Ni solid catalysts 3202 immersed in a molten eutectic mixture 3203 of LiBr/KBr 3 (as shown in FIG. 32B). A feed 3204 of methane 4 was flowed through an inlet tube 3205 to the bottom of the reactor. The reactor was at 1000° C. and the flow of the feed was at 20 sccm methane. Gas products exited the rector from the top 3206. The Ni balls acted as a catalyst for the methane conversion to carbon, The molten bromide salt decreased the coking of the metal surface considerably due to surface tension, allowing methane pyrolysis to operate with high conversion for an extended period. FIG. 32C shows a photograph of the cooled reactor after running for several hours. The carbon was separated to the top of the reactor, above the salt surface. The Ni surface shows minimal coking on the surface.

### Example 11

### Decoking of Active Catalysis Using Molten Salt as a Solvent

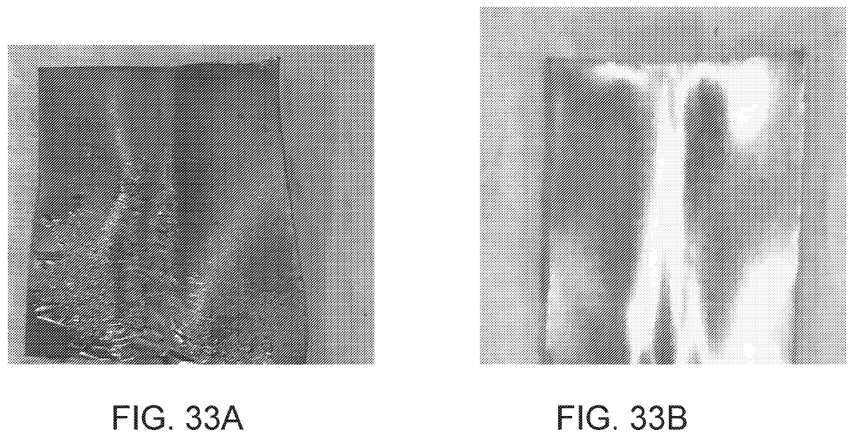

Demonstrating the ability of the molten eutectic mixture of LiBr—KBr to clean coked metal samples. Reference is made to FIG. 33A which shows a Ni metal thin foil coked in a closed vessel at high temperature with methane. The coked foil was then immersed in a LiBr—KBr molten mixtures in a closed vessel, with Ar bubbling next to the coked metal piece. After 20 minutes of Ar bubbling through the vessel, the Ni foil was decoked as shown in FIG. 33B, and the carbon was washed off to the molten salt top layer, where it was floating due to its lower density respect to the molten salt.

### Example 12

### In-Situ Production and Dispersion of Metal Catalyst in Molten Salt

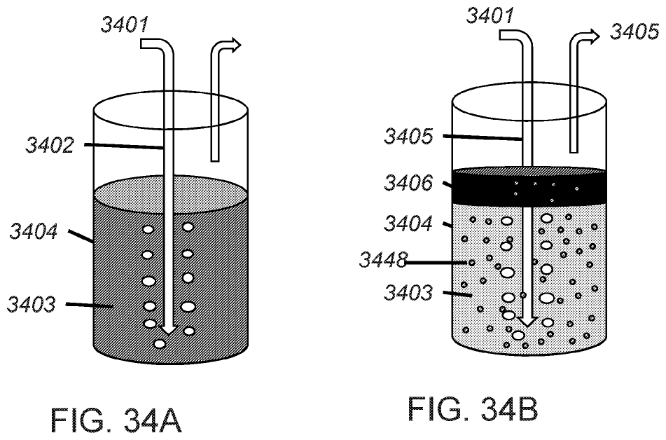

In this example, transition metal solids are produced from a molten salt in a reactor configuration according to simplified illustration FIG. 34A. Some embodiments may introduce solids suspended in the molten salt media as a different form of catalyst precursor. In this example, methane is thermally decomposed in the reactor after the in-situ production of transition metal solids according to the simplified illustration. Some embodiments may also include more reaction zones, post-reaction separation units, or gas preheating units. in this specific example, a. feed stream 3401 of hydrogen (3 sccm) and argon (17 sccm) at 1 bar are bubbled introduced a quartz inlet tube 3402 (having a 3 mm OD, and a 2 mm ID) into an alkali-halide molten salt 3403 (e.g., LiCl, NaCl, KCl, LiBr, NaBr, or KBr) or a mixture of alkali-halide molten salts. Transition metal catalyst precursors are dispersed in the molten salt either homogeneously such as transition metal halide (e.g. CoCl₂, FeCl₂, FeCl₃, NiCl₂, CoBr₂, FeBr₂, FeBr₃, or NiBr₂) dissolved in molten salt, or heterogeneously such as transition metal oxide solid particles (e.g. CoO, Co304, FeO, Fe-2O₃, Fe₃O₄, NiO) suspended in the molten salt. The molten salt is housed in a quartz reactor 3404 (having a 9.5 mm OD, and a 8.8 mm ID) at 750° C. The catalyst precursors is reduced by the hydrogen. Transition metal solids are produced and dispersed in the molten salt as the reaction media for methane decomposition reaction illustrated in FIG. 34B.

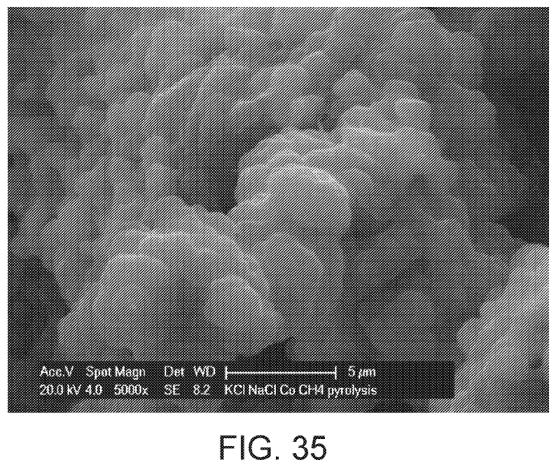

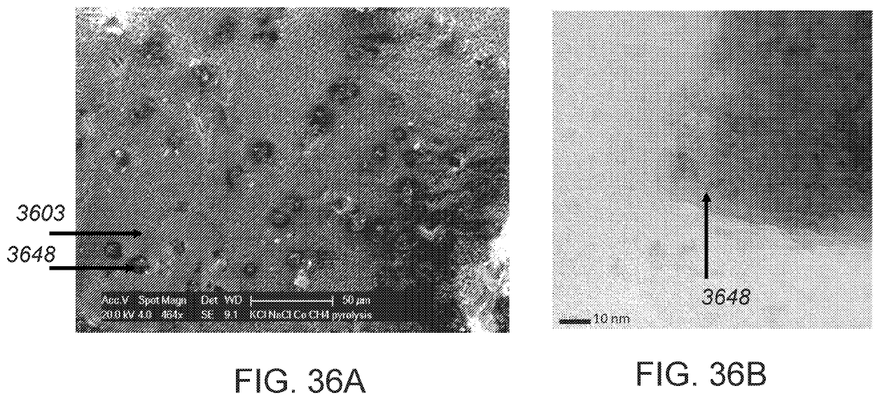

In the specific example shown in FIG. 34B, cobalt nanoparticles 3448 were dispersed in a molten salt mixture 3403 of NaCl and KCl housed in a quartz reactor 3404 (having a 9.5min OD, and a 8.8 mm ID). A feed 3401 of methane at 1 bar was bubbled through a quartz inlet tube 3405 (having a 3 mm OD, and a 2 mm ID) into the molten salt at 1000° C. Bubble rise velocities were estimated to be 19cm/s, result in a gas residence time of 0.78 seconds. The hydrogen product and unreacted methane were collected from the top 3405a of the column and analyzed using a mass spectrometer. In this specific example, a stable methane to hydrogen conversion of 15% during a 5-hour reaction period was observed with no sign of catalyst deactivation. Solid carbon formed from thermal decomposition of methane accumulated at the melt surface 3406. The scanning electron micrograph of the solid carbon 3406 collected from the top of the reactor column is shown in FIG. 35. Round carbon plates of micron and sub-micron level agglomerate into solid carbon particles collected in the reactor. The scanning electron microscopy of the cooled molten salt after 5 hours of methane decomposition reaction is shown in FIG. 36A. Cobalt metal particles 3448 of 5-10 μm diameter were evenly dispersed in the cooled molten salt 3403. The transmission electron microscopy of a cobalt metal particle are shown in FIG. 36B. The cobalt metal particles consist of monodispersed cobalt nanoparticles 3448.

This Example demonstrates the successful in-situ production of metal catalyst in molten salt. The solid suspension of solid metal catalyst and molten salt successfully converted methane to hydrogen and solid carbon in a bubble column reactor. Solid carbon is collected at the surface of the molten salt, and separated from the bulk of the molten salt and the surface of the solid catalyst. Other embodiments may optimize the molten salt composition, solid catalyst precursor choice and other reaction conditions to allow for higher reaction rate and longer catalyst lifetime.

### Example 13

### Controlling the Separation Between Carbon and the Molten Salt Using the Lift Force of the Bubble Column

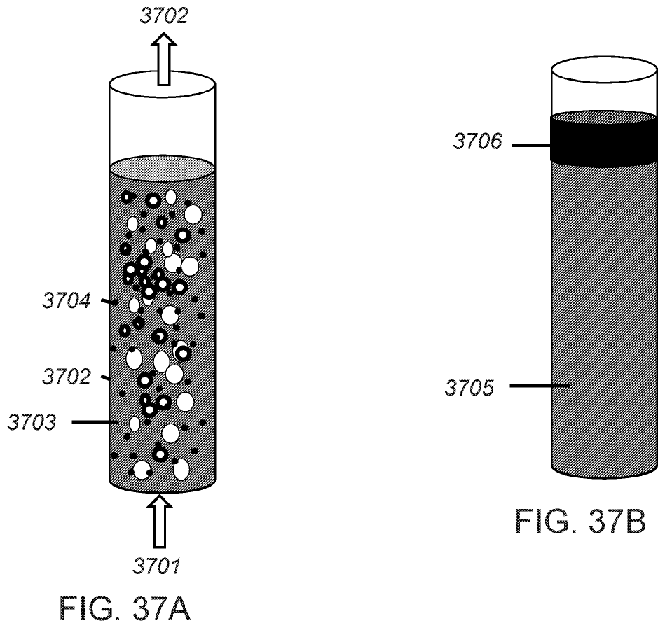

In this example, methane is thermally decomposed in the reactor according to simplified illustration FIGS. 37A and 37B. Some embodiments may also include more reaction zones, post-reaction separation units, or gas preheating units.

In one reactor configuration as shown in FIG. 37A, a feed 3701 of methane (15 sccm) at 1 bar is introduced to the bottom of a quartz reactor 3702 (having a 25 mm OD, and a 22 mm ID), which houses a molten salt 3703 comprising magnesium chloride and potassium chloride. Solid carbon 3704 was produced from the thermal decomposition of methane and mixed with the molten halide salt to form a shiny due to the lift force of the bubble column. In another reactor configuration as shown in FIG. 37B, a molten salt 3705 comprising the same composition of magnesium chloride and potassium chloride with molten salt 3703 is quiescent after a period of reaction time with methane stream. The carbon 3706 produced by the thermal decomposition of methane aggregated on the surface of the melt, and was separated from the molten salt. The degree of separation can be controlled by the lift force of the bubble column, allowing carbon to be either collected as a value-adding product, or transferred and utilized within the molten salt as a liquid fuel.

Accordingly, FIG. 37A illustrates an exemplary process whereby the lift force of the hydrocarbon gas stream in a bubble column reactor with a molten salt mixed the carbon with the molten salt. FIG. 37B then illustrates an exemplary process whereby a quiescent reactor consists of a molten salt and solid carbon product from the thermal decomposition of hydrocarbons. The carbon floats on top of the molten salt, allows for easy solid-liquid separation.

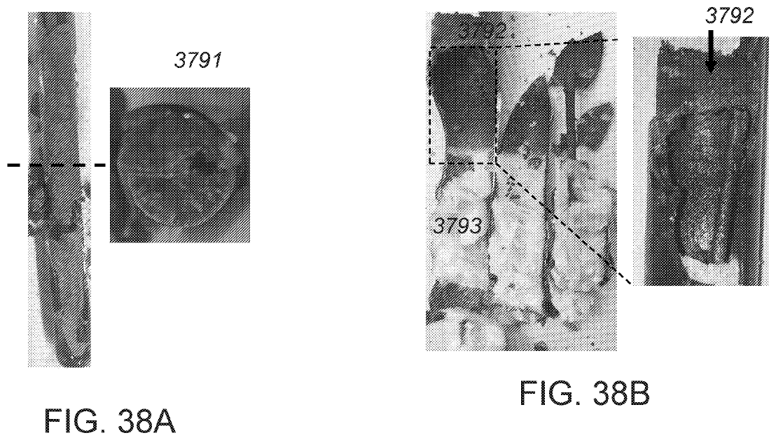

A bubble column reactor with molten potassium chloride and magnesium chloride was immediately quenched to room temperature after methane decomposition reaction. A photograph of the resulting products shown in FIGS. 38A and 38B. The quenching process retains the microstructure of the molten salt while a lift force from the methane stream is present. The cross-section 3791 in FIG. 38A shows that the quenched salt is homogeneously mixed with the carbon produced from the thermal decomposition of methane. This phenomena indicates that the molten salt and carbon formed a slurry at high temperature with bubble lift force. In another bubble column reactor as shown in FIG. 38B, the molten salt was held above its melting point without gas bubbles passing through the liquid for a sufficient amount of time after the methane decomposition reaction to allow the formation of a quiescent liquid. The cooled reactor column shows a distinctive separation between the carbon 3792 and the salt 3793. For the photographs shown in FIG. 38, a bubble column reactor as shown in FIG. 38A consisting of molten potassium chloride and magnesium chloride immediately quenched to room temperature after methane decomposition reaction, and a bubble column reactor as shown in FIG. 38B consist of molten potassium chloride and magnesium chloride cooled to room temperature after a sufficient amount of time at a temperature higher than the melting point of the molten salt, in absence of any gas flow through the liquid after the methane decomposition reaction.

This example demonstrates the feasibility of controlling the degree of separation between carbon and the molten salt in a bubble column reactor for hydrocarbon decomposition. A slurry where carbon is mixed with the molten salt is formed due to the lift force of the gas stream. Such slurry is easy to transfer and can be utilized at high temperature by itself. When a reactor consist of molten salt and carbon is quiescent, or does not have enough lift force, the carbon floats on top of the molten salt, allows for easy solid-liquid separation. Other embodiments may optimize the molten salt composition, reactor design, reaction condition and gas composition to tailor the solid-liquid separation according to the need of difference applications.

### Example 14

### Methane Decomposition in a Bubble Column with Solid Metal Oxide Particles Dispersed in Molten Salt

In this example, methane is thermally decomposed in the reactor having molten salt and solid oxide particles according to simplified illustration FIG. 37A. The metal oxide either performs as a catalyst itself or as a support for other transition metal catalysts (e.g., Ni, Co, Fe, etc.). The metal oxide particles form a stable slurry in the molten salt. Some embodiments may also include more reaction zones, post-reaction separation units, or gas preheating units.

In this specific example referring to the configuration as shown in FIG. 37A, 10 wt % metal oxide including CeO₂ in a first test and TiO₂ in a second test was dispersed in a molten salt mixture 3703 of 45 wt % NaCl and 55 wt % KCl housed in a quartz reactor 3702 (having a 9.5 mm OD, and a 8.8 mm ID). A feed 3701 of methane (8 sccm) and argon (2 sccm) at 1 bar was bubbled through a quartz inlet tube (having a 3 mm OD, and a 2 mm ID) into the molten salt at 1000° C. Bubble rise velocities were estimated to be 19 cm/s, result in a gas residence time of 0.55 seconds. The hydrogen product and unreacted methane were collected from the top of the column 3702 and analyzed using a mass spectrometer. The salt appeared to have a uniform yellow color attributed to the oxygen vacancies on the CeO₂ surface, and is a direct evidence of stable slurry formation.

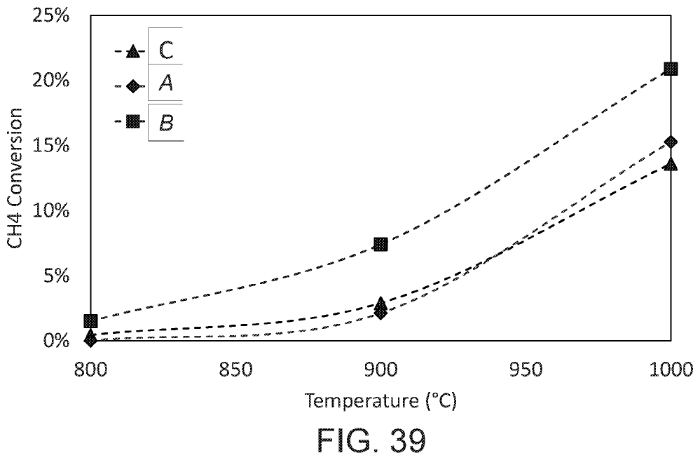

The methane conversion versus temperature is shown in FIG. 39 for two metal oxides: (A) TiO₂, (B) CeO₂ dispersed in molten NaCl—KCl salt. Compared with methane conversion in a molten salt without metal oxide dispersion (C), it is clear that when a catalytically active metal oxide (e.g., CeO₂) is dispersed in the molten salt, the methane decomposition reaction rate and methane conversion increases. In this embodiment, the metal oxide particles serve as catalysts for the methane decomposition reaction. When a catalytically inert metal oxide (i.e. TiO₂) is dispersed in the molten salt, the methane decomposition reaction kinetics is similar to that in a molten salt mixture without the metal oxide particles.

### Example 15

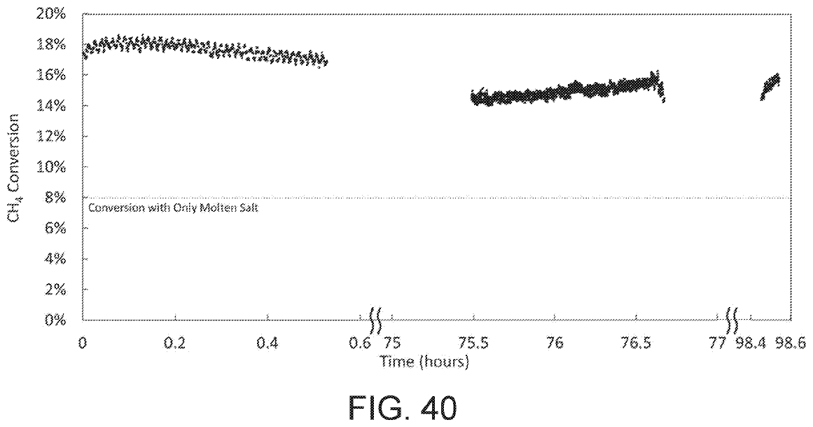

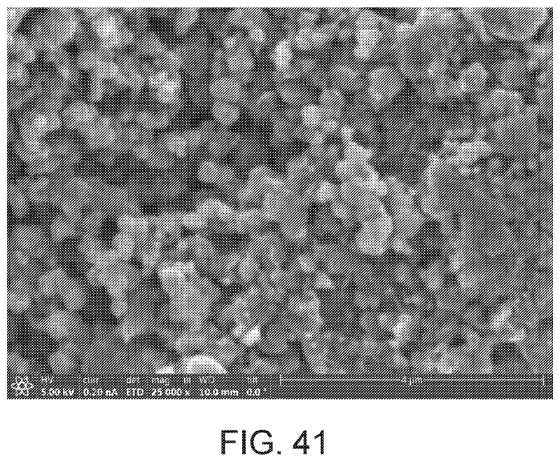

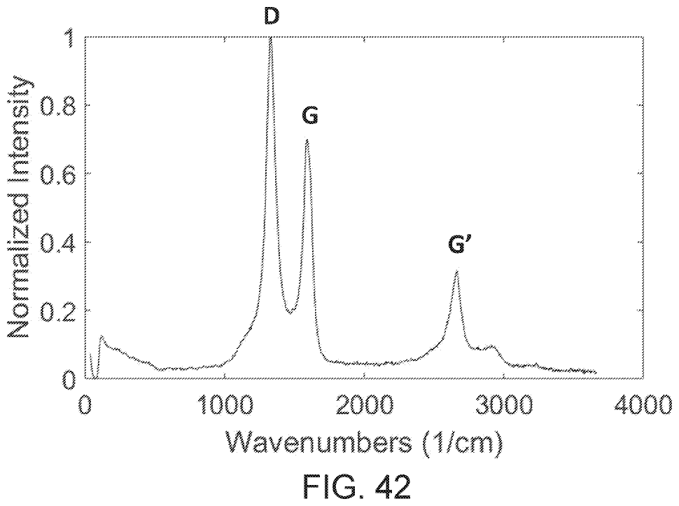

In another example showing how metal oxides act as catalysts in molten salts, 1.25 g of Al₂O₃/SiO₂ particles (<38 μm in size) with a 65% loading of Ni was dispersed in a molten salt mixture (25 g) comprised of NaBr (49 mol %) and KBr (51 mol %). Methane (14 SCCM) was bubbled through the slurry at 1050° C. and 1 bar. The methane conversion during a 99-hour continuous methane decomposition reaction is shown in FIG. 40. The methane conversion was stable within the 99 hours period, and significantly higher than the methane conversion (8%) in a same bubble column without the metal oxide addition. The carbon produced during the methane decomposition reaction was collected from the top of the melt. The scanning electron microscope image of the carbon product is shown in FIG. 41. The carbon consists of nano-plates from 100-300 nm diameter. Larger plates assembled from these carbon nano-plates are observed as well. The Raman spectroscopy of the carbon product (as shown in FIG. 42) shows a D/G ratio of 1.26 and a G′ emission characteristic representative of a mixture of disordered and graphitic carbon, or carbon with sub-micron level small graphitic units as observed in FIG. 41. In this specific embodiment, the metal oxide (Al₂O₃ and Sift) particles act as a support for a transition metal (Ni) catalyst for methane decomposition reaction. A stable dispersion was formed when the supported metal oxide was dispersed in a molten salt. The supported metal oxide was catalytically active in the molten salt. The molten salt media facilitates the removal of solid carbon from the oxide surface, allows easy separation and collection of the carbon product on the surface of the molten liquid, as well as preventing catalyst deactivation by removing the solid carbon from the surface active sites of the catalysts

This example demonstrates the successful conversion of methane in a bubble column reactor consist of molten salt and solid oxide particles dispersed in the molten salt. The solid oxide particles can act as catalyst for methane decomposition, or as support for metallic catalyst for methane decomposition. The molten salt helps to remove solid carbon product from the solid oxide surface, preventing the catalytically active solid oxides from deactivation. The separation between carbon and the molten salt can be controlled by varying the density of the molten salt and the lift force of the bubble column, allowing easy separation and collection of the solid carbon. Other embodiments may optimize the molten salt composition, solid oxide composition, reactor design, and reaction conditions to enhance the performance of reactor.

### Example 16

### Methane Decomposition on Lewis Acidic Metal Halide Salt

In this example, methane was thermally decomposed in the reactor consist of a catalytic molten salt according to the simplified configuration illustrated in FIG. 2. Some embodiments may also include more reaction zones, post-reaction separation units, or gas preheating units.

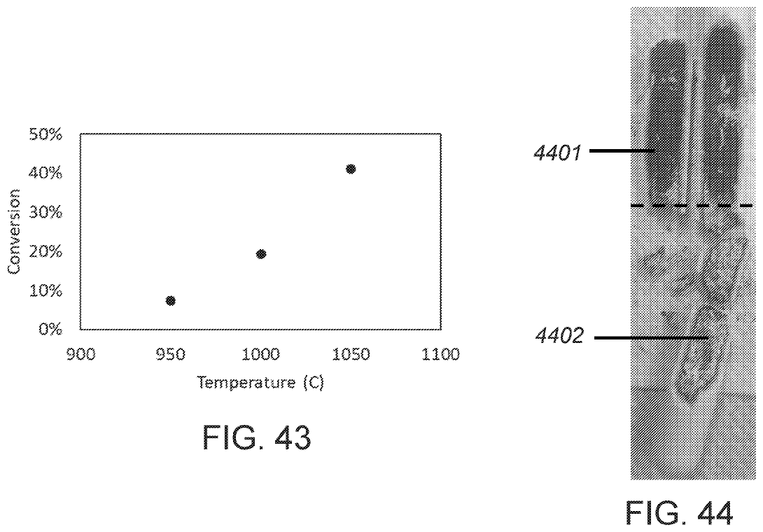

In this specific example, 5 mL of molten salt mixture 203 of KF (87 mol %) and MgF₂ (13 mol %) was housed in an alumina reactor 204. A feed 1 of Methane (16 SCCM) at 1 bar was bubbled through an alumina inlet tube 202 (having a 3 mm OD, and a 2 mm ID) into the molten salt mixture 203 at a temperature of from 950° C. to 1050° C. The hydrogen product and unreacted methane were collected from the top 205 of the column and analyzed using a mass spectrometer. The strong ionic bonding between F⁻ and Mg²⁺ contributes to the high Lewis acidity of Mg²⁺, resulting in a high catalytic activity for methane decomposition. FIG. 43 shows the methane conversion as a function of temperature. High conversion (˜40%) is observed in a relatively short bubble column and short residence time at 1050° C. FIG. 44 shows a photograph of the inside of the reactor after it was slowly cooled slowly to room temperature after methane decomposition reaction from 950° C. to 1050° C. Carbon (A) was found on the top of the molten salt and was largely separated with the salt (B). The cooled reactor column shows a distinctive separation between the carbon (A) and the salt (B).

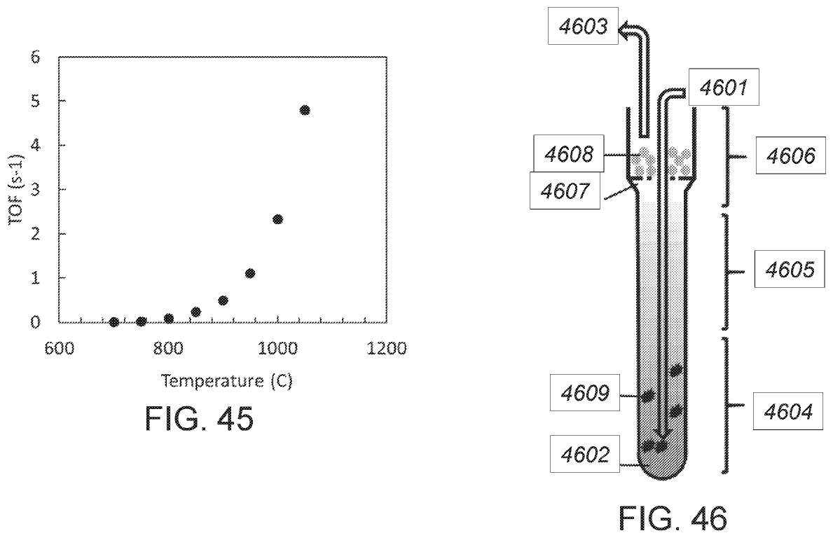

In another embodiment, the specific active Lewis acidic site of MgF₂ in solid phase is shown to catalytically convert methane into carbon and hydrogen as well. Solid MgF₂ powder was loaded into a 1 cm diameter packed bed reactor with 5 cm in length. Methane (10 SCCM) was flown through the packed bed at 1 bar, and the temperature of the bed was increased from 300 to 1000° C. The methane was first observed to convert at 600° C. and had nearly 50% conversion to carbon and hydrogen at 1000° C. FIG. 45 shows the turn over frequency (TOF) of methane on the solid MgF₂ surface as a function of temperature. High TOF is observed for methane decomposition without deactivation.

Apparent kinetic parameters were measured in bubble column reactors consisting of other molten halide salts with Lewis acidic cations, hereby referred as Lewis acidic salts (e.g., MgCl₂, ZnCl₂, YCl₃, and LaCl₃) and shown in TABLE 3. The methane decomposition reaction in a bubble column reaction consist of molten Lewis acidic salts have a lower apparent activation energy compared with either inert, molten salt (such as KCl) or gas phase methane decomposition reaction. This result demonstrates the correlation between the Lewis acidity of the cation in strong electrolytes and the catalytic activity of methane decomposition on the surface of these Lewis acidic salts.

TABLE 3
Apparent activation energy of methane decomposition reaction in
molten halide salt bubble column reactors or in solid packed bed
reactor (in the case of solid MgF₂)

| Salt Composition | Apparent Activation Energy [kJ/mole] |
|---|---|
| 87 mol % KF-13 mol % M2F₂ | 231 |
| MgCl₂ | 154 ± 3 |
| ZnCl₂ | 80 ± 28 |
| YCl₃ | 218 |
| LaCl₃ | 200 |
| KCl | 378 ± 38 |
| Gas phase (literature) | 422 |
| Solid MgF₂ | 206 |

This example demonstrates the successful conversion of methane using Lewis acidic salts as catalysts. Lewis acidic molten salts are used in bubble column reactors, and solid Lewis acidic salts are used in packed bed reactors. In all cases, the Lewis acidic salts show high catalytic activity for methane decomposition reactions. Other embodiments may optimize the molten salt composition, reactor design, and reaction conditions to enhance the performance of the methane decomposition reaction.

### Example 17

### Catalysis by Molten Salt Vapor

Methane is thermally decomposed in a reactor configuration according to simplified illustration FIG. 46. Some embodiments may also include more reaction zones, reflux zones, post-reaction separation units, or gas preheating units.

In this specific example, a feed 4601 of 5 sccm methane at 1 bar pressure was flown through a quartz inlet tube (having a 3 mm OD. and a 2 mm ID) into a 3-zone quartz reactor loaded with a molten salt 4602 having 10 g molten ZnCl₂, and the effluent gas 4603 was collected at the top of the reactor. The bottom 2 parts 4604, 4605 of the reactor were of same width (having a 12 mm OD, and a 10 mm ID) and their total length was 40 cm. In the top zone 4606 (having a 28 mm OD, and a 25 mm ID, with a 10 cm length), a porous quartz plate 4607 was placed which held some quartz beads 4608. The bottom zone with molten ZnCl₂ was held at a constant temperature 720° C., which was close to the boiling point of ZnCl_{2.} ZnCl₂ vapor entered the middle zone 4605 and catalyzed the decomposition of methane at a different temperature. In the top zone 4606 which was kept at 400° C., the salt vapor condensed as liquid and reflux back to the hot middle zone 4605. Carbon 4609 produced in this reactor either grow on the wall or sink down to the bottom.

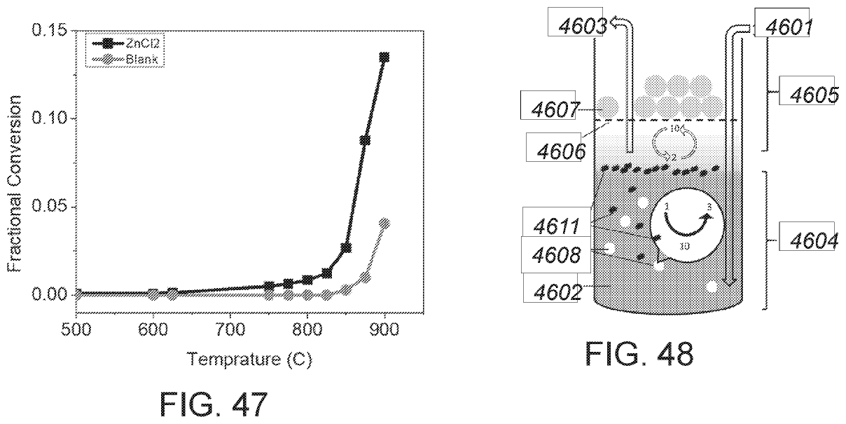

The fractional conversion of methane in a blank reactor and a reactor loaded with ZnCl₂ is shown in FIG. 47. The temperature is the middle zone temperature. It can be seen clearly methane conversion was much higher with the presence of ZnCl₂ than in the blank reactor at same temperature. In the ZnCl₂ case, methane conversion reaches 14% at 900° C., while in the blank reactor the conversion is less than 5% at the same temperature. This example demonstrates the catalytic activity of ZnCl₂ vapor.

### Example 18

Methane is thermally decomposed in a reactor configuration according to the simplified configuration illustrated in FIG. 48. Some embodiments may also include more reaction zones, reflux zones, post-reaction separation units, or gas preheating units. Different catalyst composition or concentrations may also be used.

In this specific example, a feed 4801 of 10 sccm methane at 1 bar pressure was bubbled through a quartz inlet tube (having a 3 mm OD, and a 2 mm ID) into a 2-zone 4804, 4805 quartz reactor loaded with 12 cm of a 30 mol % ZnCl₂-70 mol % KCl eutectic molten salt mixture 4802. The effluent gas 4803 was collected at the top of the reactor. Both parts of the reactor 4804, 4805 were of same width (having a 25 mm OD, and a 22. mm ID), but the 8 cm bottom zone 4804 was held at higher temperature, and the 30 cm top zone 4805 was kept at room temperature. In the top zone 4805, a porous quartz plate 4806 was placed which held some alumina beads 4807. In the bubbles 4808, methane was converted by ZnCl₂ vapor 4810 to hydrogen and solid carbon 4811. Solid carbon either floated at the surface of liquid molten salt or sink to the bottom. Above the liquid surface, ZnCl₂ vapor 4810 re-dissolve back into the eutectic liquid 4802, and the colder alumina beads 4807 prevented the un-dissolved ZnCl₂ from flowing out with effluent gas 4803 by condensing any ZnCl₂ vapor.

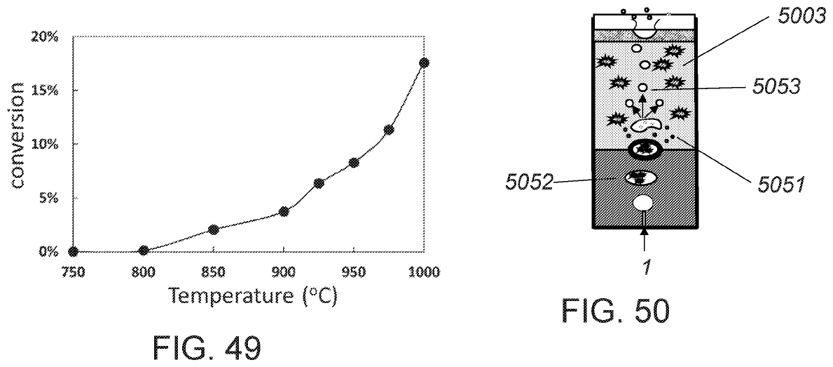

The fractional conversion of methane at a different temperature in the lower zone 41804 is shown in FIG. 49. At 1000° C., methane conversion reaches 17.6%. In this reactor configuration, carbon does not grow on the reactor wall, and the liquid reservoir allows ZnCl₂ to dissolve back into liquid. This example demonstrates that ZnCl₂—KCl eutectic can be used as an active catalyst for methane pyrolysis. The active gaseous salt vapor can fill the reactant gas bubble and serve as the catalyst.

### Example 19

### Methane Pyrolysis on Supported Molten Salt

Reference is made to FIG. 6. Natural gas is bubbled through a high-temperature molten salt with a bed of supported molten salt particles. The supported molten salt sites on the solid catalyst support greatly increase the surface area for reactions to occur. The supported molten salt species should be chosen to be immiscible with the molten salt used for the surrounding environment to ensure the supported sites stay anchored due to surface tension. The dynamic liquid surfaces can prevent C—C bond coordination. Furthermore, the surrounding molten salt environment can be chosen to have a higher carbon wettability to uptake any C atoms deposited on the supported molten salt sites; this will prevent coking and plugging of the packed bed reactor.

In a specific example, a feed of 20 sccm of methane is bubbled into a molten salt column of CsBr (cesium bromide) at 900° C. A packed bed of supported molten LiF on γ-Al₂O₃ provide a large number of catalytic sites for methane pyrolysis. LiF is immiscible in CsBr, helping to keep the liquid LiF drops adhered to the surface of the alumina support. Carbon is readily removed from the surface of the CsBr column.

### Example 20

### High-Temperature Methane Pyrolysis in Emulsions of Molten Salts and Molten Metals

Reference is made to FIG. 50. Methane 5001 is bubbled vigorously through a high-temperature molten metal 5052 in a less dense molten salt 5003 to form an emulsion of either molten metal particles in a molten salt 5051 or a molten salt particles in a molten metal. The emulsion has a much higher surface area to volume ratio than pure molten salts or molten metals would have on their own. In turn, the reactive surface area available for the methane gas is now larger, resulting in larger rates of hydrogen production. The emulsion reaction environment also provides the opportunity to have processes and reactions that are normally selective to salt or metal interfaces carried out in concert. Emulsification can be enhanced by adding an emulsifying agent to salt-metal mixture.

In a specific example, a 27 mol % Ni—Bi molten metal is emulsified with molten NaBr/KBr at 1000° C. using particles of carbon as an emulsifying agent. 20 sccm of methane is bubbled through the column and the solid carbon formed from pyrolysis readily separates at the surface where it can be readily removed.

### Example 21

### Electricity or Heat Production from Methane Partial Combustion

Reference is made to FIG. 11. A feed stream 101 of methane and oxygen are sent in a single stream or two independent gas streams to a reactor containing a reactive molten halide salt 204 in a bubble column. A rapid reaction between oxygen and the salt result in production of a halogen and simultaneous reduction in oxygen partial pressure. In some embodiments, the salt is lithium iodide, and oxygen reacts to form iodine gas and lithium oxide or lithium hydroxide. As a result, the halogen becomes an oxidant for methane and minimizes any reaction between oxygen and methane. In some embodiments, the halogen can react with methane through several intermediates including but not limited to halogen radicals and halogens dissolved in the molten salt which react at the salt-gas interface. After methane becomes activated, the resulting product car react further to form solid carbon 206 and hydrogen halides. The solid carbon floats to the surface and can be removed. In addition, hydrogen halides are produced and further react with the salt and/or oxygen to produce steam 205. The hydrogen in methane is reduced to steam and leaves the reactor.

The overall reaction is exothermic and a steam cycle 1105 is used to generate electrical power from the heat of reaction. In this schematic, that is accomplished using a tubes within the salt in which steam passes and cools the reactor. The heated steam runs through a steam turbine 1106 which runs a generator 1107 to produce electricity 1108. The reactor, steam turbine, and generator in FIG. 11 are meant to be schematic representations and by no means limits the configuration of the reactor design, heat transfer design, or any other elements of the inventive embodiment. In another preferred embodiment, a generator and steam turbine are not included, and the exothermic reaction is instead used to generate process heat.

In another preferred embodiment, reference is made to FIG. 12, where a feed 101 of methane and oxygen 1202 are fed into a molten salt 1215 at separate points. The various intermediates are explained in the figure using iodine, lithium iodide, and lithium hydroxide as exemplary intermediates. Methane and oxygen may be fed together or, as indicated in the figure, separately relying on the solubility of the halogen in the salt to provide a source of halogen vapor within the methane containing bubble in a preferred embodiment. When oxygen gas reacts with a halide salt (LiI), a halogen 1216 (I₂) is produced. The halogen either stays in a gas bubble, dissolves in the melt, or is combined with another gas stream of methane. In a second preferred embodiment, the halogen dissolves in the salt and activates the salt, thereby making the surface more reactive for methane, which is activated on the gas-melt interface. This step may also occur from a surface or melt-stabilize halogen 1217, such as I₄⁻². The halogen, or halogen dissolved in the salt, reacts with methane to form hydrogen halide (HI) and carbon 206 via radical gas-phase reactions. The produced carbon floats to the melt surface and can be removed. The hydrogen halide reacts with an oxide, oxyhalide, or hydroxide (LiOH) to form the original halide and water 1203.

### Example 22

### Methane Partial Combustion Using Chemical Looping Reactors

Reference is made to FIG. 13. The various steps outlined in Example 21 can be split into separate reactors with mixing between reactors. The salt chemical looping steps are split into a reactor with oxygen addition and hydrogen halide addition. These two reactors could also be combined into a single reactor with both steps occurring simultaneously. The reactor with methane addition may consist of the same chemical looping halide salt, or another catalytically active melt; for example a molten metal, molten salt, or other liquid catalytic media may be used. A bromide salt is used in this example of a bromine and bromide chemical looping cycle. Oxygen 1301 is contacted with a reactive bromide salt 1311 that may be dissolved in other salts; bromine and oxide or oxy-halides 1310 are produced. The bromine 1302 is then contacted with methane 1303 in a separate vessel 1304 to produce separable carbon 1305 and hydrogen bromide 1306. Hydrogen bromide is then sent to another reaction vessel 1307 and contacted with an oxide or oxyhalide to produce steam 1308 and a bromide or oxybromide. The bromide or oxybromide is then re-cycled to the first reactor 1309, completing a chemical looping cycle for both the salt and halogen. Heat transfer may occur in one or more vessels, depending on the choice of salt.

### Example 23

### Methane Partial Combustion in Molten LiI—LiOH

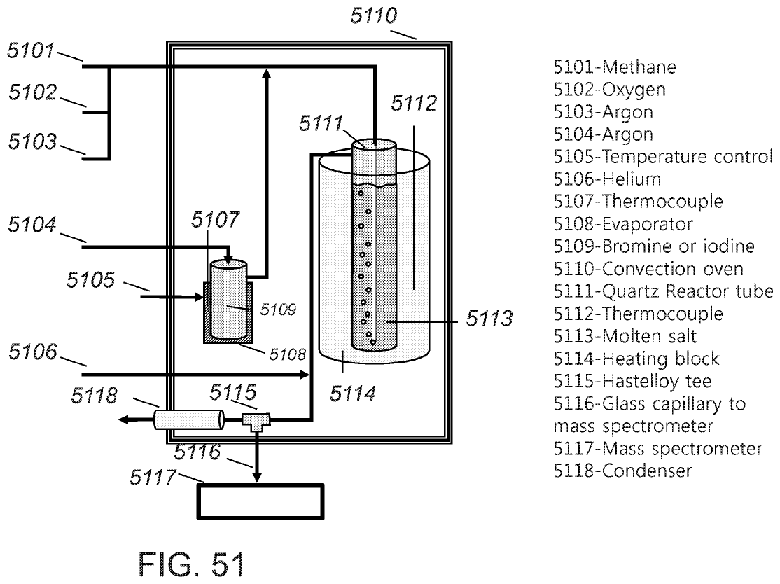

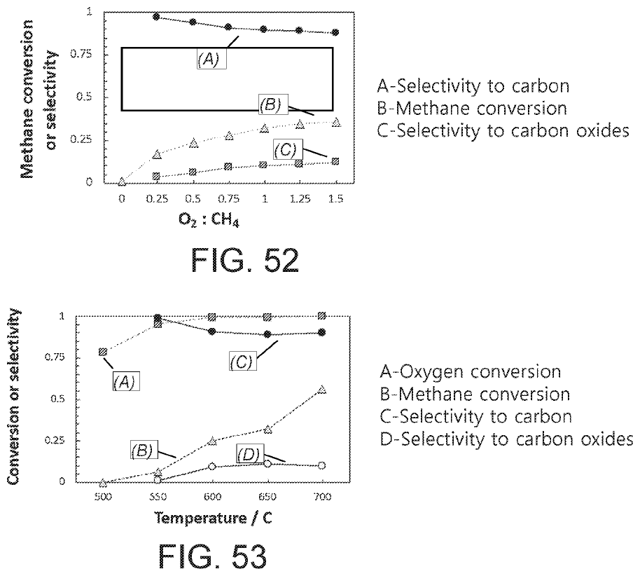

Reference is made to FIG. 52 where various oxygen:methane ratios are ted to a bubble column of LiI mixed with LiOH using the apparatus illustrated in FIG. 51, and where both methane and oxygen are fed together in a single inlet tube. The experimental system was used for reaction studies with an online mass spectrometer (Stanford Research Systems RGA 300) to analyze the reaction products. All tubing was made from glass or Hastelloy-C with graphite ferrules or ground glass joints. Heated lines delivered gases from the effluent directly to the mass spectrometer through a glass capillary tube and a complete material balance including halogens was maintained. Iodine and bromine were delivered as vapors from evaporators operating at liquid-vapor equilibrium with argon carrier gas, which was delivered using mass flow controllers (MKS 1179). The gases were combined and delivered to a tubular quartz bubble column reactor with 1.27 cm inner diameter with an external stainless steel heating block with two 350 W Omega heating cartridges. After the heating block, a helium gas stream was teed in using a ground glass connection to quench and dilute the reaction effluent line. The effluent then passed through a Hastelloy junction where a glass capillary tube (0.025 mm ID) delivered gases directly to the mass spectrometer.

Data in FIG. 52 where various oxygen:methane ratios are fed to a bubble column of LiI mixed with LiOH were both methane and oxygen are fed together in a single inlet tube. Methane conversion (B) and selectivity to carbon oxides (C) increases as oxygen:methane increases while selectivity to carbon (A) decreases. Since the reaction between melt and oxygen are rapid, even high oxygen:methane ratios result in low selectivities to undesirable carbon oxides. The temperature was 650° C., the methane pressure was 0.3 bar, the ratio of LiI:LiOH was 1:1 mole, the oxygen:methane ratio was expressed as a molar ration, and there is greater than 98% oxygen conversion in all cases.

This example demonstrates the successful and selective conversion of methane to solid carbon and steam in a single reaction vessel using a molten salt as a catalyst, and supports the following conclusions: (1) In the absence of oxygen, methane does not react with molten lithium iodide and lithium hydroxide, as evidenced by the fact that there is no methane conversion at O₂:CH₄=0; (2) Too much oxygen results in higher carbon oxide selectivities, which are undesirable, and also result in conversion of the salt to iodine gas which leaves the reactor unreacted, and therefore there is an optimum in oxygen to methane ratio.

In another experiment, reference is made to FIG. 53. The conversion of oxygen (A) and methane (B) are measured along with selectivity to carbon (C) and selectivity to carbon oxides (D) as a function of temperature in a bubble column with 1:1 mole LiI:LiOH, 0.3 bar methane, and 0.3 bar oxygen. At 500 C, very little methane conversion is observed, however the oxygen conversion is over 75%, supporting the claim that the rate of reaction between oxygen and LiI is significantly faster than hydrocarbon reactions. At higher temperatures, complete or nearly complete oxygen conversion is observed and methane conversion increases with increasing temperature. The selectivity to carbon does not significantly decrease as temperature increases above 600 C, which corresponds to the temperature that complete oxygen conversion is observed, supporting the claim that the rapid reaction between oxygen and lithium iodide result in decreasing oxygen pressure, and therefore less carbon oxide formation. Carbon oxide selectivity is relatively low and does not significantly increase at higher temperatures.

This example demonstrates the successful conversion of methane to steam and carbon with differing levels of selectivity at varying temperatures, and supports the following conclusions: (1) oxygen conversion, which is directly related to oxygen partial pressure, is correlated to carbon selectivity, (2) oxygen conversion is more rapid than hydrocarbon reactions and in a relatively short bubble column converts completely at lower temperatures than significant methane reactions occur, and (3) when oxygen is rapidly consumed, higher selectivities to carbon are observed.

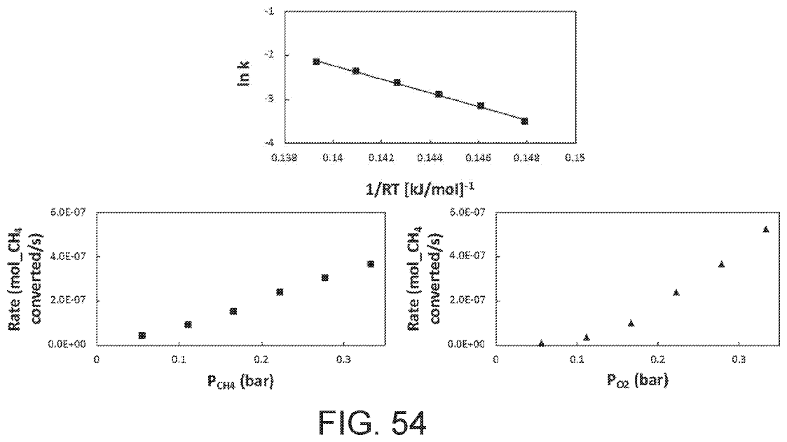

In another experiment, reference is made to FIG. 54. The activation energy and reaction orders were obtained from this data. The logarithm of the reaction rate at 0.22 bar CH₄ and 0.22. bar O₂ is plotted as a function of 1/temperature to determine the activation energy of 156 kJ/mol. The reaction order in methane was found to be first order where the partial pressure of methane was varied at 575° C. at low conversion. A reaction order near 2.5 was observed for oxygen at 575° C. in a 1:1 LiI:LiOH bubble column. In all cases, the reaction between oxygen and methane was in a bubble column of 1:1 mole LiI:LiOH. The results are consistent with methane activation occurring in the gas-phase in a reaction between iodine radicals and methane, which has a similar methane partial pressure dependence and activation energy. The results also support a reaction with lithium iodide and oxygen.

### Example 24

### Hydrogen Halide Oxidation by Molten Salts

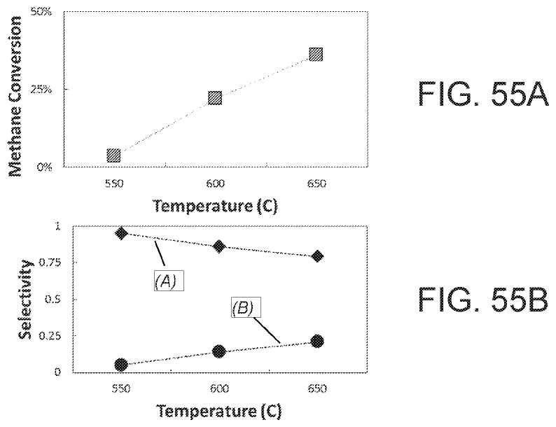

Reference is made to FIGS. 55A and 55B. A halogen and methane were fed to a reactor in the absence of oxygen, but in the presence of an oxygen carrier, LiOH. Significant water (A) and hydrogen (B) were produced without the formation of carbon oxides. The same experiment with only LiI (no LiOH) did not have any measurable methane conversion, demonstrating the important role of LiOH in the iodide mediated process to react with hydrogen iodide and prevent it from participating further in the reaction mechanism. FIG. 55B shows experimental results when the temperature was varied and methane and iodine gas were fed into a bubble column of LiI—LiOH at 0.15 bar methane. No oxygen was fed, but conversion was observed with high selectivity to solid carbon when LiI—LiOH was used. The same experiment with only LiI (no LiOH) did not have any measurable methane conversion, demonstrating the important role of LiOH in the iodide mediated process.

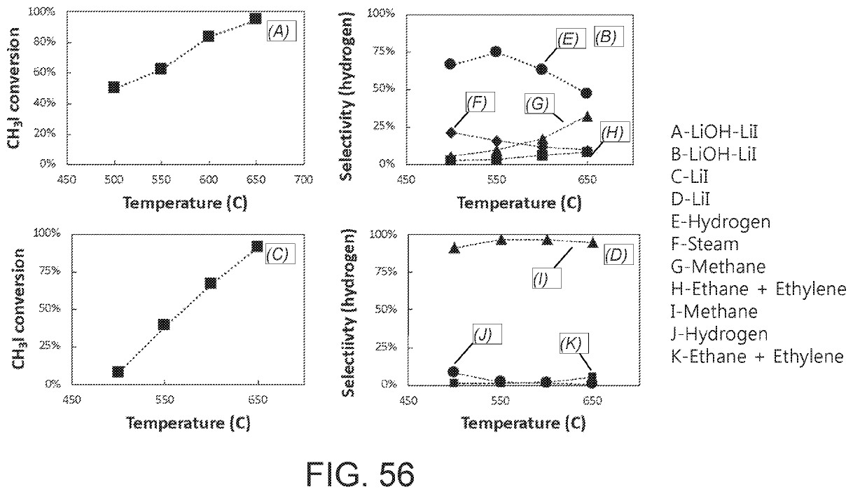

Reference is made to FIG. 56 where methyl iodide was fed to a reactor consisting of either LiI (FIGS. 56C and 56D) or LiI mixed with LiOH (FIGS. 56A and 56B). The results indicate methyl iodide conversion and selectivity were improved in the presence of LiOH and that nearly 100% methyl iodide conversion was achieved at 650° C. in a short lab scale bubble column. Methyl iodide conversion (A) and selectivity to hydrogen (F), steam (F), methane (G), and ethane (H) were measured as a function of temperature in the presence of 1:1 LiOH:LiI with 0.61 atm methyl iodide. Methyl iodide conversion (C) and selectivity to hydrogen (J), methane (I), and ethane (K) were also measured as a function of temperature in the presence of with 0.61 atm methyl iodide.

The results indicate methyl iodide conversion and selectivity are improved in the presence of LiOH and that nearly 100% methyl iodide conversion is achieved at 650° C. in a short lab scale bubble column. Methyl iodide conversion (1) plotted as a function of temperature when 0.61 atm methyl iodide was bubbled through 1:1 LiOH:LiI. (2) Selectivity to hydrogen containing products from the experiment in (1). (3) & (4) Conversion and selectivity to hydrogen containing products when 0.61 atm methyl iodide was bubble through pure LiI of the same height as (1) and (2).

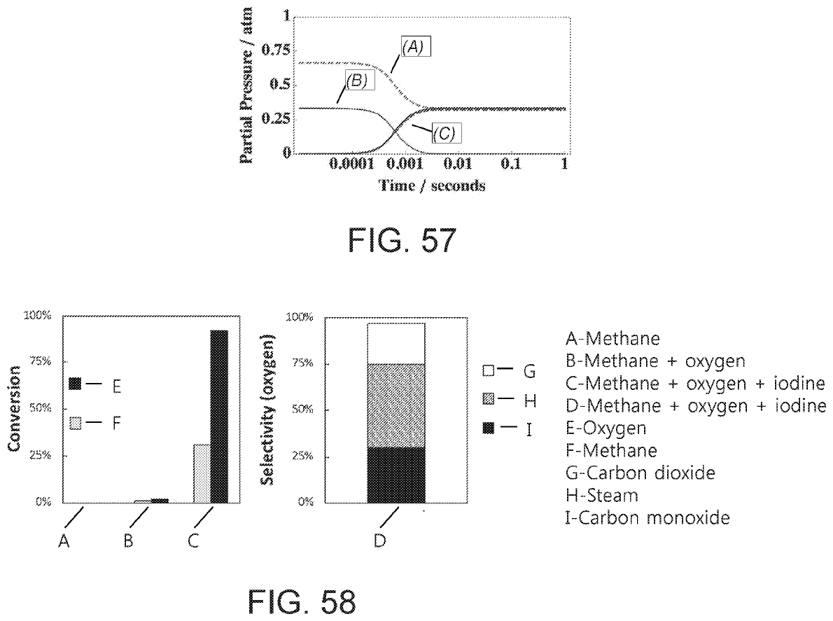

The presence of the hydroxide improves both conversion and selectivity. The hydroxide is needed to prevent the formation of methane from methyl iodide. The reaction between HI and CH₃I in the gas-phase is the reason for methane formation, and FIG. 57 shows the results from kinetic modeling in which the gas-phase radical network is modeled using microkinetic parameters gathered from the National Institute of Science and Technology (NIST). The selectivity to methane and iodine (C), hydrogen iodide (B), and methyl iodide (A) are plotted as a function of time and indicate that methane is produce in when methyl iodide and hydrogen iodide are present together.

Reference is made to FIG. 58 which shows experimental data from methane reacting with oxygen and iodine in the gas phase. Methane conversion and oxygen conversion are plotted in FIG. 58A. Methane alone is stable, and methane in the presence of oxygen is stable. However, in the presence of gas-phase iodine, significant conversion of oxygen and methane to carbon oxides is observed. The reaction has no salt present.

Three experiments were operated at 650 C and 15 seconds residence time in an empty quartz reactor and demonstrate the role of iodine and further demonstrate the importance of lithium hydroxide. When methane at 0.2 bar was sent to the reactor A, no methane conversion F was observed. When methane at 0.2 bar and oxygen at 0.05 bar were sent to the reactor B, little methane conversion or oxygen conversion E was observed. When methane at 0.2 bar, oxygen at 0.05 bar, and iodine at 0.1 bar C was sent to the reactor, significant methane and oxygen conversion were observed, along with selectivity to carbon dioxide G, steam H, and carbon monoxide I. The selectivity indicates that in these experiments in which salt was not present, significant methane combustion occurs, further demonstrating the novelty and importance of molten salt catalysts.

### Example 25

### Conversion of Methane and Bromine to Carbon and Hydrogen Bromide

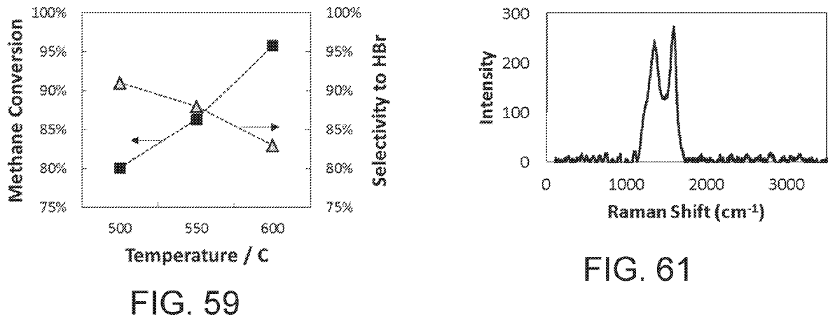

Reference is made to FIG. 59. Methane and bromine are fed to a reactor consisting of NiBr₂ dissolved in KBr, as part of the scheme depicted in the schematic in FIG. 13. The resulting melt provides a medium for the decomposition of methane to carbon and hydrogen bromide where the carbon floats to the melt surface. Even at 500° C., high conversion of methane is observed with high selectivity to hydrogen bromide. The resulting hydrogen bromide may be sent to a reactor containing NiO or NiO suspended in a salt; the reaction between HBr and NiO produces NiBr₂, which could be contacted with oxygen to produce the bromine that is fed to the reactor in FIG. 59. Complete bromine conversion was observed at 500° C. 550° C. and 600° C. The major product was HBr and carbon. The carbon was observed to float to the surface of the molten salt.

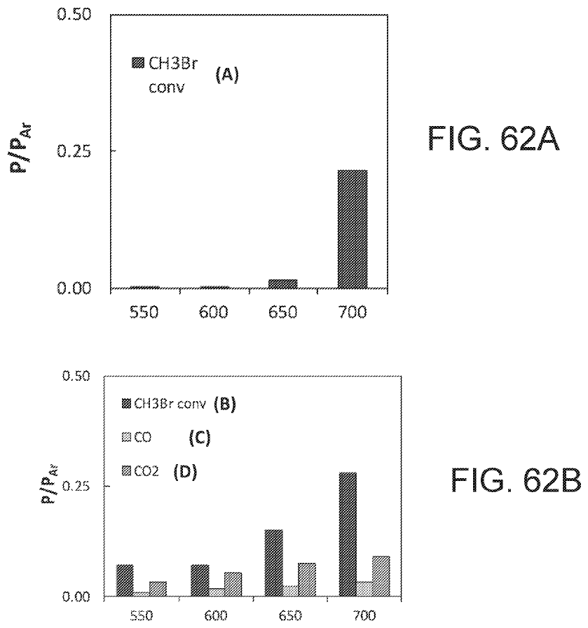

In this example, the oxidation of methyl bromide by suspended oxide is avoided by separating the oxygen carrier from the hydrocarbon or carbon species. In the absence of this separation, carbon oxides are observed, as in the results presented in FIG. 62. Here, methyl bromide is sent to a reactor containing either NiBr₂—KBr—LiBr (top) or NiBr₂—NiO—KBr—LiBr, and the conversion of methyl bromide (A) and (B) are presented as a function of temperature with the selectivity to carbon monoxide (C), and carbon dioxide (D). FIG. 62 contains experimental results from sending methyl bromide to a bubble column of NiBr₂—KBr—LiBr in which suspended nickel oxide (NiO) was present (bottom) and absent (top). In the absence of NiO, little methyl bromide conversion was observed and the conversion that did take place at 700° C. yielded primarily methane and carbon. In the presence of NiO (bottom), significant carbon oxides were observed at 550-700° C.

The presence of carbon oxides indicates that some contact between NiO and methyl bromide or a carbon containing species occurs and reduces the overall selectivity to solid carbon, supporting the conclusion that separation of the oxygen carrier and hydrocarbon conversion can result in improved overall process efficiency in some preferred embodiments.

### Example 26

### Carbon Formation and Removal from Molten Lithium Iodide in Methane Partial Combustion

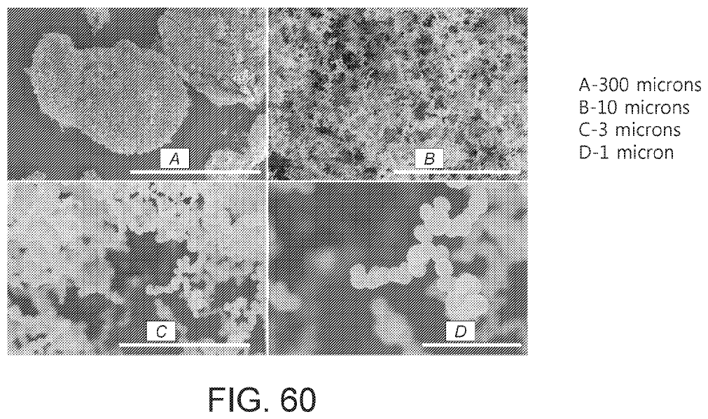

Reference is made to FIGS. 60 and 61. Carbon that was formed by contacting methane at 700° C. in a LiI—LiOH melt. The carbon floated to the surface and was visually observed to have accumulated. FIG. 60 is a set of scanning electron microscopy images of the carbon at the surface of a LiI—LiOH bubble column after cooling when CH₃I had been bubbled though. The carbon formed a clear separable layer at the melt surface where it was removed for imaging. The images are consistent with carbon black. The Raman spectrum in FIG. 61 of the same carbon is also consistent with the formation of carbon black.

This example illustrates the morphology of carbon produced from largely gas-phase decomposition resulting in morphology that is consistent with carbon black. The small spherical carbon groups interconnected with high surface area are achieved from the thermal decomposition of methyl iodide in a molten iodide salt, FIG. 60. Four different levels of magnification are present. (A) represents a scale bar of 300 microns, (B) represents a scale bar of 30 microns, (C) represents a scale bar of 3 microns, and (D) represents a scale bar of 1 micron. Experimental conversion and selectivity data for experiments in which methyl iodide was sent to a bubble column of iodide salt or iodide-hydroxide salt is shown in FIG. 56.

### Example 27

### Two-Stage Generation of Hydrogen and Power with a Separate Stream of CO₂ from Natural Gas in Molten Salt Reactors

Reference is made to FIG. 14. Methane is bubbled through a high-temperature, molten salt medium to thermochemically decompose it into molecular hydrogen and solid carbon. The gaseous hydrogen is collected at the top of the reactor and solid carbon floats to the molten salt surface. A molten salt is chosen to have a density comparable to solid carbon at reaction temperature, so a molten salt-carbon slurry forms. This slurry is diverted into a separate vessel via gravitational forces, a molten salt pump, and/or and auxiliary gas flow. A separate stream of oxygen is bubbled through the slurry to combust all of the solid carbon, producing a pure stream of CO₂ and heat. The hot CO₂ stream can be passed through a turbine to generate power and cool it for compression and sequestration or utilization. The power generated from this combustion can be fed back into the first vessel to drive the endothermic decomposition. Pristine salt is then recycled back to the base of the molten salt reactor. In a specific example using the configuration of FIG. 14, 20 sccm of methane are bubbled through pure NaCl at 1000° C. The carbon-salt slurry is transferred from the top of the molten salt reactor into a separate vessel at 900° C. fed with 20 sccm of O₂. Combustion of the solid carbon is complete, regenerating fresh NaCl to be recycled to the reactor.

Having described various systems and methods here, specific examples can include, but are not limited to:

In a first embodiment, a continuous process comprises: producing carbon and heat and/or steam by reacting oxygen and a natural gas hydrocarbon without producing significant amounts of carbon oxides by use of a halogen intermediate created by a rapid reaction of oxygen with a metal halide which in turn reacts with the hydrocarbon. A second embodiment can include the process of the first embodiment, wherein the carbon is continually separated from the salt as a suspension or immiscible phase.

In a third embodiment, a continuous process comprises: converting a natural gas hydrocarbon to carbon using a halogen oxidant in the presence of a solid or liquid oxidant.

In a fourth embodiment, a continuous process comprises: feeding oxygen and hydrocarbons into a molten salt solution, wherein the oxygen reacts with the molten salt produces a halogen more rapidly than the hydrocarbon preventing formation of carbon oxides, wherein the halogen produced by the reaction of the oxygen with the salt activates and reacts with the hydrocarbons.

In a fifth embodiment, a continuous process comprises: producing carbon and hydrogen halides from natural gas and a halogen in which the hydrogen halide is separated from the carbon stream and reacted with an oxide in a separate reactor or section of the same reactor to produce a halide or oxyhalide salt, wherein the exothermic oxidation of the hydrogen halide can optionally be used to produce heat or steam.

In a sixth embodiment, a process comprises: converting a hydrogen halide to a halogen using oxygen and a chemical looping salt in which one or more of the salt constituents is a liquid or dissolved in a liquid.

In a seventh embodiment, a process comprises: converting the exothermic heat from the reaction between oxygen and methane into carbon and steam to power using a steam cycle or a salt heat cycle.

In an eighth embodiment, a continuous process comprises i) hydrocarbon pyrolysis in a molten salt to produce separable solid carbon and molecular gaseous hydrogen, ii) combustion in a combustion unit, wherein the hydrogen produced is contacted with oxygen to produce high energy steam which drives a gas turbine, and iii) use of the outlet steam from the gas turbine in a steam turbine in a combined configuration.

In a ninth embodiment, a pyrolysis reactor for producing solid carbon and hydrogen from pure or mixtures of reactants containing hydrogen and carbon comprises: a molten salt at high temperature, wherein the reactor is configured to receive the reactant and cause the reactants to react to form hydrogen and carbon. A tenth embodiment can comprise the pyrolysis reactor of the ninth embodiment, wherein the molten salt consists of a mixture of halide salts where the anion is predominately chlorine, bromine, or iodine and the cation is predominately Na, K, Li, Mn, Zn, Al, Ce. An eleventh embodiment can comprise the pyrolysis reactor of the tenth embodiment, wherein the molten salt contains a solid suspension of solid catalysts comprised of a reactive metal or mixture of metals (including but not limited to Ni, Fe, Co, Mn, Cu, W, Pt, Pd) supported on a nonreactive solid (including but not limited to alumina, silica, Carbon, zirconia).

In a twelfth embodiment a reactor comprises: a molten salt and/or a molten salt and solid suspension at high temperature configured to receive a hydrocarbon containing reactant including alkane (methane, ethane, propane, butane, . . . ) gases or mixtures of alkane gases and cause the reactant to react to form a hydrocarbon product and hydrogen. A thirteenth embodiment can comprise the reactor of the twelfth embodiment, wherein the molten salt and/or mixture is configured to allow removal and separation of the solid carbon formed.

In a fourteenth embodiment, a reactor comprises: a molten salt and/or molten salt and solid suspension at high temperature, wherein the molten salt and/or the molten salt and solid suspension is configured to receive a feed comprising a mixture of an alkane gas and carbon dioxide and cause the feed to react to form hydrogen and carbon monoxide. A fifteenth embodiment can comprise the reactor of the fourteenth embodiment, wherein the molten salt and/or mixture is selected to allow removal and separation of any solid carbon formed.

In a sixteenth embodiment, a reactor comprises: a molten salt and/or molten salt suspension at high temperature configured to receive gas phase hydrogen and carbon containing reactants and contact the reactants with the molten material producing hydrogen as one of the products, wherein the molten salt comprises a mixture of halide salts where the anion is predominately chlorine, bromine, or iodine and the cation is predominately Na, K, Li, Mn, Zn, Al, Ce, and wherein the molten salt suspension comprises particles containing a reactive metal or mixture of metals (including but not limited to Ni, Fe, Co, Mn, Cu, W, Pt, Pd) supported on a nonreactive solid (including but not limited to alumina, silica, Carbon, zirconia). A seventeenth embodiment can include a reactor system for the processes and systems of any one of the first to eighth embodiments, wherein the gas phase reactants are introduced into the bottom of the reactors and bubble to the surface guided by an internal structure allowing circulation of the molten materials into which products are dissolved and removal of the dissolved species in the lower pressure/temperature environment of the upper region of the reactor.

In an eighteenth embodiment, a reactor system can include the processes of any one of the first to eighth embodiments, whereby the gas phase reactants are contacted with the liquid at the bottom of the reactor and guided through a tube to allow bubble lift pumping of the liquid containing dissolved products to the top of the reactor column together with the gas in bubbles where the products dissolved within the liquid are allowed to move into the gas phase for removal from the reactor. The circulation of the molten material is provided by the lifting of the bubbles.

In a nineteenth embodiment, a reactor system for the processes and systems of any one of the first to eighth embodiments can include an exothermic reaction (i.e. combustion) of the soluble species is accomplished in a separate bubble stream from the primary reaction system where a reactant (e.g. oxygen) is introduced.

In a nineteenth embodiment, a reactor system for the processes and systems of any one of the first to eighth embodiments can include, wherein an endothermic reaction process (i.e. steam generation) with or without the soluble species is accomplished in a separate stream from the primary reaction system where a reactant (e.g. liquid water) is introduced.

In a twenty first embodiment, a reaction process comprises: providing a feed stream comprising a hydrocarbon to a vessel containing a molten salt mixture, wherein the molten salt mixture comprises: an active metal component, and a molten salt solvent; reacting the feed stream with the molten salt mixture in the vessel; and producing carbon based on the reacting of the feed stream with the molten salt mixture in the vessel.

A twenty second embodiment can include the process of the twenty first embodiment, Wherein the feed stream is bubbled through the molten salt mixture. A twenty third embodiment can include the process of the twenty first or twenty second embodiment, further comprising: separating the carbon as a layer on top of the molten salt mixture; or solidifying the molten salt mixture and dissolving the molten salt mixture in an aqueous solution to separate the carbon. A twenty fourth embodiment can include the process of any one of the twenty first to twenty third embodiments, further comprising: providing oxygen to the vessel; and producing steam based on the reacting of the feed stream and the oxygen with the molten salt mixture. A twenty fifth embodiment can include the process of any one of the twenty first to twenty third embodiments, further comprising: producing hydrogen based on the reacting of the feed stream with the molten salt mixture in the vessel. A twenty sixth embodiment can include the process of any one of the twenty first to twenty fifth embodiments, wherein reacting the feed stream with the molten salt mixture comprises: reacting a hydrocarbon with a halogen to form a hydrogen halide and the carbon; converting the hydrogen halide to a halide salt within the molten salt mixture by reacting the hydrogen halide with an oxide or hydroxide; and reacting oxygen with the halide salt to produce the halogen and the oxide or hydroxide. A twenty seventh embodiment can include the process of any one of the twenty first to twenty sixth embodiments, wherein the molten salt solvent comprises one or more oxidized atoms (M)^{+m} and corresponding reduced atoms (X)⁻¹, wherein M is at least one of K, Na, or Li, and wherein X is at least one of F, Cl, Br, I, OH, SO₃, or NO₃. A twenty eighth embodiment can include the process of any one of the twenty first to twenty seventh embodiments, wherein the active metal component comprises a salt having oxidized atoms (MA)⁺ⁿ and reduced atoms (X)⁻¹, wherein MA is at least one of Zn, La, Mn, Co, Ni, Cu, Mg, or Ca, and wherein X is at least one of F, Cl, Br, I, OH, SO₃, or NO₃. A twenty ninth embodiment can include the process of any one of the twenty first to twenty eighth embodiments, wherein the active metal component comprises at least one of MnCl₂, ZnCl₂, or AlCl₃, and wherein the molten salt solvent comprises at least one of: KCl, NaCl, KBr, NaBr, CaCl₂, or MgCl₂. A thirtieth embodiment can include the process of any one of the twenty first to twenty ninth embodiments, wherein the active metal component comprises a solid metal particle in the molten salt solvent. A thirty first embodiment can include the process of any one of the twenty first to thirtieth embodiments, wherein the active metal component comprises a solid metal component disposed on a support structure within the molten salt solvent. A thirty second embodiment can include the process of any one of the twenty first to thirty first embodiments, wherein the active metal component comprises a molten metal, wherein the molten metal forms a slurry with the molten salt solvent. A thirty third embodiment can include the process of any one of the twenty first to thirty second embodiments, further comprising: transferring the molten salt mixture to a second vessel; introducing oxygen to the second vessel; reacting the oxygen with the molten salt mixture in the second vessel; and returning the molten salt mixture to the vessel after reacting the oxygen with the molten salt mixture in the second vessel. A thirty fourth embodiment can include the process of the thirty third embodiment, wherein the molten salt mixture comprises the carbon when transferred to the second vessel, and wherein reacting the oxygen with the molten salt mixture in the second vessel produces carbon oxides. A thirty fifth embodiment can include the process of any one of the twenty first to thirty fourth embodiments, wherein the molten salt mixture comprises LiI mixed with LiOH. A thirty sixth embodiment can include the process of any one of the twenty first to thirty fourth embodiments, wherein the molten salt mixture comprises NiBr₂ mixed with KBr. A thirty seventh embodiment can include the process of any one of the twenty first to thirty fourth embodiments, wherein the molten salt mixture comprises molten Ni—Bi emulsified with molten NaCl. A thirty eighth embodiment can include the process of any one of the twenty first to thirty fourth embodiments, wherein the molten salt mixture comprises LH mixed with A thirty ninth embodiment can include the process of any one of the twenty first to thirty fourth embodiments, wherein the molten salt mixture comprises CsBr having a packed bed of supported molten LiF supported on alumina. A fortieth embodiment can include the process of any one of the twenty first to thirty fourth embodiments, wherein the molten salt mixture comprises MnCl₂. A forty first embodiment can include the process of any one of the twenty first to thirty fourth embodiments, wherein the molten salt mixture comprises MnCl₂ and KBr. A forty second embodiment can include the process of any one of the twenty first to thirty fourth embodiments, wherein the molten salt mixture comprises a eutectic mixture of MnCl₂ and NaCl. A forty third embodiment can include the process of any one of the twenty first to thirty fourth embodiments, wherein the molten salt mixture comprises a eutectic mixture of LiBr and KBr. A forty fourth embodiment can include the process of any one of the twenty first to thirty fourth embodiments, wherein the molten salt mixture comprises at least one of MnCl₂ and KBr; MgCl₂ and KCl; or LiCl, LiBr, and KBr. A for fifth embodiment can include the process of any one of the twenty first to thirty fourth embodiments, wherein the active metal component comprises particles of Co or Ce. A forty sixth embodiment can include the process of any one of the twenty first to thirty fourth embodiments, wherein the molten salt mixture comprises a magnesium based salt. A forty seventh embodiment can include the process of any one of the twenty first to thirty fourth embodiments, wherein the molten salt mixture comprises a fluoride salt. A forty eighth embodiment can include the process of any one of the twenty first to forty seventh embodiments, wherein the molten salt mixture comprises at least one salt in the solid phase. A forty ninth embodiment can include the process of any one of the twenty first to forty eighth embodiments, wherein the carbon is produced without generating carbon oxides.

In a fiftieth embodiment, a process for the production of carbon from a hydrocarbon gas comprises: providing a feed stream comprising a hydrocarbon to a vessel containing a molten salt mixture, wherein the molten salt mixture comprises: an active metal component, and a molten salt solvent, contacting the feed stream with the molten salt mixture in the vessel; and producing carbon based on the contacting of the feed stream with the molten salt mixture in the vessel; and separating a carbon product from the molten salt mixture. A fifty first embodiment can include the process of the fiftieth embodiment, wherein the feed stream is bubbled through the molten salt mixture. A fifty second embodiment can include the process of the fiftieth or fifty first embodiment, further comprising: separating the carbon as a layer on top of the molten salt mixture. A fifty third embodiment can include the process of any one of the fiftieth to fifty second embodiments, wherein the molten salt mixture has a density equal to or greater than the density of the carbon. A fifty fourth embodiment can include the process of any one of the fiftieth to fifty third embodiments, wherein the carbon comprises at least one of graphite, graphene, carbon nanotubes, carbon black, or carbon fibers. A fifty fifth embodiment can include the process of any one of the fiftieth to fifty fourth embodiments, further comprising: producing hydrogen based on the reacting of the feed stream with the molten salt mixture in the vessel. A fifty sixth embodiment can include the process of any one of the fiftieth to fifty fifth embodiments, wherein reacting the feed stream with the molten salt mixture comprises: reacting a hydrocarbon with a halogen to form a hydrogen halide and the carbon; converting the hydrogen halide to a halide salt within the molten salt mixture by reacting the hydrogen halide with an oxide or hydroxide; and reacting oxygen with the halide salt to produce the halogen and the oxide or hydroxide. A fifty seventh embodiment can include the process of any one of the fiftieth to fifty sixth embodiments, wherein the molten salt solvent comprises one or more oxidized atoms (M)^{+m} and corresponding reduced atoms (X)⁻¹, wherein M is at least one of K, Na, or Li, and wherein X is at least one of F, Cl, Br, I, OH, SO₃, or NO₃. A fifty eighth embodiment can include the process of any one of the fiftieth to fifty seventh embodiments, wherein the active metal component comprises a salt having oxidized atoms (MA)⁺ⁿ and reduced atoms (X)⁻¹, wherein MA is at least one of Zn, La, Mn, Co, Ni, Cu, Mg, or Ca, and wherein X is at least one of F, Cl. Br, I, OH, SO₃, or NO₃. A fifty ninth embodiment can include the process of any one of the fiftieth to fifty eighth embodiments, Wherein the active metal component comprises at least one of MnCl₂, ZnCl₂, or AlCl₃, and wherein the molten salt solvent comprises at least one of: KCl, NaCl, KBr, NaBr, CaCl₂, or MgCl_{2.} A sixtieth embodiment can include the process of any one of the fiftieth to fifty ninth embodiments, wherein the active metal component comprises a solid metal particle in the molten salt solvent. A sixty first embodiment can include the process of any one of the fiftieth to sixtieth embodiments, wherein the active metal component comprises a solid metal component disposed on a support structure within the molten salt solvent. A sixty second embodiment can include the process of any one of the fiftieth to sixty first embodiments, wherein the active metal component comprises a molten metal, wherein the molten metal forms a slurry with the molten salt solvent. A sixty third embodiment can include the process of any one of the fiftieth to sixty second embodiments, wherein the molten salt mixture comprises LiI mixed with LiOH. A sixty fourth embodiment can include the process of any one of the fiftieth to sixty second embodiments, wherein the molten salt mixture comprises MnCl₂ and KBr. A sixty fifth embodiment can include the process of any one of the fiftieth to sixty second embodiments, wherein the molten salt mixture comprises a eutectic mixture of MnCl₂ and NaCl. A sixty sixth embodiment can include the process of any one of the fiftieth to sixty second embodiments, wherein the molten salt mixture comprises a eutectic mixture of LiBr and KBr. A sixty seventh embodiment can include the process of any one of the fiftieth to sixty sixth embodiments, Wherein the molten salt mixture comprises at least one salt in the solid phase. A sixty eighth embodiment can include the process of any one of the fiftieth to sixty seventh embodiments, wherein the carbon is produced without generating carbon oxides.

In a sixty ninth embodiment, a process for producing power comprises: reacting a feed stream with a molten salt mixture, wherein the feed stream comprises a hydrocarbon containing gas; producing heat based on the reacting; and generating power using the heat. A seventieth embodiment can include the process of the sixty ninth embodiment, wherein the feed stream further comprises oxygen, and wherein producing heat comprises: forming carbon and steam based on reacting the feed stream with the molten salt mixture, wherein generating power uses the heat in the steam to generate the power. A seventy first embodiment can include the process of the sixty ninth or seventieth embodiment, wherein reacting the feed stream with the molten salt mixture comprises: reacting the feed stream with the molten salt mixture in a vessel; producing carbon and steam based on the reacting of the feed stream with the molten salt mixture in the vessel; transferring the molten salt mixture to a second vessel; introducing oxygen to the second vessel; reacting the oxygen with the molten salt mixture in the second vessel to generate heat; and returning the molten salt mixture to the vessel after reacting the oxygen with the molten salt mixture in the second vessel. A seventy second embodiment can include the process of the seventy first embodiment, Wherein reacting the oxygen with the molten salt mixture in the second vessel generate carbon oxides. A seventy third embodiment can include the process of the seventy first or seventy second embodiment, wherein the heat is generated in the steam, the carbon oxides, or both. A seventy fourth embodiment can include the process of the sixty ninth or seventieth embodiment, further comprising: producing hydrogen based on the reacting of the feed stream with the molten salt mixture; and combusting the hydrogen to generate the heat. A seventy fifth embodiment can include the process of any one of the sixty ninth to seventy fourth embodiments, wherein generating power using the heat comprises: using a turbine to generate electricity. A seventy sixth embodiment can include the process of any one of the sixty ninth to seventy first embodiments, wherein the power is generated without generating carbon oxides.

In a seventy seventh embodiment, a reaction process comprises: providing a feed stream comprising a hydrocarbon to a vessel containing a molten salt mixture, wherein the salt mixture comprises: a reactive salt; reacting the feed stream with the salt mixture in the vessel; and producing carbon based on the reacting of the feed stream with the salt mixture in the vessel. A seventy eighth embodiment can include the process of the seventy seventh embodiment, wherein the feed stream is bubbled through the salt mixture. A seventy ninth embodiment can include the process of the seventy seventh or seventy eighth embodiment, further comprising: separating the carbon as a layer on top of the salt mixture; or solidifying the carbon in the salt mixture and dissolving the salt mixture in a liquid solution to separate the carbon. An eightieth embodiment can include the process of any one of the seventy seventh to seventy ninth embodiments, further comprising: providing oxygen to the vessel; and producing steam based on the reacting of the feed stream and the oxygen with the salt mixture. An eighty first embodiment can include the process of any one of the seventy seventh to seventy ninth embodiments, further comprising: producing hydrogen based on the reacting of the feed stream with the salt mixture in the vessel. An eighty second embodiment can include the process of any one of the seventy seventh to eighty first embodiments, wherein reacting the feed stream with the salt mixture comprises: reacting a hydrocarbon with a halogen to form a hydrogen halide and the carbon; converting the hydrogen halide to a halide salt within the salt mixture by reacting the hydrogen halide with an oxide or hydroxide; and reacting oxygen with the halide salt to produce the halogen and the oxide or hydroxide. An eighty third embodiment can include the process of any one of the seventy seventh to eighty second embodiments, wherein the salt solvent comprises one or more oxidized atoms (M)^{+m} and corresponding reduced atoms (X)⁻¹, wherein M is at least one of K, Na, or Li, and wherein X is at least one of F, Cl, Br, I, OH, SO₃, or NO₃. An eighty fourth embodiment can include the process of any one of the seventy seventh to eighty third embodiments, wherein the salt mixture further comprises an active metal component, wherein the active metal component comprises a salt having oxidized atoms (MA)⁺ⁿ and reduced atoms (X)⁻¹, wherein MA is at least one of Zn, La, Mn, Co, Ni, Cu, Mg, or Ca, and wherein X is at least one of F, Cl, Br, I, OH, SO₃, or NO₃. An eighty fifth embodiment can include the process of the eighty fourth embodiment, wherein the active metal component comprises at least one of MnCl₂, ZnCl₂, or AlCl₃, and wherein the molten salt solvent comprises at least one of: HCl, NaCl, KBr, NaBr, CaCl₂, or MgCl_{2.} An eighty sixth embodiment can include the process of the eighty fourth or eighty fifth embodiment, wherein the active metal component comprises a solid metal particle in the molten salt solvent. An eighty seventh embodiment can include the process of any one of the eighty fourth to eighty sixth embodiments, wherein the active metal component comprises a solid metal component disposed on a support structure within the molten salt solvent. An eighty eighth embodiment can include the process of any one of the eighty fourth to eighty seventh embodiments, wherein the active metal component comprises a molten metal, wherein the molten metal forms a slurry with the molten salt solvent. An eighty ninth embodiment can include the process of any one of the seventy seventh to eighty eighth embodiments, wherein the salt mixture comprises LiI mixed with LiOH. A ninetieth embodiment can include the process of any one of the seventy seventh to eighty eighth embodiments, wherein the salt mixture comprises NiBr₂ mixed with KBr. A ninety first embodiment can include the process of any one of the seventy seventh to eighty eighth embodiments, wherein the salt mixture comprises molten Ni—Bi emulsified with molten NaCl. A ninety second embodiment can include the process of any one of the seventy seventh to eighty eighth embodiments, wherein the salt mixture comprises LiI mixed with LiOH. A ninety third embodiment can include the process of any one of the seventy seventh to eighty eighth embodiments, wherein the salt mixture comprises CsBr having a packed bed of supported molten LiF supported on alumina. A ninety fourth embodiment can include the process of any one of the seventy seventh to eighty eighth embodiments, wherein the salt mixture comprises MnCl₂. A ninety fifth embodiment can include the process of any one of the seventy seventh to eighty eighth embodiments, wherein the salt mixture comprises MnCl₂ and KBr. A ninety sixth embodiment can include the process of any one of the seventy seventh to eighty eighth embodiments, wherein the salt mixture comprises a eutectic mixture of MnCl₂ and NaCl. A ninety seventh embodiment can include the process of any one of the seventy seventh to eighty eighth embodiments, wherein the salt mixture comprises a eutectic mixture of LiBr and KBr. A ninety eighth embodiment can include the process of any one of the seventy seventh to eighty eighth embodiments, wherein the salt mixture comprises at least one of MgCl₂ and KBr; MgCl₂ and KCl; or LiCl, Br, and KBr. A ninety ninth embodiment can include the process of any one of the twenty eighth to eighty eighth embodiments, wherein the active metal component comprises particles of Co or Ce. A one hundredth embodiment can include the process of any one of the seventy seventh to eighty eighth embodiments, wherein the salt mixture comprises a magnesium based salt. A one hundred first embodiment can include the process of any one of the seventy seventh to eighty eighth embodiments, wherein the salt mixture comprises a fluoride salt. A one hundred second embodiment can include the process of any one of the seventy seventh to eighty eighth embodiments, wherein the carbon is produced without generating carbon oxides.

In addition to the embodiments disclosed herein, certain aspects can include, but are not limited to:

In a first aspect, a reaction process comprises: feeding a feed stream (101) comprising a hydrocarbon into a vessel (204, 304, 403). wherein the vessel (204, 304, 403) comprises a molten salt mixture (203, 332, 771) and a reactive component; reacting the feed stream (101) in the vessel (204, 304, 403); producing reaction products comprising solid carbon and a gas phase product (208) based on the reacting of the feed stream; contacting the reaction products with the molten salt mixture (203, 332, 771); separating the gas phase product (208, 337) from the molten salt mixture; and separating the solid carbon from the molten salt mixture to produce a solid carbon product (209). A second aspect can include the reaction process of the first aspect, wherein the solid carbon is solvated, carried, or entrained in the molten salt mixture. A third aspect can include the reaction process of the first or second aspect, further comprising: exchanging heat with the feed stream and molten salt mixture within the vessel using the molten salt mixture as a thermal fluid. A fourth aspect can include the reaction process of any one of the first to third aspects, wherein the feed stream is bubbled through the molten salt mixture, and wherein the method further comprises: passing the solid carbon and the molten salt mixture out of the vessel based on bubbling the feed stream through the molten salt mixture; and wherein separating the solid carbon from the molten salt mixture occurs after the solid carbon and the molten salt mixture passes out of the vessel. A fifth aspect can include the reaction process of the fourth aspect, wherein separating the solid carbon from the molten salt mixture comprises at least one of: passing the solid carbon and the molten salt mixture over a filter (336, 536) to retain the solid carbon on the filter; separating the solid carbon from the molten salt mixture using differences in density of the solid carbon and the molten salt mixture; or using a solid transfer device (408) to physically remove the solid carbon from the molten salt mixture in a second vessel. A sixth aspect can include the reaction process of any one of the first to fifth aspects, 6 further comprising: separating the solid carbon as a layer on top of the molten salt mixture (203, 332, 771); or solidifying the solid carbon and the molten salt mixture (203, 332, 771) to produce a solidified salt mixture and dissolving salt from the solidified salt mixture in a liquid solution to separate the solid carbon. A seventh aspect can include the reaction process of any one of the first to sixth aspects, further comprising: providing oxygen to the vessel (204, 304, 403); and producing steam based on the reacting of the feed stream and the oxygen with the molten salt mixture. An eighth aspect can include the reaction process of any one of the first to seventh aspects, wherein the molten salt mixture (203, 332, 771) comprises one or more oxidized atoms (M)^{+m} and corresponding reduced atoms (X)⁻¹, wherein M is at least one of K, Na, Mg, Ca, Mn, Zn, La, or Li, and wherein X is at least one of F, Cl, Br, I, OH, SO₃, or NO₃. A ninth aspect can include the reaction process of any one of the first to eighth aspects, wherein the reactive component comprises an active metal component, wherein the active metal component comprises a salt having oxidized atoms (MA)⁺ⁿ and reduced atoms (X)⁻¹, wherein MA is at least one of Zn, La, Mn, Co, Ni, Cu, Mg, Fe, or Ca, and wherein X is at least one of F, Cl, Br, I, OH, SO₃, or NO₃. A tenth aspect can include the reaction process of any one of the first to ninth aspects, wherein the reactive component comprises a solid disposed within the molten salt mixture, and wherein the active component comprises a metal, a metal carbide, a metal oxide, a metal halide, solid carbon, or any combination thereof. An eleventh aspect can include the reaction process of the tenth aspect, wherein the reactive component comprises Ni, Fe, Co, Ru, Ce, MoC, WC, SiC, MgO, CaO, Al₂O₃, MgF₂, CaF₂, or any combination thereof. A twelfth aspect can include the reaction process of the tenth or eleventh aspect, wherein the reactive component comprises at least one of: a solid metal particle in the molten salt mixture or a solid metal component disposed on a support structure within the molten salt mixture. A thirteenth aspect can include the reaction process of any one of the first to twelfth aspects, wherein the reactive component comprises at least one of MnCl₂, ZnCl₂, or AlCl₃, and wherein the molten salt mixture comprises at least one of: KCl, NaCl, KBr, NaBr, CaCl₂, or MgCl₂. A fourteenth aspect can include the reaction process of any one of the first to thirteenth aspects, wherein the reactive component comprises at least one of a molten metal forming a slurry with the molten salt mixture or a molten salt in contact with a solid support, wherein the molten salt is at least partially insoluble in the molten salt mixture.

In a fifteenth aspect, a reaction process comprises: contacting a feed stream (10) comprising a hydrocarbon with an active metal component within a vessel (204, 304, 403); reacting the feed stream with the active metal component in the vessel (204, 304, 403); producing carbon based on the reacting of the feed stream (101) with the active metal component in the vessel (204, 304, 403); contacting the active metal component with a molten salt mixture (203, 332, 771); solvating at least a portion of the carbon using the molten salt mixture (203, 332, 771); and separating the carbon from the molten salt mixture (203, 332, 771) to produce a carbon product (209). A sixteenth aspect can include the reaction process of the fifteenth aspect, further comprising: removing the carbon from the active metal component using the molten salt mixture (203, 332, 771) within the vessel (204, 304, 403). A seventeenth aspect can include the reaction process of the fifteenth or sixteenth aspect, further comprising: exchanging heat with the feed stream and the active metal component within the vessel (204, 304, 403) using the molten salt mixture (203, 332, 771) as a thermal fluid. An eighteenth aspect can include the reaction process of any one of the fifteenth to seventeenth aspects, wherein the feed stream is bubbled around the active metal component. A nineteenth aspect can include the reaction process of any one of the fifteenth to eighteenth aspects, further comprising: separating the carbon as a solid layer on top of the molten salt mixture (203, 332, 771); or solidifying the molten salt mixture (203, 332, 771) to produce a solidified salt mixture and dissolving salt from the solidified salt mixture in an aqueous solution to separate the carbon. A twentieth aspect can include the reaction process of any one of the fifteenth to nineteenth aspects, further comprising: producing hydrogen based on the reacting of the feed stream with the active metal component in the vessel (204, 304, 403). A twenty first aspect can include the reaction process of any one of the fifteenth to twentieth aspects, wherein the active metal component comprises at least one of Ni, Fe, Co, Ru, Ce, Mn, Zn, Al, a salt thereof, or any mixture thereof, and wherein the molten salt mixture comprises at least one of: KCl, NaCl, KBr, NaBr, CaCl₂, or MgCl₂. A twenty second aspect can include the reaction process of any one of the fifteenth to twenty first aspects, wherein the active metal component is a solid active metal component, and wherein the solid active metal component comprises at least one of: a solid metal particle in the molten salt mixture, or a solid metal component disposed on a support structure within the molten salt mixture. A twenty third aspect can include the reaction process of any one of the fifteenth to twenty second aspects, wherein the solid active metal component comprises a solid metal component disposed on a support structure, and wherein the support structure comprises at least one of silica, alumina, or zirconia. A twenty fourth aspect can include the reaction process of any one of the fifteenth to twenty third aspects, wherein the molten salt mixture comprises at least one of: LH mixed with LiOH, NiBr₂ mixed with KBr, Ni—Bi emulsified with molten NaCl, mixed with LiOH, CsBr having a packed bed of supported molten LiF supported on alumina, MnCl₂, MnCl₂ and KBr, MnCl₂ and NaCl, a eutectic mixture of LiBr and KBr. A twenty fifth aspect can include the reaction process of any one of the fifteenth to twenty fourth aspects, wherein the molten salt mixture comprises at least one salt in the solid phase. A twenty sixth aspect can include the reaction process of any one of the fifteenth to twenty fourth aspects, wherein the carbon is produced without generating carbon oxides. A twenty seventh aspect can include the reaction process of any one of the fifteenth to twenty sixth aspects, wherein the active metal component comprises a solid disposed within the molten salt mixture, and wherein the active component comprises a metal, a metal carbide, a metal oxide, a metal halide, solid carbon, or any combination thereof.

In a twenty eighth aspect, a system for the production of carbon from a hydrocarbon gas comprises: a reactor vessel (204, 304, 403) comprising a molten salt mixture (203, 332), Wherein the molten salt mixture (203, 332, 771) comprises: an active metal component, and a molten salt; a feed stream inlet (202) to the reactor vessel (204, 304, 403), wherein the feed stream inlet (202) is configured to introduce the feed stream into the reactor vessel (204, 304, 403); a feed stream (101) comprising a hydrocarbon; solid carbon disposed within the reactor vessel (204, 304, 403), wherein the solid carbon is a reaction product of the hydrocarbon within the reactor vessel (204, 304, 403); and a product outlet (335) configured to remove the solid carbon from the reactor vessel (204, 304, 403). A twenty ninth aspect can include the system of the twenty eighth aspect, Wherein the feed stream inlet (202) is configured to bubble the feed stream through the molten salt mixture (203, 332, 771) within the reactor vessel (204, 304. 403). A thirtieth aspect can include the system of the twenty eighth or twenty ninth aspect, wherein the active metal component comprises a solid active metal component, wherein the feed stream inlet is positioned in a lower portion of the reactor vessel (204, 304, 403) below the active metal component, and wherein the active metal component comprises a solid disposed within the molten salt mixture (203, 332. 771), and wherein the active component comprises a metal, a metal carbide, a metal oxide, a metal halide, solid carbon, or any combination thereof. A thirty first aspect can include the system of any one of the twenty eighth to thirtieth aspects, further comprising: a second vessel (404), wherein the product outlet (335) is fluidly coupled to an inlet (333) of the second vessel, wherein the product outlet is configured to receive the solid carbon and molten salt mixture (203, 332, 771) from the reactor vessel (204, 304, 403) and separate the solid carbon from the molten salt mixture (203, 332, 771). A thirty second aspect can include the system of the thirty first aspect, wherein the product outlet is in an upper section of the reaction vessel (204, 304, 403). A thirty third aspect can include the system of the thirty first or thirty second aspect, further comprising: a second vessel outlet configured to provide fluid communication between the second vessel and an inlet of the reactor vessel (204, 304, 403), wherein the second vessel outlet is configured to receive the separated molten salt mixture (203, 332, 771) and return the separated molten salt mixture (203, 332, 771) to the inlet of the reaction vessel (204, 304, 403). A thirty fourth aspect can include the system of the thirty third aspect, wherein the molten salt mixture (203, 332, 771) comprises the solid carbon when transferred to the second vessel, and wherein reacting the oxygen with the molten salt mixture (203, 332, 771) in the second vessel produces carbon oxides. A thirty fifth aspect can include the system of any one of the twenty eighth to thirty fourth aspects, wherein the product outlet is configured to separate the solid carbon as a layer on top of the molten salt mixture (203, 332, 771). A thirty sixth aspect can include the system of any one of the twenty eighth to thirty fifth aspects, wherein the molten salt mixture (203, 332, 771) has a density equal to or greater than the density of the solid carbon. A thirty seventh aspect can include the system of any one of the twenty eighth to thirty sixth aspects, wherein the solid carbon comprises at least one of graphite, graphene, carbon nanotubes, carbon black, or carbon fibers. A thirty eighth aspect can include the system of any one of the twenty eighth to thirty seventh aspects, wherein the molten salt mixture comprises one or more oxidized atoms (M)^{+m} and corresponding reduced atoms (X)⁻¹, wherein M is at least one of K, Na, Mg,Ca,Mn, Zn, La, or Li, and wherein Xis at least one of F, Cl, Br, I, OH, SO₃, or NO₃. A thirty ninth aspect can include the system of any one of the twenty eighth to thirty eighth aspects, wherein the active metal component comprises a salt having oxidized atoms (MA)⁺ⁿ and reduced atoms (X)⁻¹, wherein MA is at least one of Zn, La, Mn, Co, Ni, Cu, Mg, Ce, Fe, or Ca, and wherein X is at least one of F, Cl, Br, I, OH, SO₃, or NO₃. A fortieth aspect can include the system of any one of the twenty eighth to thirty ninth aspects, wherein the active metal component comprises at least one of MnCl₂, ZnCl₂, or AlCl₃, and wherein the molten salt mixture comprises at least one of: KCl, NaCl, KBr, NaBr, CaCl₂, or MgCl₂. A forty first aspect can include the system of any one of the twenty eighth to fortieth aspects, wherein the active metal component comprises at least one of: a solid metal particle in the molten salt mixture, or a solid metal component disposed on a support structure within the molten salt mixture. A forty second aspect can include the system of any one of the twenty eighth to forty first aspects, wherein the active metal component comprises a molten metal, wherein the molten metal forms a slurry with the molten salt mixture.

While several embodiments have been provided in the present disclosure, it should be understood that the disclosed systems and methods may be embodied in many other specific forms without departing from the spirit or scope of the present disclosure. The embodiments and present examples are to be considered as illustrative and not restrictive, and the intention is not to be limited to the details given herein. Many variations and modifications of the systems and methods disclosed herein are possible and are within the scope of the disclosure. For example, the various elements or components may be combined or integrated in another system or certain features may be omitted or not implemented. Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

Numerous other modifications, equivalents, and alternatives, will become apparent to those skilled in the art once the above disclosure is fully appreciated. It is intended that the following claims be interpreted to embrace all such modifications, equivalents, and alternatives Where applicable. Accordingly, the scope of protection is not limited by the description set out above but is only limited by the claims which follow, that scope including all equivalents of the subject matter of the claims. Each and every claim is incorporated into the specification as an embodiment of the present systems and methods. Thus, the claims are a further description and are an addition to the detailed description of the present invention. The disclosures of all patents, patent applications, and publications cited herein are hereby incorporated by reference.

We claim:

1. A reaction process comprising:
feeding a feed stream comprising a hydrocarbon into a vessel, wherein the vessel comprises a molten salt mixture and a reactive component;
reacting the feed stream in the vessel;
producing reaction products comprising solid carbon and a gas phase product based on the reacting of the feed stream;
contacting the reaction products with the molten salt mixture;
separating the gas phase product from the molten salt mixture; and
separating the solid carbon from the molten salt mixture to produce a solid carbon product.

2. The reaction process of claim 1, wherein the solid carbon is solvated, carried, or entrained in the molten salt mixture.

3. The reaction process of claim 1, further comprising:
exchanging heat with the feed stream and molten salt mixture within the vessel using the molten salt mixture as a thermal fluid.

4. The process of claim 1, wherein the feed stream is bubbled through the molten salt mixture, and wherein the method further comprises:
passing the solid carbon and the molten salt mixture out of the vessel based on bubbling the feed stream through the molten salt mixture; and
wherein separating the solid carbon from the molten salt mixture occurs after the solid carbon and the molten salt mixture passes out of the vessel.

5. The process of claim 4, wherein separating the solid carbon from the molten salt mixture comprises at least one of:
passing the solid carbon and the molten salt mixture over a filter to retain the solid carbon on the filter;
separating the solid carbon from the molten salt mixture using differences in density of the solid carbon and the molten salt mixture; or
using a solid transfer device to physically remove the solid carbon from the molten salt mixture in a second vessel.

6. The process of claim 1, further comprising:
separating the solid carbon as a layer on top of the molten salt mixture; or
solidifying the solid carbon and the molten salt mixture to produce a solidified salt mixture and dissolving salt from the solidified salt mixture in a liquid solution to separate the solid carbon.

7. The process of claim 1, further comprising:
providing oxygen to the vessel; and
producing steam based on the reacting of the feed stream and the oxygen with the molten salt mixture. The process of claim 1, wherein the molten salt mixture comprises one or more oxidized atoms (M)^{+m} and corresponding reduced atoms (X)⁻¹, wherein M is at least one of K, Na, Mg, Ca, Mn, Zn, La, or Li, and wherein X is at least one of F, Cl, Br, I, OH, SO₃, or NO₃.

9. The process of claim 1, wherein the reactive component comprises an active metal component, wherein the active metal component comprises a salt having oxidized atoms (MA)⁺ⁿ and reduced atoms (X)⁻¹, wherein MA is at least one of Zn, La, Mn, Co, Ni, Cu, Mg, Fe, or Ca, and wherein X is at least one of F, Cl, Br, I, OH, SO₃, or NO₃.

10. The process of claim 1, wherein the reactive component comprises a solid disposed within the molten salt mixture, and wherein the active component comprises a metal, a metal carbide, a metal oxide, a metal halide, solid carbon, or any combination thereof.

11. The process of claim 10, wherein the reactive component comprises Ni, Fe, Co, Ru, Ce, MoC, WC, SiC, MgO, CaO, Al₂O₃, MgF₂, CaF₂, or any combination thereof.

12. The process of claim 10, wherein the reactive component comprises at least one of: a solid metal particle in the molten salt mixture or a solid metal component disposed on a support structure within the molten salt mixture.

13. The process of claim 1, wherein the reactive component comprises at least one of MnCl₂, ZnCl₂, or AlCl₃, and wherein the molten salt mixture comprises at least one of: KCl, NaCl, KBr, NaBr, CaCl₂, or MgCl₂.

14. The process of claim 1, wherein the reactive component comprises at least one of a molten metal forming a slurry with the molten salt mixture or a molten salt in contact with a solid support, wherein the molten salt is at least partially insoluble in the molten salt mixture.

15. A reaction process comprising:
contacting a feed stream comprising a hydrocarbon with an active metal component within a vessel;
reacting the feed stream with the active metal component in the vessel;
producing carbon based on the reacting of the feed stream with the active metal component in the vessel;
contacting the active metal component with a molten salt mixture;
solvating at least a portion of the carbon using the molten salt mixture; and
separating the carbon from the molten salt mixture to produce a carbon product.

16. The reaction process of claim 15, further comprising:
removing the carbon from the active metal component using the molten salt mixture within the vessel.

17. The reaction process of claim 15, further comprising:
exchanging heat with the feed stream and the active metal component within vessel using the molten salt mixture as a thermal fluid.

18. The process of claim 15, wherein the feed stream is bubbled around the active metal component.

19. The process of claim 15, further comprising:
separating the carbon as a solid layer on top of the molten salt mixture; or
solidifying the molten salt mixture to produce a solidified salt mixture and dissolving salt from the solidified salt mixture in an aqueous solution to separate the carbon.

20. The process of claim 15, further comprising:
producing hydrogen based on the reacting of the feed stream with the active metal component in the vessel.

21. The process of claim 15, wherein the active metal component comprises at least one of Ni, Fe, Co, Ru. Ce, Mn, Zn, Al, a salt thereof, or any mixture thereof, and wherein the molten salt mixture comprises at least one of: KCl, NaCl, KBr, NaBr, CaCl₂, or MgCl₂.

22. The process of claim 15, wherein the active metal component is a solid active metal component, and wherein the solid active metal component comprises at least one of: a solid metal particle in the molten salt mixture, or a solid metal component disposed on a support structure within the molten salt mixture.

23. The process of claim 22, wherein the solid active metal component comprises a solid metal component disposed on a support structure, and wherein the support structure comprises at least one of silica, alumina, or zirconia.

24. The process of claim 15, wherein the molten salt mixture comprises at least one of: LiI mixed with LiOH, NiBr₂ mixed with KBr, Ni—Bi emulsified with molten NaCl, LiI mixed with LiOH, CsBr having a packed bed of supported molten LiF supported on alumina, MnCl₂, MnCl₂ and KBr, MnCl₂ and NaCl, a eutectic mixture of LiBr and KBr.

25. The process of claim 15, wherein the molten salt mixture comprises at least one salt in the solid phase.

26. The process of claim 15, wherein the carbon is produced without generating carbon oxides.

27. The process of claim 15, wherein the active metal component comprises a solid disposed within the molten salt mixture, and wherein the active component comprises a metal, a metal carbide, a metal oxide, a metal halide, solid carbon, or any combination thereof.

28. A system for the production of carbon from a hydrocarbon gas, the system comprising:
a reactor vessel comprising a molten salt mixture, wherein the molten salt mixture comprises: an active metal component, and a molten salt;
a feed stream inlet to the reactor vessel, wherein the feed stream inlet is configured to introduce the feed stream into the reactor vessel;
a feed stream comprising a hydrocarbon;
solid carbon disposed within the reactor vessel, wherein the solid carbon is a reaction product of the hydrocarbon within the reactor vessel; and
a product outlet configured to remove the solid carbon from the reactor vessel.

29. The system of claim 28, wherein the feed stream inlet is configured to bubble the feed stream through the molten salt mixture within the reactor vessel.

30. The system of claim 28, wherein the active metal component comprises a solid active metal component, wherein the feed stream inlet is positioned in a lower portion of the reactor vessel below the active metal component, and wherein the active metal component comprises a solid disposed within the molten salt mixture, and wherein the active component comprises a metal, a metal carbide, a metal oxide, a metal halide, solid carbon, or any combination thereof.

31. The system of claim 28, further comprising:
a second vessel, wherein the product outlet is fluidly coupled to an inlet of the second vessel, wherein the product outlet is configured to receive the solid carbon and molten salt mixture from the reactor vessel and separate the solid carbon from the molten salt mixture.

32. The system of claim 31, wherein the product outlet is in an upper section of the reaction vessel.

33. The system of claim 31, further comprising:
a second vessel outlet configured to provide fluid communication between the second vessel and an inlet of the reactor vessel, wherein the second vessel outlet is configured to receive the separated molten salt mixture and return the separated molten salt mixture to the inlet of the reaction vessel.

34. The system of claim 33, wherein the molten salt mixture comprises the solid carbon when transferred to the second vessel, and wherein reacting the oxygen with the molten salt mixture in the second vessel produces carbon oxides.

35. The system of claim 28, wherein the product outlet is configured to separate the solid carbon as a layer on top of the molten salt mixture.

36. The system of claim 28, wherein the molten salt mixture has a density equal to or greater than the density of the solid carbon.

37. The system of claim 28, wherein the solid carbon comprises at least one of graphite, graphene, carbon nanotubes, carbon black, or carbon fibers.

38. The system of claim 28, wherein the molten salt mixture comprises one or more oxidized atoms (M)^{+m} and corresponding reduced atoms (X)⁻¹, wherein M is at least one of K, Na, Mg,Ca,Mn, Zn, La, or Li, and wherein X is at least one of F, Cl, Br, I, OH, SO₃, or NO₃.

39. The system of claim 28, wherein the active metal component comprises a salt having oxidized atoms (MA)⁺ⁿ and reduced atoms (X)⁻¹, wherein MA is at least one of Zn, La, Mn, Co, Ni, Cu, Mg, Ce, Fe, or Ca, and wherein X is at least one of F, Cl, Br, I, OH, SO₃, or NO₃.

40. The system of claim 28, wherein the active metal component comprises at least one of MnCl₂, ZnCl_{2,} or AlCl₃, and wherein the molten salt mixture comprises at least one of: KCl, NaCl, KBr, NaBr, CaCl₂, or MgCl₂.

41. The system of claim 28, wherein the active metal component comprises at least one of: a solid metal particle in the molten salt mixture, or a solid metal component disposed on a support structure within the molten salt mixture.

42. The system of claim 28, wherein the active metal component comprises a molten metal, wherein the molten metal forms a slurry with the molten salt mixture.
